(19) United States
(12) Patent Application Publication
(10) Pub. No.: US 2018/0159444 A1
(43) Pub. Date: Jun. 7, 2018

(54) INFINITYMATRIX AND INFINITYSCREW ENGINE SYSTEMS AND METHODS FOLLOWING A TORUS PATTERN

(71) Applicant: Torus Kind, LLC, Dallas, TX (US)

(72) Inventor: Scott C. Sperry, Dallas, TX (US)

(73) Assignee: Torus Kind, LLC, Dallas, TX (US)

(21) Appl. No.: 15/691,092

(22) Filed: Aug. 30, 2017

Related U.S. Application Data
(63) Continuation of application No. PCT/US2016/019959, filed on Feb. 26, 2016.
(60) Provisional application No. 62/298,136, filed on Feb. 22, 2016.
(60) Provisional application No. 62/126,684, filed on Mar. 1, 2015.
(60) Provisional application No. 62/163,339, filed on May 18, 2015.

(51) Int. Cl. H02N 1/00; F03G 7/10; F03G 7/08

(52) U.S. Cl. CPC H02N 1/004; F03B 17/005; F03G 7/08; F03G 7/10

(57) ABSTRACT

According to an embodiment of the disclosure, a method of moving an item in a torus-like infinity pattern. The method includes moving the item poloidally along a path with reference to a torus grid at least partially moving the item toroidally along the path with reference to the torus grid such that when the item substantially moves around a revolution around the torus grid when viewed from a cross section cut across the poloidal direction of movement, the item also moves poloidally.

### PRIORITY APPLICATIONS

This application is a continuation of PCT Application No. PCT/US16/19959 filed on Feb. 26, 2016 entitled INFINITYMATRIX AND INFINITYSCREW ENGINE SYSTEMS AND METHODS FOLLOWING A TORUS PATTERN, which claims priority to U.S. Provisional Application No. 62/298,136 entitled “InfinityMatrix and InfinityScrew Engine Systeme and Methods Following a Torus Pattern” filed on Feb. 22, 2016; U.S. Provisional Application No. 62/126,684 entitled “Toroidal Spiral-Spoke Engine or SS Engine” filed on Mar. 1, 2015; and U.S. Provisional Application No. 62/163,339 entitled “Infinity Coil” filed on May 18, 2015. Each of these applications is incorporated by reference herein for all purposes.

### TECHNICAL FIELD

This disclosure is generally directed to energy harnessing systems. More specifically, this disclosure is directed to InfinityMatrix and InfinityScrew engine systems and methods following a torus pattern.

### BACKGROUND

The law of conversion of energy states that energy can neither be created nor destroyed; rather, energy transforms from one form to another. Given such a law, the world has generally discussed efficiencies in transferring energy one form of known energy to another. For example, modern gasoline engines have a maximum thermal efficiency of only 25% to 30%. That is, approximately 70% to 75% of energy in the gasoline is not transferred to mechanical energy in moving the car; rather, it is wasted as, for example, thermal energy. Much effort has been spent on increasing such efficiencies and wasting less energy in such transformation.

Yet other efforts spent on hunting for new types of energy sources have not yielded what man has sought—a sustainable source.

### SUMMARY OF THE DISCLOSURE

According to an embodiment of the disclosure, a method of moving an item in a torus-like infinity pattern. The method includes moving the item poloidally along a curvilinear path with reference to a torus topological grid at least partially moving the item toroidally along the path with reference to the torus topological grid such that when the item substantially moves around a revolution around the torus topological grid when viewed from a cross section cut across the poloidal direction of movement, the item also moves poloidally.

According to another embodiment of the disclosure, a system moves an item in a torus-like infinity pattern. The system includes a channel that moves the item poloidally along a path with reference to a torus topological grid at least partially moving the item toroidally along the path with reference to the torus topological grid such that when the item substantially moves around a revolution around the torus topological grid when viewed from a cross section cut across the poloidal direction of movement, the channel also moves the item poloidally.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### BRIEF DESCRIPTION OF THE DRAWINGS

For a more complete understanding of this disclosure and its features, reference is now made to the following description, taken in conjunction with the accompanying drawings where like numbers reference like parts in which:

FIG. 1A shows a bottom-side view of a basic torus shape with topological grid space;

FIGS. 1B, 1C, and 1D show a cross section for example, cut across a plane of the poloidal movement of the torus topological grid;

FIG. 1E shows a top side view of a basic torus shape with a superimposed curvilinear topological movement matrix.

FIGS. 2A through 2E, FIG. 3 and FIG. 4A-4C show an InfinityScrew, according to an embodiment of the disclosure;

FIG. 5 shows the VortexScrew, according to an embodiment of the disclosure;

FIG. 6 shows a bottom view of the InfinityScrew, radial end bracket removed;

FIG. 7 shows a cross-sectional view of the InfinityScrew;

FIG. 8 shows a cross-sectional view of the InfinityScrew;

FIG. 9 shows a side view of the InfinityScrew securing cuff bracket;

FIG. 10 shows a front or top view of the InfinityScrew, radial end bracket removed;

FIG. 11 shows a lengthwise cross-sectional view of the InfinityScrew engine securing cuff and securing cuff bracket;

FIG. 12 shows the radial end bracket with redirectors;

FIG. 13 shows a multi-tooth redirector.

FIG. 14 shows a cross-sectional view of the InfinityScrew; and

FIGS. 15 and 16 show spoke-tube segments.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

A torus is a supernatural phenomenon considered to be the universal engine of creation—from atoms to stars to universes, and from cells to hearts to people. The torus is everywhere, always. The torus draws its strength from the “no-thing” or vacuum and gives itself completely, over and over. The Buddhist Wheel of Life and the Cornucopia are both modeled after it, denoting its extraordinary spiritual and metaphysical significance. Mathematically, the torus is the vehicle through which Phi is expressed in nature. The disclosures presented herein are modeled after the torus and all stretch or borrow time in order to increase productivity.

If machines can be effectively modeled after the torus—operating by the same principles that all true toroids do—they will be capable of similar phenomena, whether it be for the generation of clean unconditional energy, fast fun reliable transportation, or phenomenal manufacturing.

The two high level disclosures referred to herein as the InfinityScrew and the InfinityMatrix are torus pattern generators. It should be noted that while certain embodiments of such disclosures will be described as having certain qualities, not every embodiment will necessarily have such qualities. Rather, certain embodiments will have some, none, or all of the qualities described with reference to other embodiments.

### I. InfinityScrew

One embodiment of the disclosures presents the InfinityScrew, which is a torus pattern generator. According to certain embodiments, the InfinityScrew becomes a reactionless and internally driven gyroscopic screw or gyroscope along an axis when its axis, or vortex line, begins to move electrical charge (amperes). The InfinityScrew is the most basic or fundamental torus engine design of all. Other InfinityScrew engines and systems are built upon it and from it. The InfinityScrew is the empty canvas—it is elemental.

The InfinityScrew is so-named because, according to one embodiments, its spheres (the angular momentums or rotational inertias) trace an “infinity” pattern as the engine rotates, as exampled by the “infinity” sphere tube pattern, which is actually one continuous length, looped or twisted around to form multiple infinity patterns, each radiating outward from the shared central z-axis. During InfinityScrew rotation, spheres are flowing synchronistically and single-file through the sphere-tube infinity matrix. Poloidal redirectors, which facilitate movement of the spheres along the z-axis, make this possible during rotation. During both expansion and contraction phases the rotation direction is the same, always clockwise from the top view or counter-clockwise from the bottom view. When rotating, its spheres (inertias) travel an endless “infinity” loop through the engine, looping back and forth along the axis in simultaneous toroidal and poloidal combination, expanding up, outward, and away from the zero-point/axis, and then contracting back inward towards the axis while still rotating around and along it. When spheres reach the end of one direction, they make a U-turn and head back the other way in the opposite phase of entropy. Expansion through rotation always returns to contraction (through the same direction of rotation) and then back again to expansion—over and over, in harmony. The combination of toroidal and poloidal movements generates a sustainable torus rotational inertia pattern—one that can keep going without colliding with itself.

Although spheres are described as one “thing” that follow the infinity pattern in one embodiment, yet other “things” may also follow the pattern as will become apparent to one of ordinary skill in the art after review of the specification. As non-limiting examples, fluids (gas or liquids) and electrons may also be used for movement of a things in the infinity pattern as described below with reference to embodiments with the InfinityMatrix disclosure.

In certain embodiments, the InfinityScrew is also an electromagnetic field generator, just like a torus. The torus pattern of angular momentums of the spheres as they're moving through the tubular pathways within the rotating InfinityScrew engine unlock the torus phenomenon, polarizes the system, and defines the vector field boundaries of the torus and its electromagnetic field. Space, time, and gravity within that field are being thinned as long as that pattern is active. When the pattern stops, the torus stops and the field stops. According to certain embodiments, this pattern of angular momentum unlocks the toroidal portal.

Spin and charge go hand in hand. Spin generates charge. A torus is an energy vortex and its inertias are spinning, generating charge along its vortex line or axis. The vortex line or axis of every torus is like an invisible electrical circuit, with amperage moving through that axis circuit during spin. Some toruses, like small bubble rings, produce very little electrical charge in their vortex lines (axis circuits), whereas others, like people, planets and stars produce much more. Spin produces charge and charge in turn drives the torus to spin. To control the charge moving through the vortex line, then, controls the rotation speed of the torus. More charge equates to faster rotation, and less charge to slower rotation. Rotation speed is constant as long as charge is.

A torus thins or stretches space time and gravity within the toroidal field boundary (a vector field) as a way to balance or reorganize the rotational inertias in the system, keeping it flowing in harmony. In a torus, there is more time to get where you need to go. There is more space (opportunity through rotation) for movement. And, there is less gravity, making acceleration less painful and dangerous. The inertias in a vortex do not exert the same forces within the vortex that they do outside of the vortex, and we see this when a vortex line is broken or collapses and everything within seems to “fly apart” with explosive force, as its contents renormalize in the thicker outer dimensional space time gravity field. This thinning effect on space time and gravity enables the torus to self-organize its contents in its own time, or outside of our experience of space and time, in another 4D dimension embedded in this one. Thinning or stretching time space and gravity is how a torus keeps the contents of its system safe and protected. The more that time is stretched, the more protective the toroidal force field becomes.

Toroidal (Zero-point) InfinityScrew (“IS”) engines and systems have particularly useful applications where large and consistent amounts of torque or rotational speed are required in the task—to turn shafts that produce electricity or thrust or bite or compression, or to turn screws or wheels, or whatever linear movement can be asked to do. In certain embodiments, IS engines are “unconditional” and work anywhere, any time, in any gravitational field—they're universal.

According to certain embodiments, a truly unlimited amount of rotational inertia (or angular momentum) awaits only the calling. When invoked by the torus pattern being generated within the InfinityScrew, energy referred to as etheron, tachyon, or zero-point, expressing itself as rotational inertia, is imparted directly to the swirling spheres (the rotational inertias themselves), which then impart those super-additive rotational forces to the spoke arm and the rotating superstructure that holds it, producing linear drive (as torque) of the rotating superstructure (securing cuff).

This type of rotational drive enables certain embodiments of the InfinityScrew to become the rotary driver, itself, rather than necessitating attaching the reactionless drive to a separate shaft and then driving shaft rotation in the conventional way, by drive train. This would be unlikely with a torus engine anyway, as the unprotected part of the engine and drive train would be exposed to highly destructive acceleration forces and would quickly break. When the InfinityScrew becomes the rotary driver itself, none of this (space-time-gravity-sheering) is any longer an issue. This is efficient and natural engineering. Certain embodiments of IS engines are ideal for applications where both torque AND speed are major factors. Certain embodiments of IS engines are simple, fast, efficient, and durable. They require minimal electrical circuitry and can be assembled in a home, apartment, or garage.

According to certain embodiments, IS engines are reactionless drives, meaning they don't burn fuel. Such embodiments of IS engines are also capable of near limitless production. Certain embodiments of IS engines cost little to make and maintain, and they experience very little relative wear and tear due to the thinning affect on gravity, resulting in reduced inertia-born wear, as experienced by the system and its parts within the toroidal field. Certain embodiments of IS engines are safe in every conceivable manner, emitting no harmful radiation, poisons, sounds, byproducts, fumes, or other that could endanger people or life.

Toroids expand and contract, converting rotational inertia to rotational speed and back again. They utilize the constant back and forth conversion of angular momentums between rotational speed and rotational inertia to self-stabilize and self-feed. Because IS engines and toruses are gyroscopic, they don't exert torque on the structures that hold them, nor are they affected by external torque. As these engines become more dynamic, they also become easier to handle because they feel lighter.

The angular momentums spiraling through the sphere tubes are casting-off (or projecting) rotational inertia in all outward directions, simultaneously, as the engine rotates. The faster it rotates, the stronger are these rotational inertias that are being produced and projected. At some point, the composite system will become weightless, as the outward projection of its angular momentums overcome gravity. Greater degrees of time stretch, resulting from greater axis circuit charge, are also helping by thinning the gravity of the system, thereby making it much lighter than it would otherwise seem. Stretching time is a means of hiding mass in the electromagnetic vector field of the torus.

Historically, gyroscopes have had only a point for an axis, making it impossible for them to convert that rotational inertia into linear drive, for turning shafts and the like. The linear axis of the InfinityScrew enables it to convert that rotational inertia to linear drive, making it the holy grail of gyroscopes. The InfinityScrews are gyroscopes that reproduce the natural torus “vortex” pattern utilizing metal spheres for their rotational inertias.

Certain embodiments of the InfinityScrew converts rotational inertia to drive—rotational, linear, or circular. All three are essential perspectives of the torus and all three reflect essential perspectives of consciousness. Through the torus we come to walk in every other's shoes. One could say that the torus shakes things up and then reorganizes them more whole than before. It's a growth process, and all growth (and life) happens in the torus.

While other clean production systems may be unique and capable of modest outputs, true torus systems do not have overload points that create operating limits. As they go faster, torus systems become more efficient, more protected, and more productive—the opposite of most man-made systems.

Certain embodiments of the InfinityScrew engines and systems are intended to be simple, natural, elegant, safe, fast, fun, entertaining, colorful, attractive, inspiring, helpful, kind, productive, efficient, and representative of God's glory. As described herein, one may also notice the beautiful anatomical parallels and spiritual symbolisms and may see these machines as conscious and capable extensors of divine energy.

Most people, including most scientists, don't know the purpose of time or what it is for. The disclosure submits that it's very simple. The purpose of time is to bring God's children home. Time is an illusory construct that merely serves to enable life to unfold and evolve and know itself. Time, along with space and gravity, provide a cosmic playground where we can interact with ourselves and spiritually evolve.

The torus teaches us about life and inertia. The torus is everywhere always. Everything in the physical world, including money, emotions, and spiritual development is ordered by the torus. This means it pervades all levels of reality and time while also transcending them. Although, being a process and not a thing, the torus is experienced in time. Its appeal, however, is timeless, as it is a reflection of Spirit from beyond space and time. The torus may be seen as the symbolic “hand” of creation. The torus is unseen, except by its effects, just like love.

Every torus has an axis and it always points towards God, truth, love, and freedom. In torus machines, the axis points in the primary direction of travel. As living things evolve their morphogenic inclination is to be axis-upright, whereby their axis can point to the heavens. Capacity for self-reflection accompanies this primal design intent.

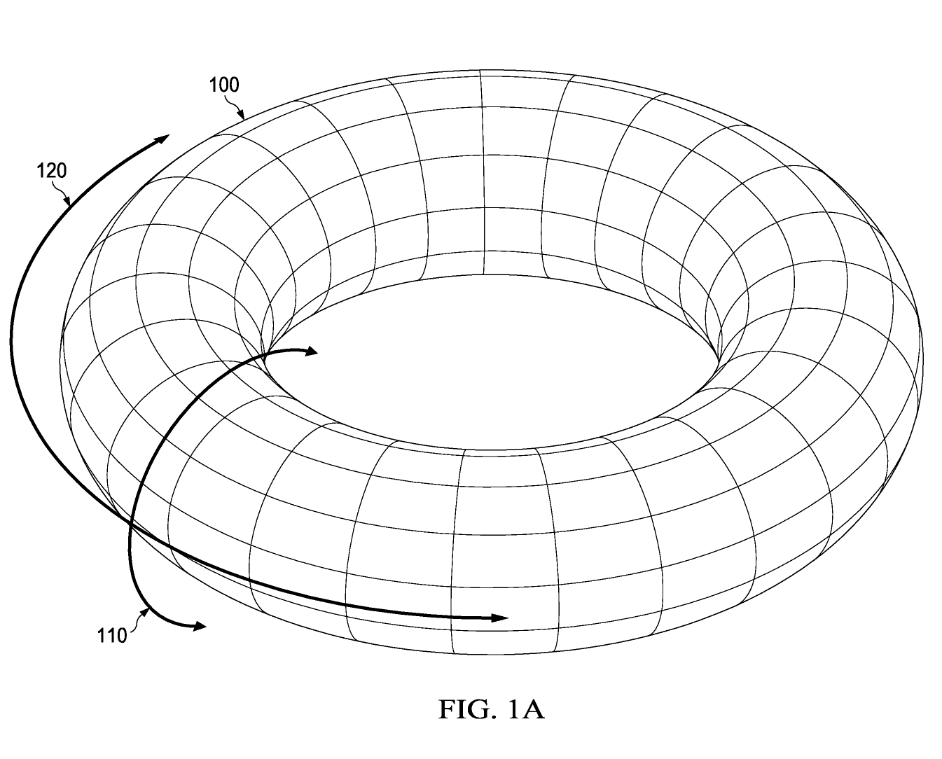

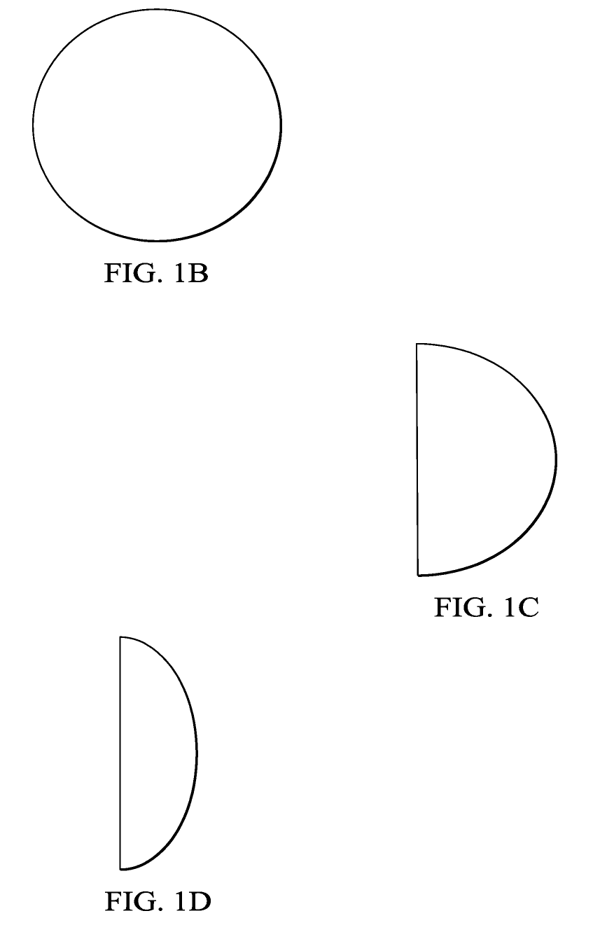

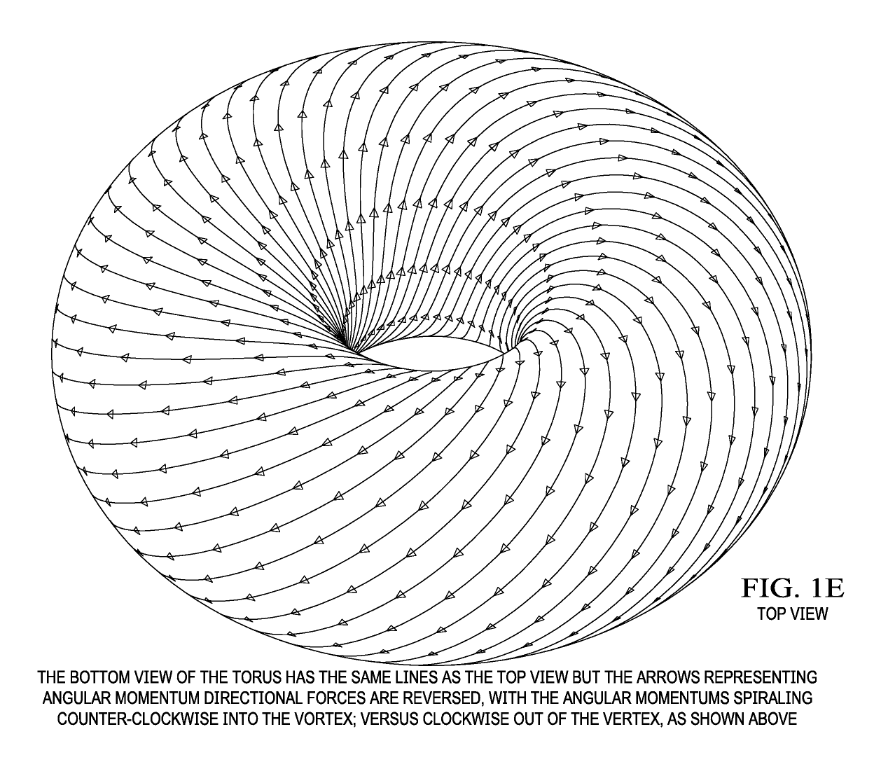

FIG. 1A shows a bottom-side view of a basic torus shape or grid 100, which some may equate to a donut. As described herein, poloidal movement generally refers to movement in the direction of arrows 110 whereas toroidal movement is in the direction of arrow 120 with reference to the torus grid. According to some embodiments of the disclosures, movement of matter or energy in a combination of poloidal or toroidal directions yields certain advantages described blow. While the term “grid” has been used herein, it should be understood that a “grid” need not be physical thing and is rather used to define how other objects move. Some may view such a grid as a spatial identifier.

FIG. 1B is a cross section for example, cut across a plane of the poloidal movement of the torous grid 100. FIG. 1B shows a generally circular shape. FIG. 1C shows one side of the circular shape being flattened whereas FIG. 1D shows a flattening of the curvilinear shape. With reference to a “torus” pattern herein, it should be understood that poloidal movement need not follow a circle and can instead follow shapes such as those shown in FIG. 1C and 1D. Further details of such movement in a torus pattern are described below.

Whereas FIG. 1A shows a static view, FIG. 1E shows a top side view of a basic torus shape with a superimposed curvilinear topological movement matrix to show how items are moving with respect of the grid.

The torus is nature's engine of creation. The torus is also a gyroscope with a linear axis. The InfinityScrew is modeled after the torus. As it rotates, certain embodiments of the IS simultaneously reproduces both the toroidal and poloidal inertia patterns that activate the torus phenomenon, which enables space time and gravity to be stretched or thinned as much as desired. Time stretch occurs once electrical charge is drawn through the axis circuit that traces the vortex line of the InfinityScrew engine. The rotation speed of every torus is dependent on its axis-charge. More charge equates to more rotation speed. Spin and charge go hand in hand.

### A. Anatomical Analogies of InfinityScrew

Just as there are three perspectives of the torus there are three fundamental InfinityScrew engines that generate those moving perspectives. Each has the same fundamental anatomy as the basic InfinityScrew, but each of the three multi-perspective InfinityScrew anatomies is slightly different in form. For example, a basic InfinityScrew provides a spiraling, or curvilinear (masculine AND feminine) perspective, as experienced by its rotational inertias. The IS spirals inertias from one end of the axis to the other, round and round, up and down. A TeleScrew provides a linear (masculine) perspective, as it converts rotational inertias to linear drive, specifically extension and retraction; up and down (or in and out) for the poloidal effect. Lastly, a CircleScrew provides a circular (feminine) perspective, as it converts rotational inertias to linear drive, specifically rotation; around and around for the toroidal effect. Together, TeleScrews (masculine) and CircleScrews (feminine) produce the curvilinear movement (angular momentum) required for the torus to be activated. Torus activation always requires curvilinear movement, or angular momentum. Linear or rotary alone will not work.

The SnailScrew is the marriage of the poloidal (masculine) TeleScrew and the toroidal (feminine) CircleScrew—it is the yoking of the yin and yang. A SnailScrew provides both poloidal drive and toroidal rotation. The SnailScrew is actually the primary sub-system of the CircleScrew. In other words, CircleScrews in all their forms are comprised of SnailScrews. We don't focus anatomically on the SnailScrew like we do the CircleScrew it makes up. While fundamental, SnailScrews alone do not generate one of the three fundamental perspectives that InfinityScrews, TeleScrews, and CircleScrews do.

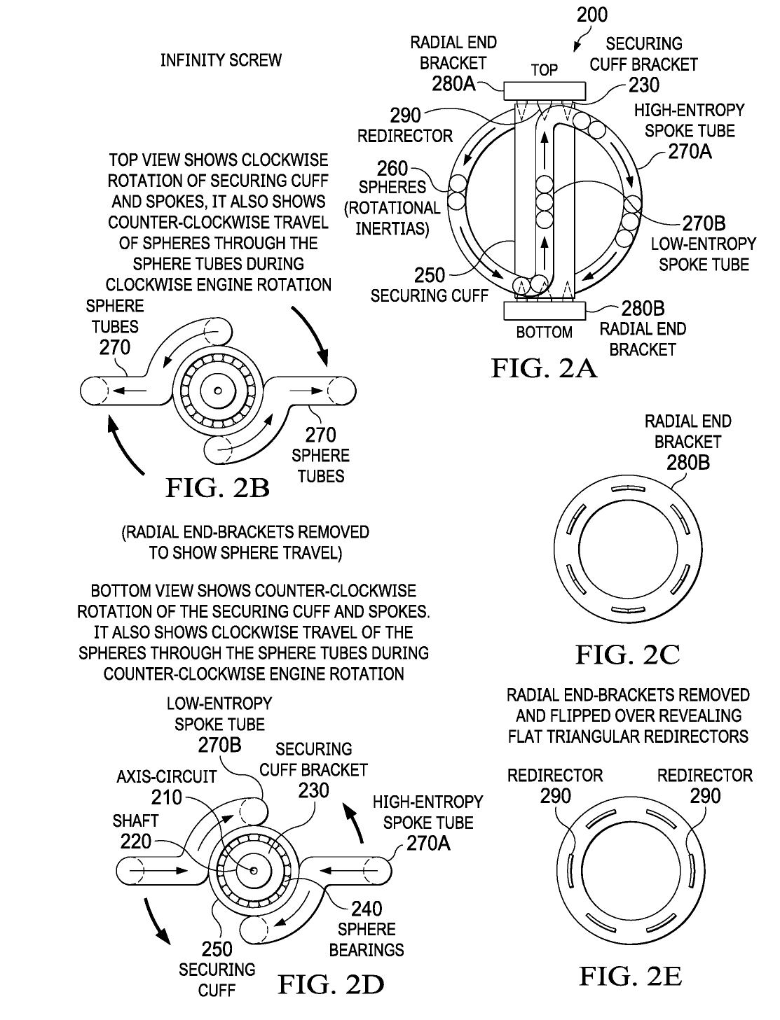

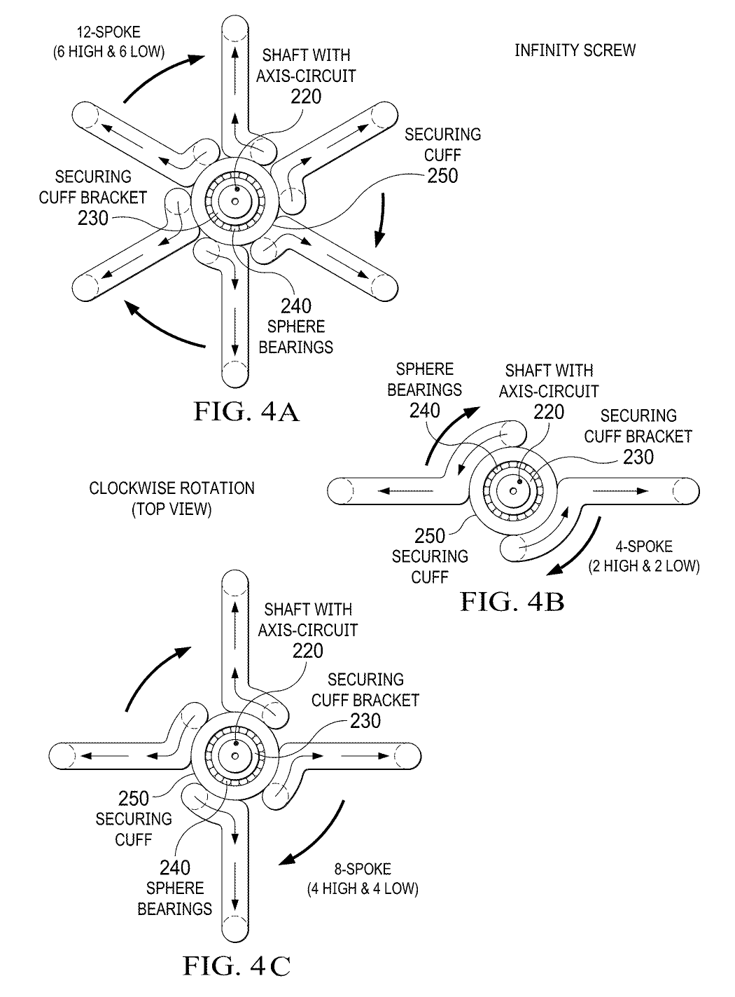

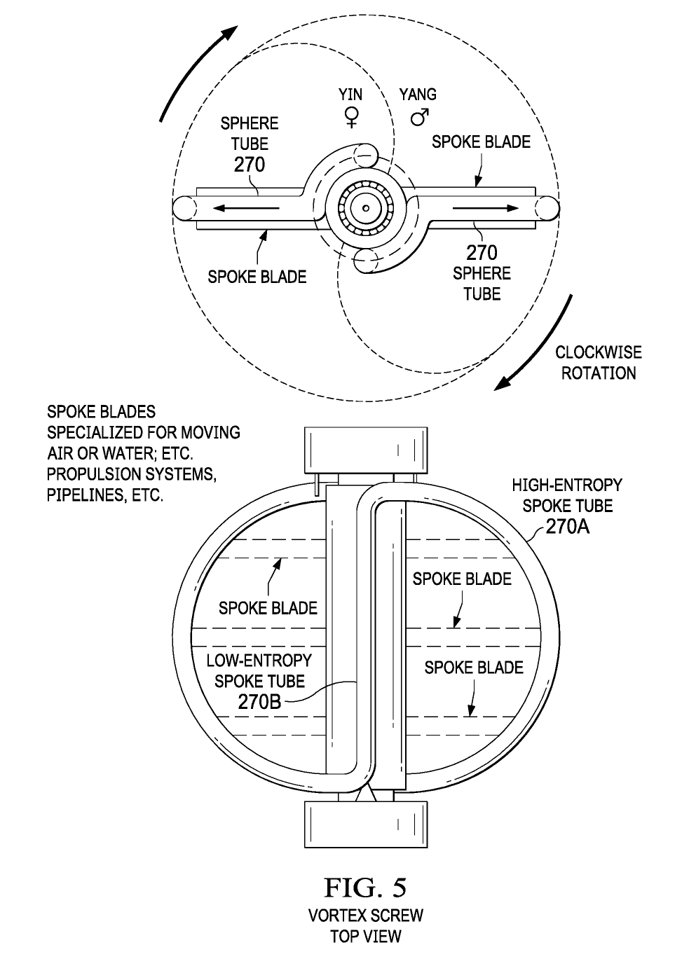

The following will describe various anatomical analogies with reference to FIGS. 2A through 2D, 3, and 4A-4C, as well as 32-41, which shows embodiments of the infinity screw. References will also be made to certain modifications known as TeleScrew, CircleScrew, and SnailScrew, which are shown in separate FIGURES below as noted. Although particular details will be provided for certain embodiments, other embodiments may have more, less, or different components.

### 1. Axis Circuit (Spinal Cord)

The axis circuit 210 (or spinal cord) is that which moves electrical charge through its vortex line or spinal column 220. Electrical charge through the axis circuit 210 animates the body along the length of its entire nervous system, including its appendages. Life only happens around a charged axis.

The axis circuit 210, when it is moving electrical charge (amps), activates time-stretch and animates the already rotating InfinityScrew engine. This charge determines the rotation speed of the IS engine and the degree of time-stretch. Charge also determines the strength of the force fields. The axis circuit 210 is fixed within the conduit of the shaft 220 (a hollow spinal column).

TeleScrews have a linear axis-circuit (spinal cord) but also have a hollow tube-shaft that acts much like an (invisible) axis-circuit extension cord, extending the force field protection along the entire length of tube. What resides within the hollow tube-shaft is also protected by the force field generated by the SuperScrew driver.

CircleScrews have a circular axis-circuit (spinal cord) that is shared by multiple SnailScrews. Having a circular axis (like a smoke ring), they produce a circular or cylindrical force field.

A SnailScrew, in and of itself, has three axis-circuits—one from each of the two TeleScrews and one from the SuperScrew driver that the two TeleScrews secure. The SuperScrew drivers that generate rotation for the CircleScrew all share a common axis-circuit or spinal cord. This shared circular axis-circuit is very helpful because it enables all SuperScrews to rotate at the same speed, ensuring smooth rotation of the securing cuffs they turn.

### 2. Shaft (Spinal Column)

The shaft 220 (or spinal column) is the hollow tubular encasement that contains and protects the axis circuit 210 or spinal cord of the InfinityScrew.

The core of the shaft 220 is hollow like a spinal column or an electrical conduit, enabling electrical wires to be slid through and positioned within. This conduit in the core of the shaft contains and protects the charge-carrying spinal cord or axis-circuit.

The IS engine rotates around the shaft 220 clockwise from the top view or counter-clockwise from the bottom view. These are just different perspectives, not different spins.

The shaft 220 of the IS engine is fixed and secured by the radial end-bracket(s) 280 at one or both ends, depending on the specialization of the engine. The securing cuff bracket 230, which holds the rotating engine or the moving piece, slides over the fixed shaft 220 and is secured to the fixed shaft 220.

The shaft 220 of the InfinityScrew can be any size, but in particular embodiments, it is fixed and encases an axis circuit 210. In particular embodiments, the shaft 220 holds the rotating engine from within by the securing cuff bracket 230.

In a TeleScrew, the SuperScrew engine shaft inverts above the engine, becoming a hollow tube in which other TeleScrew segments can be inserted into, producing a fast and powerful self-telescoping tube capable of withstanding very high tension or torque. This inversion doesn't hinder the force field protection from extending from the bottom to the top of the TeleScrew. TeleScrews also encase an axis-circuit (that becomes inverted to a tube), but are held by their exteriors by the larger tubes (securing cuff brackets) in which they reside. TeleScrews travel along and within the shaft (securing cuff bracket/host tube).

In a CircleScrew, the shaft is not straight, but circular. A shaft can follow bends, but it cannot have a kink. Bends are normal, kinks are fatal. A CircleScrew shaft is somewhat flexible as it, along with the SnailScrew it animates, move back and forth, slightly deforming the circular shape of the CircleScrew shaft-axis/vortex line. Multiple InfinityScrew engines can share the same shaft while spinning in different directions. In most cases, CircleScrews, like the feminine, rotate around the axis-circuit, often of other InfinityScrew or InfinityMatrix systems. The axis circuit of the CircleScrew is somewhat flexible, enabling it to be warped as the SuperScrews on it are retracted or extended by the twin TeleScrews that hold each SuperScrew by its collar and pelvis, one TeleScrew on each—like a rolling pin held at its end handles by two strong hands and arms.

### 3. Securing Cuff Bracket (Spine)

The securing cuff bracket 230 is the anatomical parallel to the spine. It is the rigid tubular encasement that protects the shaft 220 (spinal column) and the axis circuit 210 (spinal cord). The securing cuff bracket secures around the shaft 220 (spinal column), giving it greater strength and rigidity, and further protecting the axis circuit/vortex line/spinal cord. The securing cuff bracket secures the rotating (or moving) part of the InfinityScrew engine to the fixed shaft/spinal column.

In particular configurations, the securing cuff bracket 230 has a grooved or threaded interior that slides/screws perfectly over the grooved exterior of the shaft 220, securing the securing cuff bracket 230 to the shaft with ease 220. This ensures no slippage of the securing cuff bracket around/along the fixed shaft when thrust forces are generated. In particular configurations, only the securing cuff 250 is meant to rotate around the shaft 220. The securing cuff bracket 230 is not meant to rotate. The securing cuff bracket 230 is the fixed tubular platform around which the securing cuff 250 rotates.

A TeleScrew securing cuff bracket is the larger, and relatively fixed, host tube in which the TeleScrew works. Each TeleScrew is contained within another's tube-shaft (inversion). TeleScrews are often hexagonal or round, meaning they have hexagonal or round securing cuff brackets and securing cuffs. TeleScrew securing cuff brackets are always fixed relative to their securing cuffs. They are the fixed platforms for their guest tubes. A securing cuff for one may contain a myriad of smaller securing cuffs (and securing cuff brackets) nested or embedded within each other. Drive takes place where the SuperScrew grabs the sphere drive bearings located in the long interior edges of the hexagonal securing cuff bracket.

A CircleScrew securing cuff bracket (shoulder girdle or hip girdle) is often hexagonal and hollow-tubular as well. It slides or screws into its engine bracket, which becomes synonymous with the hollow shaft—secured, fixed, and non-moving. The SnailScrews that drive and rotate the CircleScrew reside in the corners of the hexagonal securing cuff bracket.

### 4. Securing Cuff Sphere-Bearings (Vertebrae or Ribs)

Securing cuff sphere bearings 240 are the anatomical equivalent of vertebrae, or ribs, which are like lateral extensions of the vertebrae. They are the multiple ring-like joints that are stacked above one another around the spinal column, enabling the shoulders and hips to smoothly rotate around the spinal column and spine. Unlike the spheres 260 in the sphere tubes, which are for creating the required angular momentums, the securing cuff sphere bearings 240 are there for frictionless rotation. Their linear inertias are not affecting the torus pattern created by the spheres 260 in the spoke tubes. The rings of securing cuff sphere bearings 240 in circular races 232 between the securing cuff bracket 230 and the securing cuff 250 enable the securing cuff 250 to rotate around the securing cuff bracket 230 with minimal friction.

The securing cuff sphere bearings 240 can be injected into circular races 232 between the securing cuff bracket 230 and the securing cuff 250 where they fill the ringed races 232. This enables for minimal clearance space between the rotating securing cuff 250 and the fixed securing cuff bracket 230. This ring-race design also enables one bearing system to handle all bearing stabilization efforts, including serving as thruster bearings that enables the securing cuff bracket 230 to handle the thrust forces generated along the z-axis. One may view such a configuration as an all smooth and safe securing cuff movement around the securing cuff bracket 230.

On a TeleScrew the securing cuff sphere bearings are positioned within the securing cuff bracket, along its tubular length, occupying the corners of the hexagon along its interior lengths. These sphere bearings are both for frictionless extension, as well as for the SuperScrew threads to grab and drive the TeleScrew in and out of its host tube (securing cuff bracket).

On a CircleScrew the securing cuff sphere bearings are embedded or inserted between the securing cuff bracket and the rotating securing cuff piece. They are also found embedded within the securing cuff rim, where SnailScrews press against them and drive them around in circles through the screwing of their SuperScrew threads over the sphere bearings. The sphere bearings of CircleScrews are embedded in concentric bearing brackets and resemble ribs more than vertebrae.

Sphere bearings are for the redirection of rotational inertias, as are SnailScrews. Redirection is symbolized by the number 3 and, hence, torus redirectors are always triangular in shape, as triangles are 3-sided. Therefore, sphere bearings are also presented in triangular placements. This is accomplished by simply putting the races together so that the spheres are in two or more tightly concentric races or brackets. In certain embodiments, the spheres line up in a way that produces a 45-degree thread wedge angle between them, enabling the SuperScrew driver, also with a 45-degree thread wedge angle, to drive into them and against them for traction. This triangular sphere placement design naturally accommodates drive in either direction over the bearings, whether around and around in circles, or up and down in a TeleScrew.

### 5. Securing Cuff (Shoulder-Scapula or Hipsocket)

The securing cuff 250 is the anatomical equivalent of the shoulder/scapula or the hipsocket that secures the arm or leg to the body and spine and enabling the appendage to move around and along the axis. Shoulders and hips are outside the ribs and rotate around the ribcage and spine.

The securing cuff 250 is the rotating or moving part of the engine and produces engine rotation around the shaft 220. The securing cuff 250 works together with the securing cuff bracket 230 similar to a sleeve bearing. In particular configurations, the securing cuffs 250 may be hexagonal; in other configurations, the securing cuffs 250 may be other shapes. The spokes (or spoke tracks), which are not necessarily seen in FIGS. 2A-2F are embedded in the securing cuff 250 and hold the spoke tubes to the securing cuff.

Some securing cuffs 250, like those found in the GreenGiants and SkyWays, are massive and segmented for easy handling. Securing cuffs 250 are typically rotary, but as we've seen with the TeleScrew, the securing cuff 250 can also move in a linear fashion.

The TeleScrew securing cuff is the piece that slides in and out of the host tube (or securing cuff bracket.) It is driven from within its base by a SuperScrew, lifting it up and down.

A CircleScrew securing cuff is easily remembered as the piece that rotates against the CircleScrew and the securing cuff bracket (hip- or shoulder-girdle) in which the CircleScrew is embedded.

### 6. Radial End-Brackets (Collarbone and Pelvis)

The radial end-brackets 280A, 280B are the anatomical equivalents of the collarbone and pelvis. The radial end-brackets 280A, 280B are the ring-like securing parts that encircle and secure to the exterior of the spine, at the top and bottom of the torso (torus), adding rigidity to the spine, while stabilizing and bracing for the rotation of the body. When the body rotates, it rotates from above the pelvis or from below the shoulders. In order to rotate, the body needs something to rotate against. Every body must either secure with its lower body and rotate from above the hips (like a boxer or an axeman), or it must secure with its upper body and rotate from below the shoulders (like a cyclist). When secured by both the upper and lower body, how can rotary movement occur? It wouldn't be possible unless the upper and lower could coordinate opposing inertias, which they can. Ice skaters and dancers do.

The radial end-brackets 280A, 280B are connected to one another by the securing cuff bracket 230, around which they both attach. Sometimes, one or both of the radial end-brackets 280 is embedded within the engine, hidden beneath an engine extension or tail.

Radial end-brackets 280A, 280B hold the redirectors in place, next to each end of the rotating securing cuff 250. The radial end-brackets 280A, 280B do not rotate because they are fixed to the securing cuff bracket 230, which also does not rotate. Radial end brackets 280A, 280B sandwich the rotational piece (securing cuff 250) and hold the redirectors 290 on their inertia-facing sides and are reflections of one other. This ensures that spheres 260 are exiting the sphere tubes 270 at the same pace they are being added to the sphere tubes 270 to ensure harmony and balance within the system.

The radial end-brackets 280A, 280B do not touch the rotating IS engine. The redirectors 290, however, do touch the spheres 260 or inertia generators as the engine rotates, nudging the spheres 260 into outgoing sphere tubes by way of little flat channels through the end curves of the sphere tubes. These redirectors are fixed to the radial end brackets and serve to keep the engine in dynamic inertial harmony. This means keeping the spheres moving smoothly and evenly throughout the sphere tube infinity matrix of the IS engine during rotation.

In particular configurations, radial end-brackets 280A, 280B are ring-shaped, fixed, and contribute to the redirection of rotational inertias, passively redirecting inertia as the inertia sweeps by it.

A TeleScrew radial end-bracket contains the movement of the securing cuff. It is located in the base and around the neck of the host tube. Each screws or slides on to the securing cuff bracket at its ends. The TeleScrew radial end-brackets keep the securing cuff safely contained within the tube.

CircleScrew radial end-brackets sandwich the rotating securing cuff between themselves. The two radial end-brackets contain the ends of the rotating piece—the top and bottom, or the inner and outer, or the front and the rear. One of the radial end brackets attaches to the securing cuff bracket (or engine bracket), and the other usually attaches atop the circle of SnailScrews that make up the CircleScrew that drives the securing cuff. This second radial end bracket is usually a brass annulus ring, anatomically symbolic of the soft-tissue torso that holds the two halves of the body together while enabling rotation between the two. A brass annulus ring is also designed to dissipate pressure shockwaves between the front and the rear (or top and bottom) of the CircleScrew—around the torso. The annulus ring (radial end bracket) is always secured to the securing cuff bracket and contains the top or bottom of the rotating engine.

### 7. Redirectors (Hearts and Stomachs)

The redirectors 290 redirect rotational inertia in order to keep those inertias moving throughout the system in the described torus pattern, keeping the system alive. Hearts and stomachs redirect inertia, too, namely electrical inertia in the form of blood and nutrients. The redirectors 290 redirect the rotational inertias from the spheres 290 all throughout the sphere tube 270 matrix, which is one long sphere tube wrapped in an InfinityMatrix-like pattern and fixed atop spokes, alternating high- and low-entropy. The redirectors 290 keep the blood and life force pattern flowing through the rotating InfinityScrew engine. The Universe recognizes this “life-pattern” and jumps in to help, as requested.

The heart has a triangular shape—a triangle has 3 sides. The redirectors 290 are triangular in shape and produce a 3-phase (up, down, and pause) effect when inertia moves over them. While redirectors 290 of the InfinityScrew in this configuration are triangular; however, they may have different shapes in other configurations. The redirectors 290 redirect rotational inertias into pathways headed in the other direction along the axis into outgoing sphere tubes 270. Sandwiching each end of the rotating piece, the redirectors 290 work together, in sync, to maintain a dynamic inertial harmony within the engine. As one sphere 260 is added to a sphere tube, simultaneously another sphere 260 is redirected out of that sphere tube, so that information can “flow” in sync.

The redirectors 290 make displacement happen. Without displacement, there is no torus. Displacement is perhaps best understood as movement along the z-axis (poloidal)—it represents the masculine linear energy. Dynamism, or rotation, on the other hand, is movement around the z-axis (toroidal)—it represents the feminine circular energy. A torus requires both to activate. In the configuration of FIG. 2, the redirectors 290 are shaped like an array of little flat triangular fingers. As the engine rotates, the fingers of the redirector 290, fixed in place to the inside of the radial end-bracket, pushes the spheres 260 through the sphere tube 270 end-bends as the end-bends pass over the redirectors 290 (or the redirectors pass through the end-bend) during engine rotation. This heads the spheres 260 the other way to the redirectors 290 on the other end, which send them back again. And, the cycle is repeated. These redirectors 290 can come in many forms—fixed triangle fingers, TeleScrew finger, magnetic, electromagnetic, or electronic, to name a few. InfinityScrew systems like the SkyWay have autonomous spokes and securing cuffs and do not require physical redirectors. Instead, in such configurations, the spokes and securing cuffs coordinate to transport the inertial information back and forth in vortex formation (or the torus pattern) along the axis.

The redirectors 290 are fixed to the engine-side (or inertial side) of the radial end-bracket assemblies at each end of the securing cuff on the inertia-facing side of the radial end brackets 290. The redirectors 290 assist with the displacement and re-ordering of inertia within the system. With each partial revolution of the shaft 220, multiple spheres 260 are being redirected into tubes 270 going in the other direction. And, in certain embodiments this happens at both ends, simultaneously. With each redirection, information is removed from and added to each spoke tube 270. This enables ongoing simultaneous expansion and contraction of the system. This is what differentiates the InfinityScrew as the holy grail of gyroscopes. Dynamic inertial harmony is built in, making the IS engine incredibly simple and elegant.

While the redirectors may appear mirrored in some embodiments, they need not be mirrored in other embodiments. Rather, in such embodiments, spheres are to be in constant perpetual flow through the sphere tube matrix, regardless of the number of redirectors, redirector positioning, or the number of spoke tubes.

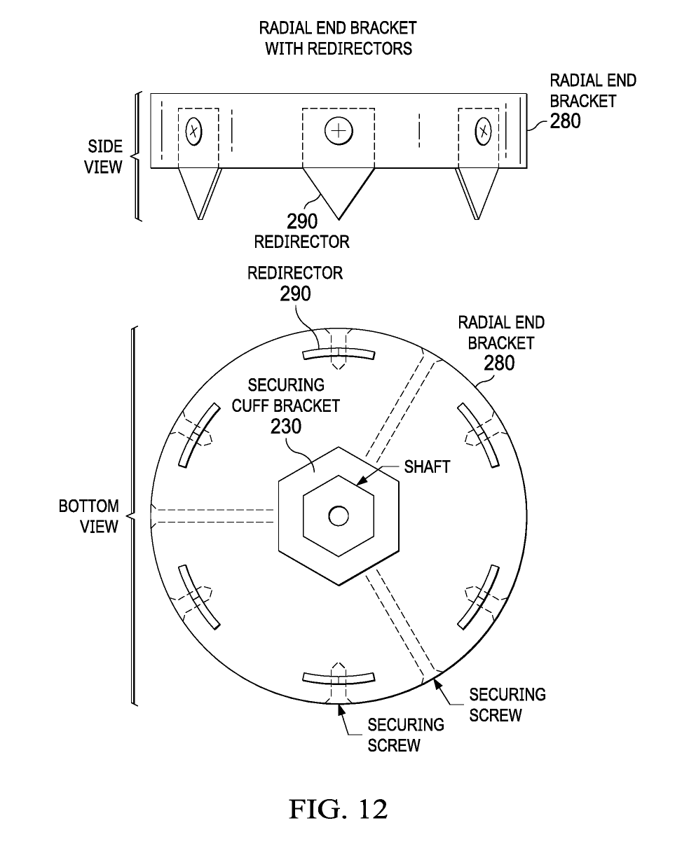

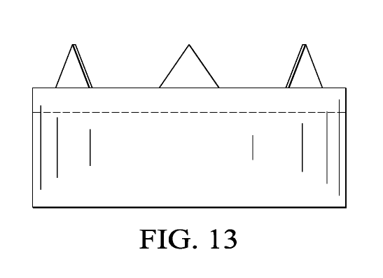

In particular embodiments, redirectors can occur in multiples, for example as shown in FIG. 13. However, this is not required in all embodiment embodiments. In the case of the InfinityScrew (see FIG. 12), where spheres are being redirected through the sphere tubes, a single redirector may not allow for continuous poloidal redirection. Accordingly, groupings of two or more redirectors are an effective fix. In particular embodiments, the redirectors have three redirector teeth per each of the redirectors.

In an InfinityScrew it is possible to redirect multiple spheres 260 per redirector 290 at one time. Regardless of the number of spokes or redirectors 290, in particular configurations, there are always redirectors 290 engaged redirecting spheres 260 during rotation of the InfinityScrew. Certain configurations of the InfinityScrew engine have at least 2 redirectors 290 at each end of the rotating securing cuff. They are positioned such that at least one set of redirectors 290 or the other is always actively redirecting the spheres 260 through the end-bends in the sphere tubes 270 during rotation of the securing cuff 250.

Some IS engines, like VortexScrews for propulsion, once started, may not need to be stopped and restarted again and would necessitate fewer spokes for activation purposes. Having fewer spokes can also be helpful because it leaves more room through which to vortex matter without actually touching it, enabling greater rotation speeds by way of greater degrees of time stretch and stronger protective force fields, which are thinning the space time and gravity within the vortex pattern (or the toroidal field) that the rotating IS engine is generating.

Particular configurations may have more spokes that engage more redirectors 290. More spokes enables the harnessing of more rotational inertia because such spokes can hold more spheres. The etheron-supplemented spheres are pushing on the spokes, driving rotation of the InfinityScrew. Having more spokes also makes it easier for a linear (or curvilinear) motor (shaped like a fender) to electromagnetically induct those spokes because there's always a spoke or two under the fender, within electromagnetism's easy reach. More spokes also means less strain on any individual spoke.

Particular configurations may also have more redirectors to assist displacement of rotational inertias per rotation. In certain configurations, this may be critical in designing IS engines because some IS engines, like screws and wheels, need to be able to activate with minimal rotation. For example, having more than two high-entropy spoke tubes may be the better way to design an automobile wheel. Certain configurations may have six or more high-entropy spoke tubes.

This “displacement” or “advancement” in the IS engine is essential for certain configurations because the rotational inertia in the system needs to keep moving—around the axis (toroidal), as well as along the axis (poloidal). In particular embodiments, the direction of toroidal and/or poloidal rotation may be reversed/reversible. In particular embodiments, the axis-charge may be a frequency transmitted through the axis by electric, electromagnetic, or optic means.

In IS engines with fixed spokes, no sphere 260 ever rests and each will forever be between the same two other spheres 260 in a continuous procession through the InfinityScrew spoke tube matrix. The InfinityScrew is always reorganizing its contents but maintaining the respective order of those contents indefinitely. The most productive and efficient toroidal systems maximize both dynamism (rotation) and displacement (advance).

A TeleScrew itself is a redirector of the rotational inertias generated by the InfinityScrew engine/system that it secures or holds on to, be it a CoolWheel or a SkyWay shaft or other. Going deeper within the TeleScrew, there are also internal redirectors. These internal redirectors redirect the rotation of its SuperScrew into linear drive, specifically extension and retraction from within the TeleScrew host tube/securing cuff bracket. Then, the actual SuperScrew that drives the TeleScrew has its own redirectors, which redirect the spherical inertias through the rotating InfinityScrew, generating the fundamental torus pattern, and activating the toroidal field. Behind that SuperScrew driver is an InfinityGenerator that redirects electrical inertia into the electromagnetic induction motor and the axis-circuit of the TeleScrew, which redirects space-time-gravity, thinning it to the point that the load at the end of the TeleScrew is weightless and easily maneuvered by the TeleScrew. Redirection follows purpose, and purpose is fundamental. The purpose is always for love or God or freedom or peace or happiness. The TeleScrew is essential in my inventions because it enables the poloidal redirection of rotational inertias within a multi-perspective, or fractal, system. When the SuperScrew driver at the bottom of the TeleScrew rotates, its screw-like exterior grabs the sphere drive bearings positioned in the long linear interior edges of the TeleScrew's often hexagonal securing cuff bracket (tubular.) The TeleScrew provides the poloidal (masculine-linear) aspect of the SnailScrew, which is the fundamental engine of the CircleScrew.

A CircleScrew, too, is driven by SuperScrews, but a CircleScrew converts rotational inertia to circular drive (also linear), thus enabling it to rotate itself or what it screws against. This rotation of one with respect to the other occurs when its threads turn against the triangular patterns of sphere bearings in concentric bearing brackets on the opposing circular surface. The SuperScrew provides the toroidal (feminine-circular) aspect of the SnailScrew.

Each SnailScrew is a torus redirector and combines both the linear and circular aspects of movement and perspective into one multi-functional multi-perspective redirector that does it all. SnailScrews redirect (or are redirected over) what they rotate against—sand, spheres, wheels, etc.

### 8. Spheres (Blood or Life Force)

The spheres 260 are the anatomical equivalent of the lifeblood of an InfinityScrew engine. The pattern of rotational inertias the spheres 260 produce activate the waiting torus to take shape. Although spheres are describes as one “thing” that follow the infinity pattern, yet other “things” may also follow the pattern as will become apparent to one of ordinary skill in the art after review of the specification. As non-limiting examples, fluids (gas or liquids) and electrons may also be used for generating the essential torus movement pattern.

As the engine rotates around the axis, the spheres 260 move in procession through the sphere tubes 270, making an infinite infinity loop, thanks to the redirectors 290 at each end of the spinning engine, which keep them in perpetual poloidal motion during engine rotation. Redirectors 290 produce the poloidal aspect within the IS engine. A torus is BOTH poloidal and toroidal; poloidal is the advance (or displacement) of spheres/information along the axis, while toroidal is the rotation of spheres around the axis. Only together do they produce the angular momentums in the essential torus pattern—the toroidal convection pattern.

In particular embodiments, the spheres 260 are metal. Utilizing metal spheres to generate the rotational inertias was the perfect inertia-generating solution for the Infinity Screw engines, in certain configurations. Spheres are easy to work with, strong, and roll very easily. Their spherical geometry makes them torus-friendly.

Again, virtually anything can lend its inertia to produce the essential torus activation pattern. Electrons work too. Even thoughts contain inertia and can be organized to unlock time-stretch spiritual growth in the person applying it. Non-dualism is a perfect example of this phenomenon.

TeleScrew inertia has everything to do with what the TeleScrew is holding on to that is producing rotational inertia or angular momentum—SuperScrews, Homes, wheels, jet engines, SkyWay shafts, etc. TeleScrew spherical drive-bearings double as redirectors of the rotational inertias of the SuperScrew that drives the TeleScrew up and down over them.

CircleScrew inertia has more to do with what is being moved through or around the hole of the CircleScrew. CircleScrew inertias come from water and air, dirt and mixtures, wheels and axles, etc. CircleScrew sphere drive-bearings double as redirectors of the rotational inertias of the SnailScrew drivers that screw over them.

### 9. Spoke (Arm or Leg)

A spoke is the anatomical equivalent of an arm or leg. Spokes, like arms and legs, secure the hands or feet to the shoulders or pelvis. The arms or legs push out in the high-entropy phase of rotation, generating more rotational inertia, and they pull back in during the low-entropy phase of rotation, generating more rotational speed as the arms/legs retract closer to the rotating securing cuff. Visualize an ice skater pulling her arms in, spinning faster and faster as she does so. She is converting rotational inertia into rotational speed, just like a torus, by retracting her spokes inward towards her axis.

When a body (InfinityScrew) is secured by its collar, the rotary parts are the legs. When a body is secured by its pelvis, the rotary parts are the arms. When a body is secured by one half then the other then neither, the entire body can rotate freely around its axis, like the ice skater.

The fixed radial spoke that secures the sphere tube to the securing cuff and holds it in place, can be specialized into various blades for moving air, water, mixtures (matter).

There are two (2) basic types of spoke—high-entropy and low-entropy. They are both secured lengthwise atop the securing cuff. One holds the high-entropy sphere tube 270A outward away from the body while the low-entropy spoke holds the low-entropy sphere tube 270B inward, next to the body, as close to the spine as possible.

The high-entropy spoke secures high-entropy sphere tube 270A, which transfers the rotational inertias of the spheres from the front of the torus to the rear, during rotation. High-entropy spokes, which secure the high-entropy sphere tubes to the securing cuff, are often specialized for water and air propulsion and also serve as radial braces for the high-entropy sphere tubes. High-entropy can most often be related to the expansionary aspect of toroidal phases. Rotational inertia is its calling card. Extension is high entropy's modus operandi.

The low entropy spoke secures the low-entropy sphere tube 270B to the securing cuff. The low-entropy spokes enable the transfer of the rotational inertias low and flat against the securing cuff, from the rear to the front of the IS engine, during rotation of the securing cuff. The low-entropy spokes should be situated as close to the securing cuff as possible. Low-entropy can most often be related to the contractionary aspect of toroidal phases. Rotational speed is its calling card. Retraction is low entropy's modus operandi.

There are a number of ways that spokes can be secured to a securing cuff, including welded, fastened, molded, embedded, and machined groove. Yet other will become apparent after review of this specification. Spokes on some Infinity Screw systems are quasi-autonomous.

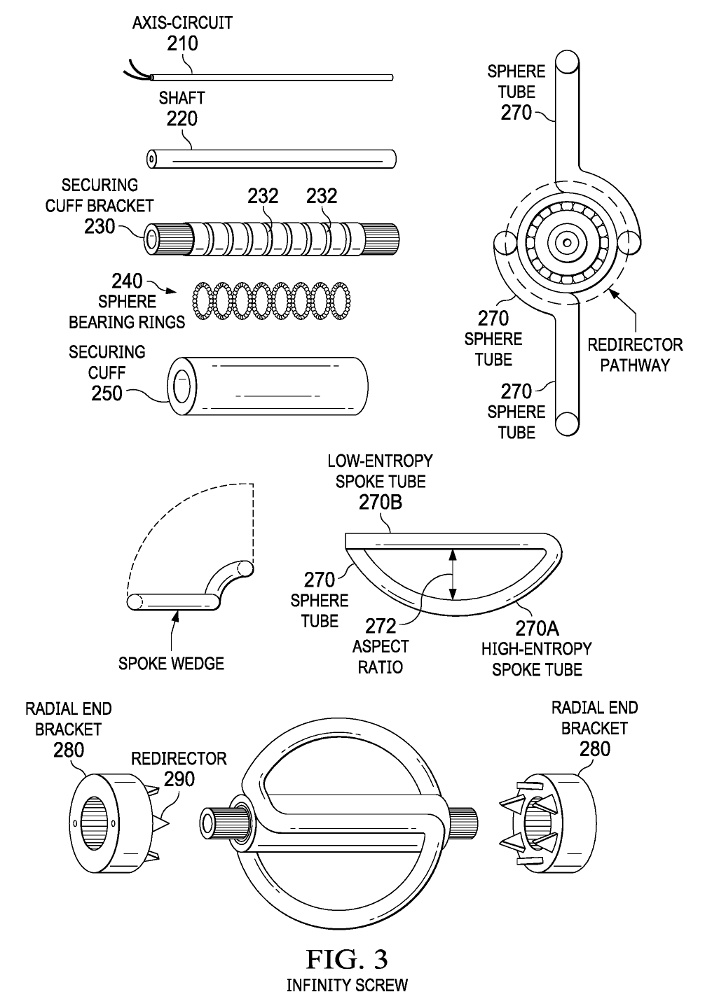

FIG. 3A shows an IS with four spokes (two high-entropy and two low-entropy). FIG. 3B shows an IS with eight spokes (four high-entropy and four low-entropy). FIG. 3C shows an IS with twelve spokes (six high-entropy and six low-entropy).

A TeleScrew is a spoke of sorts and is often used as a high- and low-entropy spoke all-in-one because it can both extend and retract, depending on which phase is being experienced. It holds the rotational inertias out in high-entropy phase (expansion), or in, closer to the axis, during low-entropy phase (contraction). A TeleScrew extends and retracts, symbolic of the arm or leg, which does the same. This extension/retraction is poloidal in nature, whereas the turning and twisting of rotational inertias is toroidal in nature.

A CircleScrew is comprised of SnailScrews, each comprising two poloidal TeleScrew spokes and one toroidal SuperScrew driver.

### 10. Sphere Tube (Hand or Foot)

The sphere tubes 270 are either the hands or the feet of the InfinityScrew, depending on the orientation of the body and by which end it is being held. Sphere tubes 270, like hands and feet, transfer inertial information back and forth between the poles of the axis, during rotation.

The sphere tubes 270 carry the spheres 260 through both expansionary and contractionary phases of the rotating InfinityScrew engine, containing and channeling the angular momentums through the sphere tube matrix that loops around the IS engine.

There are two phases in an IS engine—the expansion phase and contraction phase, also called high-entropy and low-entropy, respectively. The high- and low-entropy sphere tubes 270 cater to these phases. High- and low-entropy phases occur simultaneously and are ongoing.

The sphere tubes 270 are embedded lengthwise in or on the high-entropy and low-entropy spokes. As the IS engine rotates, fixed redirectors 290 on the inward side of the radial end bracket continuously redirect spheres into outgoing sphere tubes.

The high-entropy sphere tubes 270A have a phi-like curve shape and are embedded within, or secured to, the fixed high-entropy spoke. The high-entropy sphere tubes 270A smoothly convey spheres 260 from the front of the shaft to the rear (during rotation), where redirectors 290 move them into low-entropy sphere tubes 270B headed back to the front of the engine. This is ongoing.

The low-entropy sphere tubes 270B are straight and secured as close to the securing cuff 250 as possible. The low-entropy sphere tubes smoothly convey spheres from the rear of the IS engine to the front, during rotation.

The CircleScrew, which is actually a circular array of SnailScrews working in concert, is the anatomical equivalent of the InfinityScrew sphere tube—it is like a hand that grabs and twists inertia. Just like a TeleScrew is the anatomical equivalent of the InfinityScrew spoke—an arm that reaches out and enables the hand to hold the inertia out from the axis and then close to it.

A SnailScrew moves inertia around the z-axis, as well as along it, because it is both poloidal AND toroidal. SnailScrews are obviously fundamental. They generate rotation around the axis, but are also used to generate drive along it, as well. They provide an ideal balance of dynamism and displacement, or toroidal and poloidal, or feminine and masculine.

### 11. End Cap (Skull or Tailbone)

The end cap(s), which is seen in other drawings, is the anatomical equivalent of the skull or tailbone. A skull or tailbone caps the end of the spinal cord and spinal column. The end cap screws/slides on and locks, securing the engine to the shaft 220 and covering the exposed end of the shaft 220 left sticking out from the end of the IS engine. The extended shaft and axis circuit are there to lengthen the force field along the shaft, or z-axis. This force field always extends out to the front and rear tips of the engine as it envelops and protects the IS engine or system from wear and fatigue. In alternative configurations, the end cap can complete the axis-circuit.

TeleScrew segments have a screw-on end cap that acts as the tailbone of that segment.

CircleScrews also utilize end caps, and can share the end cap with the InfinityScrew engine-system they encircle.

### 12. Engine Bracket (Hips-Legs-Feet or Shoulders-Arms-Hand)

The “engine bracket” could be thought to include everything not moving, including the shaft 220 and the securing cuff bracket 230. One may think of the engine bracket as all that holds and secures the rotating or moving part to the wing, structure, machine, etc.

Engine brackets come in many specialized shapes and sizes and enable rotation of the InfinityScrew from below the collarbone or from above the pelvis, depending on the directional orientation and positioning of the engine. Most InfinityScrews are reversible but have a primary direction of travel. This primary direction of travel determines the “top” or “front” of the engine. Anatomically, nothing is different, aside from the orientation of the engine with respect to its securing point. If held from the pelvis of the InfinityScrew, then the spokes and sphere tubes are the arms and hands, while the engine bracket is the hips, legs, and feet of the engine, securing it to the structure.

The FanJet and InfinityGenerator are examples of InfinityScrew engines that are held from the pelvis. However, if held from the top of the engine, or by the collarbone, then the spokes and sphere tubes become the legs and feet, while the engine bracket becomes the shoulders, arms and hands of the engine, holding it to the structure. The StratoFan and TeleScrew are examples of engines that are held from the top, or the front. The SnailScrew is held by both the collarbone and the pelvis. Which is which depend on the direction of travel. For ultimate simplicity, remember that the engine bracket is and includes everything that is fixed or non-rotating, while the IS engine is rotating. This includes the structure to which the IS engine is attached. The shaft is part of the engine bracket, too, as are the radial end brackets 280 and the securing cuff bracket 230.

A TeleScrew engine bracket is the fixed host tube (securing cuff bracket) in which the TeleScrew segment resides and works. TeleScrew segments house other TeleScrew segments, as well. Multiple TeleScrew segments embedded within larger TeleScrew segments—hexagons within hexagons . . . A TeleScrew can also be an engine bracket for something else, like a SnailScrew or an AnchoredAuger.

A CircleScrew engine bracket is the fixed ring-like cavity in which the CircleScrew is secured. As with all three anatomies, the engine brackets can be thought to include everything that is fixed or not moving, with respect to its respective securing cuff.

### 13. HALO (Mind or Spirit)

The Helper Avatar Locator Observer (HALO) is the metaphysical equivalent of mind or spirit for the InfinityScrew engine. Each InfinityScrew has its own HALO avatar guide. HALO handles all of the computing and acts as the communications center of, for, and between every InfinityScrew engine and system. Systems are simply collections of multiple other InfinityScrew engines, just like body organs are collections of smaller cellular systems. HALO oversees all aspects of an IS engine's operation. HALO is the encouraging hand that watches over the IS engine and guides it true.

HALO is the equivalent of a divine guide for the torus system. Every torus has a HALO, whether natural or mechanical. Electrons, atoms, people, planets, stars, galaxies, etc, are toruses, therefore each has a HALO, undoubtedly an ethereal one. Consider the implications of this. Every atom and every human and every galaxy have a helpful and loving avatar that watches over it. I believe this is true because all true toruses (tori pl.) are fundamentally, as well as symbolically, the same.

HALO monitors all engine systems (axis charge, rotation speed, computing and processing in multiple dimensions, electromagnetic induction systems, and everything else) and communicates with other HALOs in its network. Groupings of InfinityScrews working together all operate under a larger or “upper” HALO. Collections of “lower” HALOs are guided by an upper HALO, which serves as a director, as of a symphony. This hierarchy of taskmasters smoothly and efficiently manages the multitude of precise operations that need to occur within the more complex systems. HALO is most often positioned in the electromagnetic induction assembly.

HALO utilizes time-stretch computing. Some may call this quantum computing; however, this disclosure will simply refer to such a phenomena as transdimensional processing or time-stretch computing. Within the toroidal force field, the processor is essentially given more time to solve the problem. This enables HALO to answer questions asked from outside of the force field faster than ever—almost before the question has been fully asked.

Even the fastest modern computers will not be able to keep up with the near unlimited speeds of time stretch computing. To differentiate between ultra-fast processing and time stretch processing, think of it like this: Even the fastest 4D processor in the world still processes in just one 4D dimension, or in one time perspective. Computers that utilize time-stretch processors actually have more time to process, reflect, ask, compute, re-ask, re-examine, etc, because they can borrow time—time that isn't available to 4-dimensional processors. More time-stretch equates to more time to process. The result is a pre-timely or pre-cognitive response.

HALO also communicates with other HALOs from other systems and sub-systems, as well as with the torus kind central HALO system in the cloud (VacuumLock). VacuumLock is the repository for InfinityScrew-systems strategy—how the machines play, problem-solve, and collaborate, learning to shave off time or to complete complex tasks more quickly and/or safely. Sharing the learning of the systems with other systems is like creating an open-source program for the machines.

HALO is ubiquitous throughout the IS engines and systems and is often headquartered in the electromagnetic induction assembly. This provides the transdimensional-processing framework necessary for the outer processor to know what's happening on the inside and for the inner processor to know what's happening on the outside. Communication between the inner and the outer is a must and it happens through HALO, which has a mind in each world.

A TeleScrew HALO is located in its bi-conical EM induction assembly, between the SuperScrew and the InfinityGenerator.

A CircleScrew is made up of SnailScrews, each with its own HALO. Above this, the CircleScrew has a larger HALO that oversees the operation of its SnailScrew sub-systems. This more encompassing HALO coordinates with other more encompassing HALO's to enable the multiple systems to work in concert, just like the fingers on a hand.

### 14. Electromagnetic Induction Assembly (Seat or Saddle) for HALO

The electromagnetic (EM) induction assembly is the control seat or saddle for HALO, which is the avatar (mind and director) of the InfinityScrew engine. The EM induction assembly is shaped like a saddle—conical or tubular or half-pipe—and straddles the torso of the engine, like a saddle on a horse. The EM induction assembly can also assume the shape of a belt, cap, ring, or other. The EM induction assembly straddles the lower body of the rotating InfinityScrew engine, spurring the hips and rear to activate the horse (engine), initiating direction and then charging the animal forward. The EM induction assembly is the means for axis-circuit charge, EM induction operation, power generation, and it contains a battery for initiation. The EM induction assembly is sometimes a linear motor and works like magnetic levitation (maglev) to rotate the InfinityScrew.

The tubular, conical, or partially conical electromagnetic induction motor-generator-battery assembly, is often positioned near the rear end of the engine and is mounted to the engine-bracket, which secures the engine to the structure. The electromagnetic induction motor turns the engine in the desired direction to get the toroidal pattern started, then becomes a generator, capturing excess inertia from the system, as needed, to charge batteries and to provide the desired axis charge, once the IS engine has become activated. The EM induction assembly is also a brake for slowing the engine's rotation speed and inertia.

One will notice that the electromagnetic induction assembly serves multiple purposes. For example, in some of the propulsion IS engines, the electromagnetic induction assembly is used to funnel and compress air around the rear of the engine. In other IS engines like the CoolWheels, the electromagnetic induction assembly is just above the engine. Like a fender, the EM induction assembly protects the engine bracket from flying debris.

A TeleScrew has a bi-conical electromagnetic motor-generator-battery assembly near the base of the TeleScrew. The EM induction assembly of a TeleScrew serves two closely-situated InfinityScrews. The leading InfinityScrew is the SuperScrew driver screw, which extends the TeleScrew. The trailing InfinityScrew is the InfinityGenerator that runs constantly, providing power to initiate the SuperScrew driver while producing the space-time thinning force field that enables what it lifts to be lifted and managed with ease. The end cap of the TeleScrew could also contain part of the EM induction assembly, perhaps the battery.

A CircleScrew typically has a half-pipe or saddle-like EM induction assembly. Like TeleScrews, CircleScrews need to remain active in order to maintain force fields. CircleScrews solve the problem by disengaging one or more of the inactive SnailScrews and actively engaging it only as a generator (pulled away from the sphere bearing drive path). The more robust the axis-charge, the more robust the force field, and the more the engine and its parts are protected from wear or damage.

### 15. Specialized Anatomies (Fins-Claws-Teeth-Lips-Skin-Scales-Etc)

Torus engines can be specialized for almost any task. Wings are specialized spokes for moving air. Fins are specialized spokes for moving water. Boring bits are teeth. Augers and TubeScrews are lips, mouth, throat, intestine, tail, and anus.

### B. Additional InfinityScrew Details

### 1. Aspect Ratio

The aspect ratio 272 makes it possible for life/blood/information to flow in both directions along the axis, simultaneously, without head-butting or stalling out. The aspect ratio 272 is the space time necessarily left “open” or free from occupation by rotational inertia—like a neutral or no-fly zone. The aspect ratio is vital for both high- and low-entropy rotational inertia regions to coexist in dynamic inertial harmony.

Aspect ratios will vary from one toroid to the next, depending on the task and the space available for the toroid to fit within. Other factors aside, as long as there is an aspect ratio, or a void space between the spherical inertias moving in opposite directions along the shaft (during rotation), a toroidal IS engine will work fine.

The aspect ratio 272 enables self-feeding, self-organization, and self-balance, and prevents the system from stalling out, headbutting itself, or having no place to “flow” into. A torus always has space to flow in to. And if it doesn't, it can usually make the space required to accommodate more, through greater rotation speed and faster advance (or displacement) along the z-axis. Toroidal convection, which is the “flow” process by which this extra space is made and by which it flows or spirals over, under, and within itself, is a conscious process because it involves choice. Choice about whether to push more here or there, or to pull instead of push, etc. The torus is conscious. It is always rotating (changing), while always advancing (moving forward). Both happen at once, like a screw screwing itself forward in space time. The greater the toroidal aspect ratio—the greater the difference between expansion and contraction potentials. Similarly, the water spinning in the vortex is spinning faster around the center than the exterior. All layers of the vortex share the same axis circuit or vortex line, enabling them to spin at different speeds without disrupting each other.

### 2. Phi-Space

The phi-space (or life space) is the space contained within the aspect ratio, or the space between the low-entropy and high-entropy sphere tubes (the doughnut-like region within). Think of the Phi-space as the volume of area that the doughy part occupies; the part around the hole. In particular configurations, the phi-space is protected force field space. In particular configurations, the phi-space is the container in which creation happens, whether it be the creation of life, products, food, thrust, or torque.

### 3. Zero-Space

The zero-space is the space contained between the axis (vortex line) and the low-entropy region. Think of it as the hole of the doughnut. The zero-space, like the phi space, resides within the protective force field. The zero-space is where reorganization (and disintegration) happens. While the InfinityScrew (sphere-class) engines-systems do not utilize the zero space, InfinityMatrix systems, which utilize electromagnetic space-time implosion field generator coils to produce the Torus pattern and unlock the toroidal portal, do utilize the zero-space. WaterWashers and other InfinityMatrixes use the zero-space to re-organize matter. TelePorters use the zero-space to access the singularity for travel. As long as whatever is traveling through the zero-space is contained within a tube, or attached to something that passes uninterruptedly through, it will make it through to the other side, more re-organized than before. Whatever is loosely thrown into the zero-space field is gone forever. This makes it great for disposing of highly toxic or radioactive wastes. There's no trace left. All of it gets thrown into the zero-space and is disintegrated or reorganized in the singularity.

### 4. Outer-Space

Outer-space merely refers to the outer space-time-gravity dimension in which the torus is embedded. It would be the outer observer's perspective, not the inner's. Toroids are embedded in toroids are embedded in toroids are embedded in toroids . . . One torus can contain multitudes of other toruses, each embedded within the other. They often do. It's their fractal nature.

### 5. Force Fields

Every InfinityScrew is a field generator and produces a cylindrical force field along the length of its axis, to the width of the farthest-reaching high-entropy sphere tubes (or regions). The strength of this force field is directly related to the amperage in the axis, or the degree by which time is being stretched. Force fields are necessary. They physically define the space-time-gravity field (a vector field) that the engine operates within. When more amperage is being moved through the axis circuit of the InfinityScrew, the force field becomes stronger, supplementing the strength of the engine residing within it. This reduces engine wear and fatigue immeasurably. CircleScrews are frequently combined with InfinityScrews to produce long complementary multi-layered force fields that can further protect the engine from wear and fatigue. These force fields are biology-friendly, enabling humans to pass through their layers without fear of harm.

Within the force field, the density of the cosmic fabric we call space time and gravity is “thinned” or “stretched”. As a result of stretching (or lessening) space-time-gravity (stg) density, the masses inside the force field experience a reduction of perceived inertias or momentums experienced within that force field. So mechanical parts wear very slowly because the destructive forces they experience are fractional to what they would be outside of the force field in the “denser” outer space-time-gravity field.

How can electromagnetic force fields protect against electromagnetic radiation? Radiation is experienced in different intensities or concentrations, which involves a time (length of exposure) aspect. A highly-energetic or ionizing particle does damage based on the exposure intensity (gravity and space) per the length of exposure (time). Now, imagine that you are in a toroidal force field which is thinning space time and gravity by 1,000-fold and suddenly you notice a highly energetic ionizing particle/wave is coming at you. You don't worry because you can thin or lessen its effects to 1/1000^{th} of its current intensity AND duration, experiencing only a very stretched-out ionizing effect. This means that the particle traveling through your force field (with a 1000× order of time stretch) will exert only 1/1000^{th} of its original intensity on what is within the force field, or you. Likewise, a shoe flying at you at 10,000 miles per hour would be able to hit you, but it would have the impact force of only 10 miles per hour ( 1/1000^{th} of 10,000 mph) when it did so. Thinning or stretching time is also much easier than constructing physical armament or defense against those harmful incoming inertias.

### 6. Amperage, Engine Diameter, Rotation Speed, and Time Stretch

The rotation speed and degree of time stretch are directly related to the amount of moving charge (amperes) in the axis circuit. More amps equates to greater time stretch, which generates greater rotation speeds and a stronger force field. Other determinants of rotation speed are the shape and size of the InfinityScrew. Larger toroidal systems require more amps to elicit the same rotation speeds as smaller ones. An InfinityScrew with a 6-inch diameter will rotate slower than one with a 5-inch diameter, amps being the same.

Time stretch . . . What is it? We call it “time stretch” because we stretch or borrow time in order to increase productivity, whatever that may be. When we give back the borrowed time, we get to keep all of the productivity it rendered—all of it.

The charge moving through the shaft determines a specific rpm for the engine. It will maintain a certain rpm regardless of the load being placed on it. This is the tachyon, etheron, or spirit supplementation doing the work, filling in wherever needed to keep the system going. It adds or removes as much rotational inertia as necessary to maintain the rotation speed associated with the charge. This is pretty awesome—like a tachyon tachometer or toroidal cruise control.

An engine needs to be turning to activate the torus pattern and time stretch fast enough to generate both dynamism (rotation) and displacement (advance) in the engine's inertias (spheres). This activation will require only a fraction of a revolution because spheres are being poloidally redirected whenever there is rotation. How fast this partial revolution occurs is important. Again, as soon as both toroidal and poloidal movements are present it becomes a torus. Once both conditions have been met, the addition of axis-circuit charge will fully animate the torus or InfinityScrew engine. This charge mimics the axis charge present in the vortex of every truly toroidal system.

That axis charge determines the rotation speed of the toroidal system. Per equivalent axis circuit charge, rotation speeds vary according to the diameter of the InfinityScrew engine. Bigger/wider InfinityScrew engines require more amps to rotate them equally as fast as smaller diameter IS engines. A tornado is a torus and it rotates about a vertical axis, yes? Have you ever noticed how the lower part of the tornado (a smaller diameter) rotates (rpms) much faster than the top of the funnel, where the diameter is larger? It's the same with water going down the drain or toilet. Again, the whole vortex/funnel is sharing the same charged axis. Toroids and IS engines with smaller diameters rotate faster per equivalent charge.

The stretching or thinning of space time and gravity is a protective measure the torus employs to ensure the information within the system doesn't fly apart at high rotation speeds. A toroid with a less dense space-time-gravity field enables a shaft to rotate at higher rpms without the shaft or its information melting or flying apart. Outside of time-stretch, this would be next to impossible due to the ill-tempered behaviors of matter in denser space-time-gravities. With increased charge come lessened space-time-gravity field densities, enabling higher rpms and greater productivity. So, the density of a toroid is adjustable by its axis charge, or the degree of time stretch. Less charge equates to greater space-time-gravity densities, more inertia, and more mechanical frailty. The density of the space-time-gravity toroid that we, in this 4D dimension experience, is limiting only in this space-time-gravity dimension. The InfinityScrew engines use this “thinning” (or stretching) of the space-time-gravity field density within the toroid as much as necessary for the IS engine to get the work done on time and without wear or fatigue. Keep in mind, thinning applies to all aspects of space-time-gravity, and not just to one aspect. All aspects are thinned or stretched or lightened or lessened or reduced or diminished. Mass “weighs” less and exerts less inertia, enabling greater rotation speeds. Space (opportunity required for movement) is stretched in rotation, and can render more production. Time is stretched and can render more production—more “time” within the inner 4D toroid to get the job done. And it does this in what seems like much less time to us in the outer toroidal field. We see the productivity through a lense of temporal compression, or time crunch. What has, from one toroidal dimension, seemingly taken 100 minutes to complete, can be presented to us in the relative span of 1 minute, so that it looks like everything is happening in fast-forward at a rate of 100:1.

Consider the implications of using time stretch for computing or data processing. In time stretch, processors literally have more time to compute and problem solve. The process is much easier than one might expect. Time stretch computing merely involves placing any processor within the aspect ratio generated by the InfinityScrew engine-system, where it can operate entirely within the force field generated by the toroidal inertia pattern—its Phi space. Computers would now be able to interact with us more effectively and realistically because they would have more time to analyze our expressions and inflections and determine appropriate responses. The personal computers I'm designing are small and compact and produce a rich and interactive holographic and stereo experience. Everything is projected outward from the devices' holographic projector and the user interacts with the holographic projection. This is actually no different than how we experience our daily face-to-face interactions in real life. We project and then interact with our projections as if they were real. Truth meets engineering. Or, using the illusion to transcend the illusion.

### 7. Electronics and Wiring

The wiring is very simple. Imagine a simple electrical circuit in the axis conduit of the shaft. When an electrical resistor is used to draw current through the circuit and shaft the electrical conditions for time stretch have been met. Again, the engine must also be rotating.

### 8. Safety, Defensive, and Behavioral Characteristics

InfinityScrew engines are safe and stable and extremely reliable. They even have their own defensive systems. InfinityScrew engines have near unlimited production potential and actually become more efficient and more productive, the more dynamic they become—the opposite of every other known system, as they are defined by maximums or operating limits.

InfinityScrew engines aren't susceptible to the wear and tear associated with conventional engines, rotary or otherwise. When in time stretch, there is a “thinning” effect on all of the mass (and therefore its inertia) within the system, which also lessens the inertia-born wear on bearings and parts that push against other parts.

As with most InfinityScrew engines, time stretch can take hold as long as there is sufficient engine rotation, even if initiated by hand. Thanks to being able to control the current through the axis circuit, the engine won't take off anybody's hands either because smaller charges equate to slower rotation speeds/rpms, giving lots of reaction time to the initiator to get out of the way.

If an InfinityScrew were to lose power from time stretch and electromagnetic induction were to fail, the engine would, for a period, still provide substantial thrust as its rotational inertia experiences a conservation effect whereby angular momentum systems don't lose power as quickly as linear systems do. The chance of an engine losing power, given the simplicity of the IS engine design, is next to zero. And it only requires a little active current for time stretch.

An IS engine becomes lighter as it generates more and more rotational inertia, making whatever it's attached to, lighter also. This makes IS engines very easy to handle. If an IS engine were to become too dynamic, its axis would simply begin to point away from the nearest strongest gravitational body and levitate away from it. This phenomenon is common to gyroscopes.

In greater degrees of time-stretch, IS engines are impervious to outside forces such as torque or electromagnetism, and are capable of withstanding bullets, birds, bombs (incl. nuclear), lightening, all forms of water, EMP, and fire. IS engines also run “cool”, as there is no combustion involved.

Steel or metal spheres are safely contained within strong secure pathways (tubes) that contain their movement and prevent them from flying out of the engine and hurting anyone.

No pollution comes off of IS engines—nothing is burned or released into the atmosphere, ever. There is nothing to hurt anyone's lungs or cause illness or disease. Very little sound pollution comes from IS engines. There is no deafening combustion-related roar. Only the light humm of the engines may be audible. Because there is nothing combustible, there is little risk of fire or explosion or anything that could burn or harm people or things.

### II. InfinityMatrix

The InfinityMatrix is a torus pattern generator for liquids, mixtures, and electrons. The InfinityMatrix utilizes tubes or wires to channel inertias through a curvilinear (circular plus linear) infinity pattern, similar to that of the InfinityScrew. The combination of poloidal and toroidal movement through the matrix of spiral spoke tubes or wires produces the rotational inertias and the essential torus pattern, defining the vector field of the resultant torus electromagnetic force field.

### A. Anatomical Analogies of InfinityMatrix

The InfinityMatrix has the same basic anatomical analogies as the InfinityScrew engine, save for the differences referenced below.

### 1. Spiral Design of Spokes is a Replacement for Spherical Bearings (Vertebrae or Ribs)

The spiraling shape of the spokes replaces the securing cuff sphere bearings as the anatomical equivalent of vertebrae or ribs in the InfinityMatrixes because they produce the same rotation effect as the bearings do in the InfinityScrews. Instead of bearings that enable the securing cuff to rotate around the securing cuff bracket, the spokes of the InfinityMatrix produce rotation by their spiral curvilinear design/configuration, thereby necessitating no bearings for rotation. This spiral spoke design is possible because we are using tubes and wires for liquids and electrons, which can flow around the end-curves without requiring more than a top or bottom set of redirectors, verses redirectors at both ends, as is the case with the InfinityScrew engines.

### 2. Securing Cuff (Shoulder-Scapula or Hip Socket)

The anatomy of the InfinityMatrix is fundamentally the same as that of the InfinityScrew. The most noticeable difference is that the InfinityMatrix securing cuff does not rotate as it does with an InfinityScrew. An InfinityMatrix securing cuff doesn't rotate because it doesn't need to. What's important is that the rotational inertias (liquids and electrons) are rotating within the securing cuff; producing the essential angular momentums that activate the torus. The securing cuff is meant to contain and channel the rotational inertias and enable them to flow through the InfinityMatrix system. The curvilinear spiral-wound spokes illustrate the torus pattern and make it possible for the fluids or electrons to travel a prescribed and contained curvilinear pathway through the InfinityMatrix system, generating the essential angular momentums along the way.

### 2. Redirectors/Hearts and Stomachs

InfinityMatrix redirectors redirect inertia to keep it moving in poloidal fashion throughout the system, keeping the system alive (angular momentum) during rotation. InfinityMatrix redirectors, which include ScrewBall valves and TubeScrew pumps (for driving fluid), or electronic switches and amplifiers (for driving coils), redirect inertia into and out of the InfinityMatrix system, versus simply recirculating it within the system, as is the case with InfinityScrew redirectors, which always add poloidal drive.

InfinityMatrix redirectors invariably always add curvilinear drive because the pathway of tubes or wires is already curvilinear (and both toroidal and poloidal.) InfinityMatrix tubes and wires can bend and flow their information around bends without requiring active redirection at the ends of every spoke, as is required with InfinityScrews. This means comparatively fewer redirectors, including sometimes none of them in one of the two radial end-brackets of the InfinityMatrix. One radial end-bracket might contain all of them.

### 3. Liquids or Electrons (Lifeblood inertia)

The liquids or electrons moving through the Infinity tube/wire matrix are producing rotational inertias (or angular momentums) as they go. Those rotational inertias are the lifeblood of the InfinityMatrix because they activate the torus field and enable it to animate.

### 4. Spoke (Arm or Leg)

InfinityMatrix spokes are the forms that hold the inertia-carrying tubes or wires in place. In the case of the InfinityMatrix, those spokes and their spoke tubes/wires take on a curvilinear or spiral shape, incorporating both the toroidal and poloidal aspects in the spoke so that no rotation of the securing cuff is necessary. In some sense, spiral spoke combines the leg and foot, or the masculine and feminine qualities, respectively. The masculine and feminine together produce curvilinear.

### 5. Spoke Tube/Wire (Hand or Foot)

An InfinityMatrix can use tubes or wires to produce the torus vortex pattern with liquids or electrons. These spoke tubes or wires are the anatomical equivalent of the hands or feet of the InfinityMatrix, depending on the orientation of the body and by which end it is being held.

The spiral spoke tubes or wires of the InfinityMatrixes don't require external poloidal redirectors, like those of the InfinityScrew because the spiral shape of the tubes (or wires) of the InfinityMatrix, along with the uninterrupted “flow” that occurs through the end-bends of the tubes or wires, provides a fixed curvilinear path that is both toroidal AND poloidal. This pattern unlocks the torus.

For every high-entropy spoke tube that is seen on the exterior there is a corresponding low-entropy spoke tube near the interior.

### 6. Electromagnetic Induction Assembly (Seat or Saddle) for HALO Avatar

The electromagnetic induction assembly is the control seat or saddle for HALO—the helper avatar that oversees the operation of the engine and its systems. The electromagnetic induction assemblies of InfinityMatrixes are located within the radial end-bracket(s); more often located around the hips or torso of the InfinityMatrix. The radial end-brackets can extend outward to, but not beyond, the high-entropy spokes of the InfinityMatrix. In some InfinityMatrixes, the electromagnetic induction assembly can be located within the aspect ratio space of the InfinityMatrix—within the Phi-space. The electromagnetic induction assembly may also house the InfinityMatrix fluid pumps and/or InfinityCoil signal generators, etc.

### B. Additional Details of InfinityMatrix

The InfinityMatrix has the same basic additional details as the InfinityScrew engine, save for the differences referenced below.

### 1. Aspect Ratio

InfinityMatrixes are often utilized in conjunction with InfinityCoils, occupying the aspect ratio and the gap spaces of the coil. The triple/trinity infinity pattern would seem to be the most basic for an InfinityMatrix, residing in the 9-3-6 gap space of the InfinityRing coils, left open for the etheron flux. These 3 nodal points are 120-degrees apart from each other.

### 2. Zero-Space

InfinityScrew (sphere-class) engines-systems do not utilize the zero-space whereas InfinityMatrix systems, which utilize electromagnetic space-time implosion field generator coils to produce the torus pattern and unlock the toroidal portal, do utilize the zero-space. WaterWashers and other InfinityMatrixes use the zero-space to electromagnetically re-organize matter. TelePorters use the zero-space to access the singularity for travel. As long as whatever is traveling through the zero-space is contained within a tube, or attached to something that passes uninterruptedly through, it will make it through to the other side, likely more re-organized than before. Whatever is loosely thrown into the zero-space field is gone forever. This makes it great for disposing of highly toxic or radioactive wastes. There's no trace left. All of it gets thrown into the zero-space and is electromagnetically reorganized in the singularity.

### 3. Amperage, Engine Diameter, Rotation Speed, and Time Stretch

Depending on its function, an InfinityMatrix can have any number of spiral spokes and/or circuits. Some InfinityMatrixes, like those of the InfinityCoils, have a base 9-point wind and at least 3 separate circuits. InfinityMatrixes, like the tube matrix in the WaterWasher, have a multitude of spoke tubes residing in the gap spaces of the InfinityRing coil in which it is embedded. The number of spoke tubes is dependent upon the number of 9-3-6 gap spaces in the InfinityRing coil. More reorganizing and filtering may be better served with more spokes, not fewer.

The redirectors on the InfinityMatrixes are either ScrewBall valves, if it's a tube matrix, or electronic switches, if it's a wire matrix. ScrewBall valves redirect liquid in and out of the infinity tube matrix, always in sync, maintaining the dynamic equilibrium of the tube matrix's rotational inertias. InfinityCoils, which are wire matrixes, have electronic switches for redirectors, delivering a 3-phase electrical signal to the InfinityCoil in a heartbeat-like rhythm. The blank space in the heartbeat is left open for etheron flux emanations. It is symbolic of leaving room or time for God or Spirit to work in our lives, or through us.

Tube matrixes like the WaterWasher have a filtration system on several of the high-entropy spoke tubes. It is designed after the feather or the baleen of a whale. It traps particulate and augers it away with a TailScrew auger system. Particulate can either be collected or permanently disposed of on site. The FeatherFilter is another anatomical piece, perhaps the kidneys and/or the liver.

The InfinityMatrix is a vanilla tube- or wire-winding pattern. It is used as a template design for InfinityCoils, WaterWashers, SpringSprings, and more.

Some embodiments of the InfinityMatrix have straight axis, while others have a spiral axis, or SpiralSpine. A SpiralSpine is a slinky-like extension of the axis-circuit that carries the force field around the axis circuit with it, along its entire charge-carrying length. It enables a thick tubular and robust electromagnetic force field and it is flexible, enabling it to bend and twist in order to fit. The key is that the spinal cord or axis-circuit never kink. A kink in the axis-circuit or vortex line will disrupt or destroy a torus. A spiral doesn't kink. SpiralSpines are utilized in systems like Bionics, as well as in agricultural systems like the SpringSpring. In both systems, that which resides within the electromagnetic field of the SpiralSpine axis extension is protected and supplemented in time stretch.

### III. InfinityScrew Systems

A hierarchical arrangements of certain InfinityScrew Systems are further described below.

### A. InfinityScrew

The InfinityScrew may be considered to be in a class of sphere-driven torus pattern generator with a subsystem of none because it is more primal. In particular configurations, the InfinityScrew is a reactionless gyroscopic engine (a reactionless drive) that converts rotational inertia into linear, circular, or curvilinear movement or drive. The InfinityScrew is the most basic of all InfinityScrew engines. The InfinityScrew looks like the Phi symbol and is the basic engine from which all other sphere class InfinityScrew engines originate. The InfinityScrew is one of the fundamental building blocks of all Infinity Screw engines and systems and is therefore a primary focus of this disclosure because most everything else is built around and upon it.

The basic InfinityScrew offers a spiraling perspective along the z-axis. This is the perspective of its rotational inertias from the point of view of the pathways they travel.

### B. InfinityGenerator

The InfinityGenerator may be considered to be in a class of sphere-driven torus pattern generator with a subsystem of InfinityScrew. The InfinityGenerator is what an InfinityScrew becomes when an electromagnetic induction motor-generator assembly is added around the waist-torso of the InfinityScrew. Now the InfinityScrew has become a rotor for energy production, with the electromagnetic induction assembly becoming the stator. InfinityScrews generate their own power and require no outside power sources for either starting-initiating or operating. Each InfinityScrew has its own HALO and each is wirelessly controlled. Naturally, this does away with the need for most electrical transmission wiring. Some electromagnetic induction assemblies are actually linear motors.

The InfinityGenerator can be scaled and designed to power a personal computer, a home, or an entire city. Clearly there is a deep global demand for such a versatile and simple power production device—one that could revolutionize billions of lifestyles overnight.

### C. VortexScrew

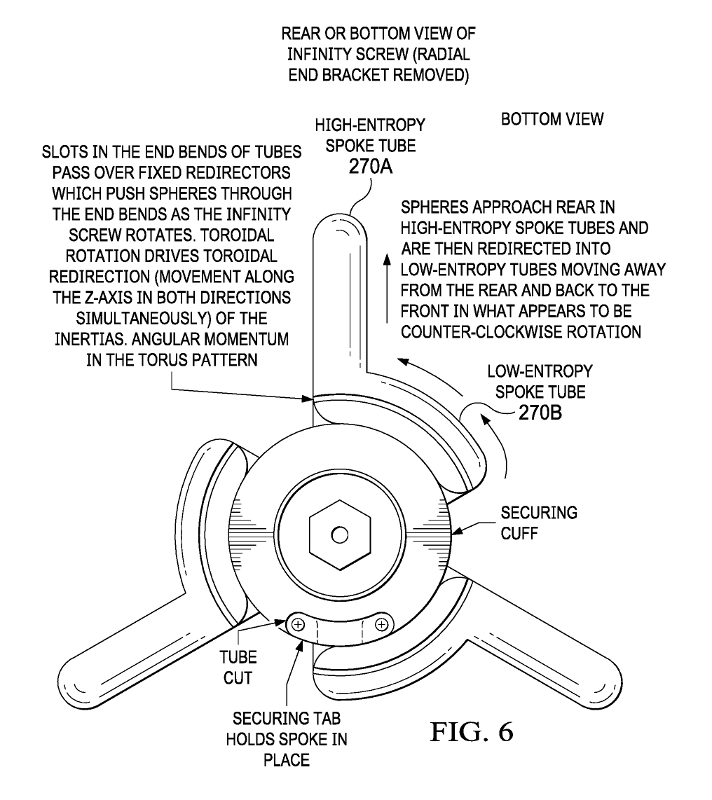

The VortexScrew may be considered to be in a class of sphere-driven torus pattern generator with a subsystem of InfinityScrew. The VortexScrew is an InfinityScrew with specialized spoke-blades (arms or legs) that vortex gases, liquids, and mixtures through pipelines, as well as provide thrust for propulsion systems. There are broad applications for the VortexScrew. An embodiment of the VortexScrew is shown in FIG. 6.

VortexScrews are found in CoolWheels, StratoFans, FanJet/FanJet Pod, HelioJet, PersonaJet, EaJet/EaJet Pod, NemoJet TubeScrews, WellScrews, SuperGills, VortexFans, and HVAC-TerraFormers.

### D. SuperShaft

The SuperShaft may be considered to be in a class of sphere-driven torus pattern generator with a subsystem of InfinityScrew. The SuperShaft is a vanilla multi-purpose torque-production design that is an InfinityScrew engine embedded within the end of a larger, more task-specific housing, like an auger or screw. The SuperShaft is usually not one long InfinityScrew. Instead, think of the SuperShaft as a cylindrical housing that the InfinityScrew slides into and secures to. The InfinityScrew resides in only part of the housing—usually just one end; not the whole length. The entire length, however, is protected equally by the forcefield generated by the InfinityScrew within the SuperShaft.

A SuperShaft is often assisted (in starting, stopping, positioning, repositioning) by a CircleDriver (a CircleScrew rotator) or a TailCone (a CircleScrew rotator). SuperShafts often do not have their own separate electromagnetic induction assemblies, as other IS engines would. Instead, the CircleScrew assistant to the SuperShaft usually initiates rotation and provides the electricity to supply the axis charge.

Supplemental force field protection for a SuperShaft can come from the addition of a CircleScrew rotator and field generator around its circumference, sharing the charged axis of the SuperShaft. This would encircle the central shaft or axis of the SuperShaft and generate a wider and more protective operating environment for both engines. The stronger the toroidal force field, the less wear and fatigue that will be incurred by an IS engine. TrainingWheels and TailScrews are both good examples of the SuperShaft. In the case of the TailScrew, the engine extension piece is not rigid, but flexible like a tail. It moves materials like dirt and concrete through tubes, over challenging distances and elevations.

SuperShafts can be embedded in any number of ways to generate rotation from within—from the very small to the very large. SuperShafts can be used everywhere rotational speed and torque are required. SuperShafts are found in TrainingWheels, SuperAxels, AnchoredAugers, and TailScrews.

### E. SuperScrew

The SuperScrew may be considered to be in a class of sphere-driven torus pattern generator with a subsystem of InfinityScrew. The SuperScrew is the most common and fundamental InfinityScrew engine and is found in almost every other InfinityScrew engine and system. Its exterior is threaded and specialized for screwing over spherical bearings. The bearings serve a dual purpose, providing “grab” for the SuperScrew threads, while enabling opposing surfaces to easily roll over one another.

When SuperScrews (or any sphere-driven InfinityScrew engine) are stopped, the recharging of the axis circuit won't start them spinning again. Typically, only the electromagnetic induction assembly can do that. This makes SuperScrews effective brakes, as well as effective drivers. SuperScrews are found in: TeleScrews, SnailScrews, and CircleScrews.

### F. TeleScrew

The TeleScrew may be considered to be in a class of sphere-driven torus pattern generator with a subsystem of SuperScrew (driver) and InfinityGenerator (power supply).

TeleScrews are strong and rigid telescoping screws that are used in many applications, particularly where extension and retraction are needed under substantial tension or torque.

Most screwing requires torque and speed but usually compromises one for the other. InfinityScrews produce near unlimited torque AND speed. They are also very compact and fit in small places that would be otherwise impossible to utilize, like within a relatively small tube.

TeleScrews contain SuperScrew engines that reside within the bases of telescoping screw tubes. They can extend or retract themselves from within their sleeve tube, depending on the direction of spin of the SuperScrew driver. These screw tubes can be nested within each other to create telescoping tubular extensors/retractors that are both very fast and very powerful. Because each section of the telescoping tube has its own engine, all segments can telescope simultaneously with blinding speed.

The tube sleeves in which the screws pull themselves along do not have conventional threads, which often provide stationary support for the screw to grab and twist over but do not provide an even, frictionless hole for the screw. Instead, TeleScrews slide in and out of sleeve tubes with almost no frictional resistance because they roll on sphere bearings set in long linear brackets set lengthwise within the hexagonal edges of the sleeve tube. The sphere bearings also provide something very solid and fixed for the SuperScrew to “bite” or “grab” and pull itself over. Linear races on the exterior of the TeleScrew's own tube (which itself is a sleeve tube for other TeleScrews), along with its hexagonal shape, keep it aligned within its host tube and prevent internal roll or rotation due to external torque. This feature also adds strength to the tube.

TeleScrews are comprised of a SuperScrew driver and an InfinityGenerator for power. This mighty duo is located in the rear of every tube segment. The InfinityGenerator sits behind the SuperScrew and provides continuous electricity to maintain the force field and initiate rotation in the SuperScrew driver. Both IS engines are initiated with power from the dual-cone electromagnetic induction motor assembly that sits between the two IS engines. HALO is located within the electromagnetic induction assembly, in the open Phi-space between the two opposite-facing induction cones.

TeleScrews are used wherever things need strength and rigidity when extended out far. TeleScrews are used in all of my inventions that require quick, smooth, and powerful extension or retraction. As within the spokes of the CreationTube, or the Skyway, or the GreenGiants—all of which hold heavy torque-producing things out on the ends of telescoping spokes, spiraling up and down (or around) a long securing cuff. In the BallJets, a TeleScrew extends and retracts the body of the thruster nozzle, also opening and closing the flow of water to the nozzle.

TeleScrews are found in SuperStruts, TeleThrusters, and Supports for other toroidal systems.

### G. SnailScrew

The SnailScrew may be considered to be in a class of sphere-driven torus pattern generator with a subsystem of SuperScrew (driver) and TeleScrew (extensors).

SnailScrews are screws that drive themselves forward as they rotate, usually over sphere drive bearings. SnailScrews can be utilized to carry structures around on their backs, just like snails carry around structures on their backs, or they can be used for circular rotation, as seen in BallJets and ScrewBall valves and several others. Typically snails are sure-footed but slow. SnailScrews are sure-footed and fast.

In order to activate time-stretch, an InfinityScrew needs to have some initial rotation to define its torus inertial field boundary. However, there is almost no way to get a screw turning with hundreds of tons resting on top of it. In order to overcome this challenge SnailScrews can retract on TeleScrews, whereby rotation is initiated by their electromagnetic induction assemblies. Once rotating, the TeleScrews, in concert, drive the rotating SnailScrew against the opposing surface until sufficient traction is obtained to move the screw and its burden forward, over that surface.

SnailScrews are comprised of one or more SuperScrews (or threaded SuperShafts) and one or more TeleScrews—producing a fast and powerful retractable driver screw that lifts and carries heavy structures. SnailScrews are also the locomotors of the larger securing cuffs and their corresponding extensor spokes, like those on the SkyWay, the GreenGiants, the CreationTubes, and the MagicChef. SnailScrews are heavy-duty lifters as well as speed demons. SnailScrews often share a common charged axis with partner SnailScrews, enabling synchronized rotation speeds for all SnailScrews on that axis.

Because SnailScrews are retractable they can withdraw into an electromagnetic induction cavity/shell to initiate rotation and then be driven outward by the TeleScrews into the medium over which the SnailScrews are traversing, which is often the spherical bearings. SnailScrews are equally effective on sand or particulate. SnailScrews (and all Infinity Screws) are also amphibious and can operate fully submerged.

The spherical bearings have dual functionality, offering both lower friction and something for the screw-shaped SuperScrew driver threads to grab hold of Once rotation of a SnailScrew has stopped, it usually takes the EM induction motor to initiate rotation again. And this happens frequently because SnailScrews are reversible. In order to keep the toroidal force field active while several of the SnailScrews are in a fixed position, one or more of the SuperScrew driver-screws is kept alive (substantial amperage through axis circuit) but in neutral. In neutral, the SuperScrew driver is still rotating, but much faster now, thanks to the greater amperage through the axis circuit. It uses this time to generate electricity, charge the axis circuit, power resistors, and charge batteries. It generates power with the aid of a half-pipe-shaped electromagnetic induction motor-generator that resides within/around the neutral space (a cavity) of every SnailScrew.

SnailScrews are found in: CircleScrews, Securing cuffs, and Spokes—for circular and linear drive.

### H. CircleScrew

The CircleScrew may be considered to be in a class of sphere-driven torus pattern generator with a subsystem of SnailScrew (driver-extensors).

CircleScrews, which include TwistGrates, CircleDrivers, and CircleCutters, are how things are rotated and protected. Each CircleScrew is comprised of an encircling ring of SnailScrews, all of them sharing the same charged circular z-axis. This is essentially like making a circular torus out of a straight one—like a smoke ring torus. As long as the SuperScrew driver engines are all the same size, they will rotate in lockstep with one another as charge is moved through the shared axis circuit.

CircleScrews consist of collections of SnailScrews, often several of them. Only two are essential for rotation, though. These SnailScrews produce a rotating perspective between two structures. Rotation occurs between two circular surfaces. One is rotating the other against itself.

CircleScrews have many utilities. In addition to rotation, CircleScrews also provide force fields that protect everything they encompass. This is particularly helpful when supplemental force field protection is required for outlying areas of an engine. As noted earlier, CircleScrews are often used in conjunction with other InfinityScrew engines to complete a protective cocoon/force field around the engine system.

CircleScrews consist of one or more SnailScrews sharing the same charged circular axis. They are fast and powerful rotators that also create an enshrining cylindrical force field around the circumference of the CircleScrew. Everything within the circular or cylindrical force field is protected. The force field of a CircleScrew is circular and encompassing but very short—only as tall as the SnailScrew drivers that make up its CircleScrew. When a CircleScrew rotates around a charged (or central vortex) z-axis, like that of another InfinityScrew with a typically straight z-axis, the CircleScrew's force field will extend along the entire length of the charged z-axis of the other IS engine, becoming a cylinder of protection and not just a circle of it. This method of filling in gaps with force fields eliminates any weakness that would cause an unsupplemented engine system to break down.

CircleScrews are ideal for situations where smooth high-powered low-end torque is required, like when initiating rotation in a boring head or the wheel of a tractor. TwistGrates, TailCones, SwivelJets, ScrewBall valves, SuperStruts, and more are driven by CircleScrews. CircleScrews are widely relied upon in Torus engineering. They provide incredible low-end torque, which means they are incredibly powerful at slow and extremely slow rotation speeds. This is possible because a CircleScrew turns forward movement along the central z-axis into a spiraling circular movement around the z-axis. SuperScrews, in contrast, are less effective at very low speeds, having a minimum rotation speed threshold that must be met in order for the torus pattern to be produced and time stretch to be able to kick in. VortexScrews and SuperShafts are most effective at higher rotation speeds, and CircleScrews are most effective at lower rotation speeds. These two types of drivers easily work together, trading off to produce both low- and high-end torque.

CircleScrews either rotate atop hip girdles or below shoulder girdles, depending on the orientation of the CircleScrew. This is determined by its primary direction of movement/travel, or by which way it most often faces when it's working.

CircleScrews are found in TwistGrates (gating), CircleCutters (boring-drilling-cutting), MagicCarpets (conveyors), ScrewBall valves (pipeline thrust gating), CircleDrivers, BigWheels, TrainingWheels, GoodGears, AnchoredAugers, TeleThrusters), TailCones (BallJets, SwivelJets, TailScrews, SuperStruts).

### I. TwistGrate

The TwistGrate may be considered to be in a class of sphere-driven torus pattern generator with a subsystem of CircleScrew.

The TwistGrate is a fast and powerful rotational gating and defense system that manages intake volumes and prevents foreign objects from accidentally entering the engine or system. TwistGrates convert linear inertias into rotational inertias. They facilitate or stop the vortexing of the inertias that cross over them—air, water, light cars, people, dirt, etc.

The TwistGrate is comprised of a rotating top grate positioned over a fixed bottom grate. The fixed lower grate is secured within the ring-like hip girdle. The hip girdle houses the CircleScrew (several SnailScrews) that rotate the top grate by its outer edge. A securing cuff bracket for a CircleScrew is either a hip- or shoulder-girdle.

The hands and arms of the TwistGrate are the SnailScrew drivers (SuperScrew-drivers and TeleScrew-extensors) that reside outside and above the hip girdle and always drive inward, towards the central axis, where they grab and rotate the securing cuff top grate. The lower body in this case is the anchor for the TwistGrate, securing it to the engine bracket. The face of the TwistGrate is a gaping mouth with radial triangular teeth. Rotation of the TwistGrate opens and closes the mouth. The skullcap is the end cap that goes on last, covering the extended bit of the shaft and securing the TwistGrate to the shaft.

### J. CircleCutter

The CircleCutter may be considered to be in a class of sphere-driven torus pattern generator with a subsystem of TwistGrate (a rotating grate for sheering and shredding).

A CircleCutter is a form of TwistGrate that has been specialized for cutting, grinding, boring and drilling. TerraBorers and VortexDrills utilize CircleCutters. Gone4Goods do too. When utilized for boring, the outer grate is covered with big teeth for ripping and tearing earth and stone, and the inner grate is for funneling debris out of the way. The CircleCutter on a Gone4Good has no exterior boring teeth. Instead, its rotating grate chops and grinds whatever is set on it. It also gates access to/from the zero-space of the Gone4Good.

### K. MagicCarpets

The MagicCarpet may be considered to be in a class of sphere-driven torus pattern generator with a subsystem of TwistGrate (rotating floor plate) and SnailScrew (starburst conveyor drivers).

MagicCarpets are designed to gently and quickly convey or redirect multiple objects inhabiting the same confined 2D surface area. MagicCarpets do this through collective combinations of rotation and upward pressure by the long gripping screws (SuperShafts) pushing up through the open slots between the aligned upper and lower grate of the MagicCarpet.

MagicCarpets are going to be a favorite of all because people will use them everyday to get to where they're going, on foot or in vehicle. These IS systems contain a circular array of SnailScrews that radiate outward in a starburst pattern from the central axis, which is positioned vertically. The upward pressure of the SnailScrew enables it to “grab” the tire or object above it. This upward pressure is generated at various places along the length of the SuperShaft gripper screws by means of TeleScrews. TeleScrews retract the long gripper screws below the grates in order to initiate their rotation. The grates of the MagicCarpets are covered in sphere bearings (in brackets) that enable things to easily slide over the top of them when the screws aren't pushed up through the grates.

Before it's pushed up against the tire or shoe or conveyee, the SnailScrews initiate rotation and time stretch so the screw can meet the object while the screw is already rotating. As long as it's moving, time stretch is capable of taking over. Things, vehicles, people, etc, can be safely floated around the MagicCarpet, or along a series of MagicCarpets, with each handing off the precious cargo to the next. MagicCarpets are also designed for use within spiraling underground tunnels called WormHoles. The spirals in the tunnels create a timing rhythm for the MagicCarpets to “flow” vehicles like water, channeling them as much as locomoting them.

MagicCarpets usually fit together in hexagonal patterns, and often have hexagonal securing cuff brackets. Through different combinations of screw rotation, the retractable starburst array of SnailScrews can quickly and articulately convey things at super speeds over long distances, up and down hills and around corners. MagicCarpets have many applications and are fun to utilize because they invoke awe in passengers and viewers. The SnailScrews in the MagicCarpet are often long and conical SuperShafts with added exterior threading to grab whatever is rolling across them—tires, shoes, cargo, etc. The InfinityScrew engine in the long gripper screw is located in the larger end of the conical screw, where it has better leverage and can exert a wider force field along the length of the screw.

MagicCarpets can also be placed on the underside of structures like large mobile beach hotels, enabling those structures to crawl speedily along the sand and through the surf

### L. ScrewBall Valves

The ScrewBall Valves may be considered to be in a class of sphere-driven torus pattern generator with a subsystem of CircleScrew (an inverted version of the TwistGrate—inside out).

ScrewBalls are high-powered ball valves that are rotated from within by a CircleScrew and shoulder girdle system, similar to the TwistGrate, whereby the shoulder girdle holds the CircleScrew firmly in place, enabling it to rotate the ball valve beneath it.

ScrewBalls are designed to rapidly gate huge flows of liquid or gas moving at super-speeds through pipelines. A CircleScrew encircling the upper end of the ball-valve gate rotates the valve and protects it in a space-time-gravity-thinning force field, ensuring it will be able to withstand.

The CircleScrew (a rotator) is embedded within the shoulder girdle of the ScrewBall. The CircleScrew gets its traction on the concentric sphere bearing rings on the top of the rotating securing cuff (the valve). The end cap of the ScrewBall valve is secured atop the protruding top of the rotating valve. In this way, one can see both the position and movement of the Screwball valve—by the rotating cap. The EM induction and HALO are on the underside of the cap. Power is captured there, where it can be fed directly to the axis circuit at its center. The EM induction is actually a circular linear motor—a linear motor wrapped in a circle or ring.

A ScrewBall valve has a CircleScrew (valve rotation) that rotates the ball valve in the center of the ScrewBall valve. The CircleScrew generates electricity and a robust protective toroidal force field around the ScrewBall valve.

SnailScrews push outward and downward along the axis, sliding into a multi-ring track of drive bearings, which are embedded in concentric rings on top of the rotating securing cuff, near its outer radial area, where the best leverage and force field protection can be given.

### M. CircleDriver

The CircleDriver may be considered to be in a class of sphere-driven torus pattern generator with a subsystem of CircleScrew.

CircleDrivers are fixed and embedded CircleScrews that rotate opposite circular surfaces with outward (poloidal) pressure—outward or away from the central z-axis and right into the drive bearings lining the interior of the securing cuff (or the interior wheel rim) that opposes the CircleDriver. Sphere drive bearings ring the securing cuff whereby the SnailScrews can grab and twist over them. The spheres are embedded within (and therefore secured to) the securing cuff.

Several CircleDrivers can share the same charged central axis. They always push outward, away from the central axis to grip and drive the securing cuff around themselves. The securing cuff bracket of the CircleDriver attaches and secures to the fixed shaft and engine bracket, around which it drives rotation of the securing cuff.

### N. BigWheels

The BigWheels may be considered to be in a class of sphere-driven torus pattern generator with a subsystem of CircleDriver (initiator) and InfinityScrew (wheel).

BigWheels are big powerful wheels for trucks and tractors and heavy-duty equipment. They aren't for water propulsion, like the CoolWheels. BigWheels have the added muscle of a CircleDriver around the rim of each wheel, giving the wheel starting torque under even the heaviest loads. Once rolling sufficiently from the help of the CircleDriver, axis-charge can activate the InfinityScrew wheel engine, enabling the CircleDriver to disengage and just produce reinforcement fields (force fields for the wheel and strut).

A BigWheel is a horizontal InfinityScrew (slow to fast rotation) in each wheel, and an added CircleDriver (very slow to slow rotation) positioned near the interior rim of the wheel, working together and trading off as rotation speeds change from stopped to low to high and back. BigWheels are great for lots of starting and stopping, forward and reverse, up and down steep hills. BigWheels are for heavy vehicles that require immense low-end torque. BigWheels utilize SuperStruts for steering and suspension. Each BigWheel SuperStrut conceals a CircleDriver elegantly hidden behind a hub-cap-like wheel cover.

### O. TrainingWheels

The TrainingWheels may be considered to be in a class of sphere-driven torus pattern generator with a subsystem of SuperShaft driver-axle, CircleDriver initiator, and TeleScrew suspension and tilt.

Diesel locomotives use a lot fuel—several million gallons each day, in the US alone. This simple application of the InfinityScrew could endlessly power every locomotive or each car, allowing for shorter, faster trains and smaller crossover gaps—better utilization of the lines.

This industry may not be around forever but this will help it for now. A train riding on TrainingWheels could safely cruise straightaways at speeds of 300+ mph. The TeleScrew suspension and tilt will lend to exceptional balance in turns, as well.

TrainingWheels are a better choice for locomotion because they can accelerate and decelerate much quicker than regular old train wheels. This alone could save many lives lost to train collisions each year. The SuperShaft that is the TrainingWheel has its InfinityScrew safely enclosed in only one end of the axle. The whole axle is protected because of the forcefield created by the IS engine at just one end and can protect the entire length of charged axis, however long it may be.

The electromagnetic induction assembly of the TrainingWheel is the CircleDriver. Each SuperScrew driver in the CircleDriver has its own half-pipe EM induction assembly. The EM induction assemblies initiate SuperScrew rotation and then take turns recapturing whatever electricity is needed to maintain axis-circuit charge, operate HALO, recharge the batteries, or to power any number of other systems. When the SnailScrews in the CircleDriver are not working or braking, they are retracted inward toward the z-axis into their EM induction half-pipes.

The SuperShaft (slow to fast rotation) in each axle works together with the CircleDriver (very slow to slow rotation) around the interior rim of one of the wheels to produce the best of torque AND speed. Together, the two IS engines move trains up, down, and all around. Telescrew extensors provide suspension and “tilt” for fast rail travel around bends.

### P. GoodGears

The GoodGears may be considered to be in a class of sphere-driven torus pattern generator with a subsystem of CircleDriver

GoodGears are CircleDrivers that rotate flat gears from within, having potentially multiple gears sharing one common axis. One could see the gear as a securing cuff that the CircleScrew drives around the shaft. The securing cuff segments of the SkyWay, MagicChef, and CreationTube, are rotated similarly, by outward pressure from SnailScrews.

### Q. AnchoredAugers

The AnchoredAugers may be considered to be in a class of sphere-driven torus pattern generator with a subsystem of CircleDrivers (rotate augers), SuperShafts (rotate augers), and SuperStruts (suspend and support augers).

This is a self-spinning auger-screw conveyor system for moving things along the length of the auger-screw, while keeping the things anchored down or secured. It is driven by a SuperShaft and accompanied by a CircleScrew (variety known as a CircleDriver). Some AnchoredAuger segments may have only a CircleDriver, and not a SuperShaft. Others may have both.

AnchoredAugers consist of a series of lengthy flexible auger screws sharing the same shaft and charged central axis-circuit and driven round and round by CircleDrivers (CircleScrews) in the linking rings of the SuperStrut (TeleScrews) support stands, which support the auger shaft segments by their ends. AnchoredAugers utilize anchored SuperStrut stands along the lengths of the augers, as needed for support. AnchoredAugers quickly and smoothly convey heavy things that are attached or hooked to them.

Whether anchored to the bottom of the ocean, ferrying underwater toroidal homes through a kelp forest along Northern California coast, or secured to the interior of a tube, ferrying people up and down steep dark tunnels in little suspended carriages by lantern light, this system can move people and things through rotation of the auger screw, which pulls or pushes them along as it rotates.

### R. TeleThruster

The TeleThruster may be considered to be in a class of sphere-driven torus pattern generator with a subsystem of CircleDriver (rotation of thruster body) and TeleScrew (extension of thruster body).

The TeleThruster is an inverted SuperStrut used for gating and steering aquatic propulsion systems. The TeleThruster extends, retracts, and rotates the thruster body of the BallJet, just like a SuperStrut extends, retracts, and rotates the thruster body of the CoolWheel or BigWheel. Similarly, a TeleThruster operates within the vortex of the thruster body, through which rotational inertias travel. As it is internally driven, it can be embedded within the thruster body, operating the extensory aspects of the thruster body from within the body itself.

A CircleDriver embedded around the shoulders of the thruster body drives outward and around, against sphere bearings in brackets surrounding the shoulders of the thruster body. The sphere drive bearing brackets are fixed to the interior of the securing cuff bracket (tube) in which the TeleThruster extends and rotates, guiding the thruster body around smoothly.

### S. TailCone

The TailCone may be considered to be in a class of sphere-driven torus pattern generator with a subsystem of CircleScrew

A TailCone is a rotating hollow tail that enables inertia to be vortexed through its interior. TailCones are for redirecting rotational inertias as thrust. They are used in SuperStruts to hold and direct the rotational inertias of propulsion thrusters like CoolWheels and JetPods. A TailCone consists of a CircleScrew rotator that rotates one circular surface over the other, with the rotating piece (securing cuff) trailing the fixed piece (securing cuff bracket). The trailing piece is the securing cuff and it contains the CircleScrew inertias. Unlike the CircleDriver, whose drivers push outward from the z-axis, or the TwistGrate, whose drivers push inward toward the z-axis, the TailCone drivers push forward, along the z-axis.

A TailCones is secured to its engine brackets with an annulus ring (radial end bracket). This annulus ring is brass (for shock absorption) and encircles the tailcone lip, covering the SnailScrews and their cavities. Sphere bearings ring the rear of the securing cuff bracket, enabling the TailCone to drive itself around them. Sphere bearings also ring the front of the securing cuff, below the annulus, enabling the annulus to exert constant inward pressure through the bearings to securing cuff. The annulus protects the wide lip or edge of the TailCone, along with the securing cuff bracket (shoulder girdle). The brass annulus presses inward (toward the z-axis) against the outer lip of the TailCone, covering their shared seam between the securing cuff and the securing cuff bracket. Brass is a very shock-resistant alloy, enabling the engine to produce sudden bursts of thrust without blowing the TailCone off or damaging the TailCone pod or the InfinityScrew engine inside of it.

### T. SwivelJet

The SwivelJet may be considered to be in a class of sphere-driven torus pattern generator with a subsystem of TailCone rotator.

SwivelJet thruster nozzles, like BallJet thruster nozzles, provide multi-directional thrust for InfinityScrew propulsion systems. Unlike BallJets, however, SwivelJets do not extend or retract. SwivelJets are for both air and water propulsion systems. All propulsion JetPods have SwivelJet (TailCones.)

SwivelJets are secured to the end of the air/water thruster delivery tube and driven by a CircleScrew, enabling full rotation of the thruster nozzle. Full rotation capability makes the SwivelJet more maneuverable while also providing a more substantial defense system.

### U. TailScrew

The TailScrew may be considered to be in a class of sphere-driven torus pattern generator with a subsystem of SuperShaft (auger) and TailCone (auger housing and auger initiator). EM Induction: TailScrew induction through rotation of the TailCone

A TailScrew is a type of SuperShaft that consists of a long flexible auger tail within a flexible tube tail, and multiple TailCones (CircleScrews) for rotating the flexible tube segments against one another and collectively locomoting the tail about, wiggling it around the worksite.

TailScrews are InfinityScrew systems designed to assist with mining, excavation, and construction. They are how TerraBorers and VortexDrills get rid of the rubble and debris they generate. TailScrews move liquids and mixtures like dirt, rubble, and concrete, over difficult distances with speed and ease. This system enables the transfer of materials out of excavation sites to awaiting storage or fill areas, and then back again when/if needed at a later time. TailScrews are instrumental to mining because of their flexibility and capacity for self-locomotion. They are incredibly safe, as well.

The auger blades on the exterior of the SuperShaft housing are outside of the force field produced by the SuperShaft engine within. These blades would normally be in harm's way and subject to excessive wear and damage. Not to worry, however, because CircleScrews will be embedded in segments of the flexible containment tube and then those lengths will be able to provide force fields around the TailScrew and its tube segments, as well as enabling the tube segments to rotate with respect to one another for locomotion purposes. By encompassing everything within the tube in a space-time-thinning force field, the material in the tube becomes less dense and easier to move, now that it too is experiencing the effects of thinned space time and gravity.

### V. SuperStrut

The SuperStrut may be considered to be in a class of sphere-driven torus pattern generator with a subsystem of TailCone (rotator), and TeleScrew (extensor-retractor).

The SuperStrut is a form of TailCone. It extends, retracts, and rotates. It redirects rotational inertias from InfinityScrews like CoolWheels and BigWheels and JetPods, to name a few. Essentially, a SuperStrut steers and stabilizes the rotational inertias being generated by the engine it secures, redirecting those rotational inertias into linear drive and propelling the craft in the desired direction of travel.

### W. BallJet

The BallJet may be considered to be in a class of sphere-driven torus pattern generator with a subsystem of TeleThruster (extensor), CircleDriver (thruster rotator), and TailCone (thruster swivel).

BallJets are highly maneuverable high-pressure water thruster nozzles that enable water propulsion systems to actively direct massive flows moving at high speeds. BallJets fully retract into the hull of the craft when not in use, extending only when necessary.

The BallJet has a TeleScrew for a central shaft (spine), upon which the torso and tail of the BallJet reside. This central TeleScrew is the mechanism by which the BallJet is extended out (opened) or retracted in (closed). The spine of the BallJet is also the gate pin that lets water begin to move through the pelvis of the thruster. When retracted, no water can enter or exit the This also protects the nozzles from foreign bodies.

This CircleDriver in the TeleThruster body also creates a cylindrical toroidal force field around the length of the tubular water feeder tube, from the central propulsion source all the way out to the nozzle of the BallJet. BallJets contain 3 very different (multi-perspective) but fundamentally self-same anatomies. One of them is a TeleScrew in the body of the BallJet. The TeleScrew is the telescoping trunk of the BallJet. The TeleScrew's arms are the radial brackets that hold the shoulders of the TeleScrew securely centered in the shoulder girdle. This enables the thruster's lower-body to slide over the TeleScrew spine. The thruster lower-body is home to the second anatomy, the CircleDriver. It rotates the lower body of the thruster. The TailCone/SwivelJet nozzle is the third anatomy. On another level, two of those three engines are comprised of smaller self-same anatomies—CircleScrews comprised of SnailScrews . . . which are each comprised of a SuperScrew and two TeleScrews . . . each TeleScrew is comprised of a SuperScrew driver and an InfinityGenerator . . . which is an InfinityScrew . . . which is a Torus pattern generator.

A SwivelJet (TailCone) rotates the tail-like jet orifice of the BallJet. The angle of the BallJet's rotating tail in relation to its spine (axis) is no accident. The angled positioning of the nozzle orifice enables us to swivel the thrust and creates yet another force field 45-degrees off from the one generated along the delivery tube's axis by the TeleScrew and the CircleScrew in the hips of the BallJet. This force field protects the TailCone as speeding water makes the angled turn after moving through the pelvis of the BallJet. The SwivelJet tail enables the water to be directed smoothly and without having to make any sharp angles when being redirected. With CircleDriver rotation of the BallJet's hips, the thruster nozzle becomes more multi-directional.

The interior of the BallJet's host tube is ringed with circular sphere bearing brackets, which enable smooth rotation and extension of the thruster body, as well as offer grip for the CircleDriver located in the hips of the TeleThruster. The CircleDriver represent the feet and legs that position and secure the body.

### X. CoolWheels

The CoolWheels may be considered to be in a class of sphere-driven torus pattern generator with a subsystem of VortexScrew (wheel), and SuperStrut (a TailCone for suspension and steering).

The CoolWheels are embedded in wheels and can be utilized anywhere wheels are utilized. And it makes perfect sense. The power for propulsion should be positioned exactly where it's needed—where the rubber meets the road—and not under the hood, where it has to be (wastefully) directed to somewhere else. CoolWheels utilize a horizontal VortexScrew (for slow to fast rotation) sandwiched in each wheel.

CoolWheels are ideal for small to medium vehicles. They are for driving on solid surfaces as well as for propulsion in water. CoolWheels are amphibious. Terrestrial transportation usually involves crossing several bodies of water (rivers, lakes, oceans, etc). Wheels that could be utilized for propulsion on land AND in water would be very helpful and therefore valuable, as they would create constant freedom of choice for the operator. CoolWheels have fixed radial impellers where the spokes on conventional wheel rims are found. When CoolWheels hit the water and their TeleScrew struts sense the proper buoyancy, the struts retract upward and can rotate in 360 degrees to provide multi-directional thrust from the spinning wheel impellers beneath the vehicle. Once in shallow enough water, struts (engine brackets) rotate and reposition CoolWheels to become rolling wheels again, carrying the vehicle out of the water and onward to the destination, wherever that may be.

CoolWheels do not utilize torque from a shaft outside of themselves, so there is no external torque on the strut (engine bracket) or the vehicle. Once rolling, even slightly, the toroidal pattern is occurring in the InfinityScrew within the wheel and time stretch can be engaged by moving electrical charge (amps) through the shaft. The selected amperage will maintain a rotation speed, regardless of the load (or lack thereof) placed on it. Think of it as toroidal “cruise control” or perhaps a “tachyon tachometer”. When you want it to spin faster, just turn up the resistor that's pulling current through the shaft. More charge equates to faster rotation and greater productivity. And once charge is applied, the IS engine goes over-unity and time stretch is occurring. Time stretch is a continuum and occurs in proportion to the amount of current that is being moved through the axis circuit in the shaft. This means that CoolWheels can rotate as fast as necessary to meet the operator's demands. This happens safely in time stretch because the engine becomes less weighty, in a space-time-gravity sense, and can therefore operate faster without being subjected to dangerously high centrifugal inertias or inertia-borne wear and tear.

The VortexScrew is completely enclosed in the wheel, sandwiched between the two hemispheres of the wheel. The wheel is the complete engine. It just has to slide onto the shaft, where it is secured by the end cap (with locking mechanism.) The SuperStrut is the engine bracket. The EM induction assembly with HALO sits above the CoolWheel like a fender. It is attached to the strut (engine bracket) and not the chassis. It initiates rotation of the Cool Wheel, then captures energy from the rotating wheel when in time stretch or overunity, as an InfinityGenerator does. The battery is also part of the electromagnetic induction assembly. The EM induction fender is also used to brake the CoolWheels.

CoolWheels don't use traditional brakes for breaking. Because amperage is determining rotation speed, the engine will naturally slow when amperage is decreased. Therefore, lessening the amperage moving through the shaft-axis acts as the toroidal brake that slows the engine to match the axis charge. In this way, braking can be quickly and smoothly achieved, and without a traditional braking system. Tires on the CoolWheels should also last a very long time because they are somewhat protected in the toroidal cocoon of the engine, experiencing only a fraction of the “wear” forces that other tires are inherently subjected to.

### Y. StratoFan

The StratoFan may be considered to be in a class of sphere-driven torus pattern generator with a subsystem of VortexScrew (fan).

The StratoFan is a VortexScrew designed for producing high-flying thrust for jet aircraft. It is unshrouded, except for a saddle-like EM induction fender assembly near the rear of the engine.

The StratoFan is held from only one end—the front end—leaving the rear of the engine free of braces or brackets. This is because braces and brackets would cause disturbance and impede the thrust vortex being generated by the engine. There is also an end cap that screws on once the engine has been screwed onto the shaft. The end cap locks the IS engine to the fixed shaft.

The StratoFan utilizes fan spoke-blades, which are shaped like a row of fan blades, arranged along the securing cuff that smoothly compress and vortex the air as it moves through the engine. Vortex compression is a common theme in toroids. When the vortexed and compressed air is exiting the engine, space time gravity “contraction” is also occurring, whereby all the extra space and time afforded in time stretch is suddenly collapsed, leaving just the production—the thrust—which occurs when the air inside the engine (torus) flows out and collides with the denser outer space-time-gravity field—the space outside the torus engine's field. In one scenario, we could be experiencing thrust that took over 30 seconds to produce (inner 4D time), experienced over only 1 second (outer 4D time.) Or, 30 seconds worth of work delivered to us in the span of 1 second.

StratoFans, like all Infinity Screw engines, can turn literally as fast as they need to in order to accomplish what is asked of them. Stretching time gives them all the time they need.

StratoFans are the “high flyers” designed for high-altitude long-haul jet travel at supersonic speeds. They can fly higher than other planes because they don't need oxygen to combust fuel. Higher altitudes reduce surface friction and enable the planes to fly supersonic without damage.

Because flights will take a fraction of the time, people won't have to make so many preparations for the discomfort typically associated with long-haul travel—jet lag, constipation, edema, bloating, dehydration, stiff joints, back pain, meal and sleep disruption, time lost during travel, and more—gone forever. And it could be extremely affordable for everyone, now that fuel expenses, long flight times, and complicated maintenance are no longer an issue for airlines. Or maybe this is meant to be the beginning of a new kind of airline. . . Just fun fun fun and faster than fast.

### Z. FanJet

The FanJet may be considered to be in a class of sphere-driven torus pattern generator with a subsystem of VortexScrew (fan), TwistGrate (gating), ScrewBall (valves), and SwivelJet (thruster nozzles).

The FanJet is a powerful, safe, and highly-maneuverable jet engine for use in most low- to medium-altitude (tropospheric) aircraft. The FanJet is an enclosed VortexScrew designed for jet propulsion in lower-altitude aircraft that need lots of precision thrust for maneuvering and power, on the spot, up and down, over and over. The FanJet is ideal for crop-dusters, regional commercial aircraft, work aircraft, recreational aircraft, and more. The IS engine size is minimal and can be retrofitted onto most conventional aircraft. IS FanJets, like all IS engines, can be customized.

The FanJet compresses air and directs it through high-pressure thruster nozzles called SwivelJets. The SwivelJets, as the name implies, swivel for multi-directional thrust. This enables the craft to make very very steep climbs and requires less runway for takeoffs and landings. When wheels touch down, SwivelJets can be redirected to produce reverse thrust, enabling very short braking distances.

The FanJet's HALO is located within the tubular belt-like electromagnetic induction assembly. The electromagnetic induction assembly sits, like a wide belt, around the rear of the engine, within the engine cavity, surrounding the IS engine. Beyond the belt, moving more deeply into the engine compartment, the air is divided between outlet ducts and then through ScrewBall valves that direct and gate thrust to the SwivelJets (knees, feet, and ankles), where the thrust meets the sky or the rubber meets the road or where the traction happens. You'll also note that the legs are just beyond the shaft (spine) where it connects to the engine-bracket. They're even tubular and bent.

The FanJet is enclosed within the engine compartment by a form-fitting shoulder girdle. The shoulder girdle of the FanJet is also the hip girdle of the TwistGrate, which gates air intake at the front of the FanJet. This TwistGrate serves at least three very important functions. It controls access to the engine's intake, it gates air intake, and it generates a cylindrical force field around the engine bracket and engine cavity. This is for safety and serves to strengthen the engine where the protective toroidal cocoon can't be generated by the rotating FanJet engine alone.

In time stretch, the fan can spin at hundreds of thousands of rpms, if necessary, and it can do it almost instantly within its protective toroidal cocoon. The engine simply doesn't experience the stresses that would liquefy other engines operating in only 4D, thanks to the space-time-gravity “thinning” effect experienced in time stretch.

### AA. FanJet Pod

The FanJet Pod may be considered to be in a class of sphere-driven torus pattern generator with a subsystem of VortexScrew (fan), Twistgrate (gating), SwivelJet (thruster), and SuperStrut (extensor-rotator).

The FanJet Pod is a shrouded outboard jet engine that could replace the shrouded jet engines used by most every airline today. Like all InfinityScrew engines, FanJet Pods don't burn any fuel. They're also fast, safe, and quiet.

### BB. HelioJet

The HelioJet may be considered to be in a class of sphere-driven torus pattern generator with a subsystem of VortexScrew (fan), TwistGrates (gating), ScrewBalls (valves),and SwivelJets (thrusters).

The HelioJet is a powerful, safe, and highly maneuverable jet engine for helicopters. It does away with messy dangerous blades and produces clean limitless multi-directional thrust via SwivelJets. Like the NemoJet, the HelioJet utilizes a centrifugal VortexScrew fan to move matter outward. Both IS engines are easily mounted within the end of the craft associated with its primary direction of travel—HelioJet on top, NemoJet on bottom.

The HelioJet shaft is further secured at each end (top and bottom) by TwistGrates with end caps. The fixed shaft of the engine is secured to the engine-bracket, which is a tubular cavity with radial outlet ducts (legs) off its equator. It might resemble the interior of a top-loading washing machine with its phallus-like agitator (shaft) sticking up. The IS engine slides onto and is then secured to the shaft. Next, the fitted shoulder girdle with embedded TwistGrate is slid/screwed into the engine cavity and secured. The outer grate that completes the TwistGrate slides on to the shaft, cupping the lower fixed grate. The tip of the shaft protrudes through the center hole of the TwistGrate and is secured by an end cap, which can be screwed on and locked.

The TwistGrate is secured to and completes the top portion of the HelioJet's form-fitting engine-bracket. It is of pivotal importance because it gates the intakes of the HelioJet engine and creates a cylindrical toroidal force field around the engine and the engine-bracket where it attaches to the craft. One could also think of the craft as part of the engine bracket. The force field is of critical importance because it enables the engine bracket to withstand the pressures generated by the VortexScrew. Sudden and explosive pressures that non-toroidal designs wouldn't be capable of managing gracefully.

TwistGrates (CircleScrews) always provide a cylindrical force field as wide as their diameters. It will extend along the entire length of the charged z-axis, around which the CircleScrew rotates. This force field thins what's within it and helps the water vortex water faster and easier, while providing supplemental strength to the pipeline. In the case of the HelioJet, the central axis runs from the top of the craft to the bottom. The CircleScrew's force field encompasses the IS engine, the engine-bracket, and part of the craft, giving it unfailing structural integrity in time stretch.

### CC. PersonaJet

The PersonaJet may be considered to be in a class of sphere-driven torus pattern generator with a subsystem of VortexScrew (fan), TwistGrate (gating), and SwivelJet (thruster).

The PersonaJet is personal jetpack that enables the wearer to fly like an eagle or swim like a dolphin—Superman and Aquaman in one. The PersonaJet is designed to propel the wearer through air and water. The VortexScrew within can spin more slowly for travel underwater, or instantly quickly for jet propulsion through the air.

Wingsuit is optional because multi-directional SwivelJet thruster nozzles makes it like a jetpack too, enabling vertical landings and take-offs. Into and out of water, as well. Dive fins, are also unnecessary because multi-directional SwivelJet thruster nozzle provides underwater maneuverability. This system works by voice command when used with the SuperGills mask-helmet. It is also designed to be controlled manually, through touch control.

A PersonaJet is personal jetpack (air & water jet propulsion system) consisting of a VortexScrew (outboard impeller) for propulsion, a TwistGrate for intake gating, and a CircleScrew-driven TailCone that puts the swivel in the SwivelJet, while protecting the engine and TailCone.

The PersonaJet engine is secured to the fixed shaft within the propulsion pod. The front of the pod is the TwistGrate, and the rear is the SwivelJet thruster (a TailCone). The TailCone assembly slides over the shoulder girdle provided by the TwistGrate in front of it, encapsulating the VortexScrew engine inside. Lastly, an annulus ring is pieced together around the TailCone and its shoulder girdle joint, enabling smooth and secure rotation of the tail cone, independent of the fixed top portion.

For safety, the PersonaJet has a gyroscopic (and self-righting) guidance system that enables the PersonaJet to take over the controls from the pilot if he/she is in danger, ensuring safe landings for anyone using a PersonaJet. Obviously people should be careful when using the PersonaJet. But they should also be able to have fun and to push the limits too. That's where the excitement is.

### DD. EaJet

The EaJet may be considered to be in a class of sphere-driven torus pattern generator with a subsystem of VortexScrew (impeller), TwistGrate (gating), ScrewBall (valves), BallJets (thrusters)

The EaJet is VortexScrew inboard impeller water propulsion system for watercraft and ships. The EaJet, embedded lengthwise in the hull of the watercraft, draws water in, drives it to the outlet pipes, through the Screwball valves, and vortexes it out through several multi-directional BallJet thruster nozzles. The BallJets are retractable, extending out from the hull only when in use.

For thrust gating, high-pressure ScrewBall valves are the way. They safely and elegantly manage how much water goes to each of the BallJet thruster nozzles. The quickness and power of the Balljets lends to incredible craft maneuverability in almost all conditions. For piloting the craft, a larger, multiple-systems HALO guidance system supercomputes dynamic optimal course options and orchestrates the EaJet's faculties.

For safety and defense, the EaJet is enclosed within the hull, where it can't injure people or marine life as it may happen over them. Likewise, the BallJet thruster nozzles are retractable and safely hidden out of the way when not in use.

For defense, the multi-directional BallJet nozzles can be directed at offenders, making breach impossible and likely damaging the other vessel.

The tubular electromagnetic induction assembly that houses HALO sits like a low belt around the rear of the engine, just in front of the thruster tubes that extend out like legs.

### EE. EaJet Pod

The EaJet Pod may be considered to be in a class of sphere-driven torus pattern generator with a subsystem of VortexScrew (impeller), TwistGrate (gating), SwivelJet (thruster), SuperStrut (steering)

The EaJet Pod is a horizontal outboard impeller screw for water propulsion. It most closely resembles the FanJet Pod, which is a shrouded aircraft jet engine. It has a front TwistGrate to gate intake and protect the engine, and a TailCone inertia redirector for directing thrust. The engine is enclosed by the SwivelJet thruster nozzle tail cone. An annulus ring helps hold the pod halves together and enables the SwivelJet to rotate. A retractable and rotatable engine bracket (a SuperStrut) holds the EaJet Pod to the hull of the watercraft. EaJet Pods are for ships or watercraft of any size.

A TwistGrate with attached shoulder girdle is the first to go on the shaft. Then the VortexScrew impeller is added on (plus end cap), followed by the SwivelJet (TailCone). The SwivelJet tail cone, or securing cuff, slides over the lip of its securing cuff bracket (which is also the TwistGrate's hip girdle) enabling the SwivelJet tail cone to rotate around. A CircleScrew embedded in the front end of the TailCone drives the SwivelJet around the securing cuff bracket, while providing a protective force field. Lastly, an annulus ring secures around the seam or joint where the securing cuff bracket meets the SwivelJet tail cone.

### FF. NemoJet

The NemoJet may be considered to be in a class of sphere-driven torus pattern generator with a subsystem of VortexScrew (impeller), TwistGrate (gating), ScrewBall (valves), BallJet (thrusters)

The NemoJet is the IS engine Captain Nemo would be using in today's adaptation of the Verne classic. Designed for submersible vehicles like submarines, the NemoJet is a vertical centrifugal impeller system that pulls water in from both below, as well as from above, and then directs it to a radial array of outgoing water delivery tubes that feed the BallJet thruster nozzles.

The belt-like electromagnetic induction assembly, like that in the FanJet, is located within the tubular cavity, or tub, into which the IS engine slides and is then secured to the shaft. Once the NemoJet's vertical centrifugal impeller engine is in place, the complementary shoulder girdle with embedded TwistGrate can be secured to the engine bracket. The TwistGrate manages the engine's intake while providing a tubular force field along the length of the axis, to the radial width of the CircleScrew in the TwistGrate. The CircleScrew should be large enough to encompass the engine-bracket so that force field protection will extend to include it.

ScrewBall valves manage waterflow between the engine and the BallJet thruster nozzles. Thrust is controlled through a combination of engine speed (time-stretch setting), TwistGrate intake setting, ScrewBall valve setting, and BallJet setting.

### FF. WellScrew

The WellScrew may be considered to be in a class of sphere-driven torus pattern generator with a subsystem of VortexScrew (impeller), TwistGrate (intake/backflow gating).

A WellScrew is essentially a VortexScrew at the bottom of a well pipe. A TwistGrate covers the bottom of WellScrew and gates inflow as well as backflow. Backflow gating enables the WellScrew to initiate rotation even when lots of heavy water is trying to move back down the well pipe.

### GG. VortexFan

The VortexFan may be considered to be in a class of sphere-driven torus pattern generator with a subsystem of VortexScrews (fans), TwistGrates (backflow gating and intake gating)

Fresh air is important to healthy living. However as structures become larger and larger, conventional ventilation systems become more costly and less effective at delivering that air in sufficient quantity.

The VortexFan is the solution that enables structures of mammoth proportions to naturally ventilate, or breathe. The VortexFan draws air in from the outside, where it moves through the structure towards its core, refreshing along the way. When the tired air reaches the VortexFan (at the core-axis of the structure), it is drawn straight up in a Venturi, where it exits the system at the top of the structure.

VortexFans are usually comprised of several segments or engines, all sharing the same shaft or axis-charge. Pulling air through the bottom and sides of the building to its center and then directing it straight up and out of the building is the most effective and efficient way to ventilate. Why? Because that's how nature does it. Have you ever seen a termite mound? The breeze passing over the top sucks the already rising warm air upward even faster, while the relative vacuum and temperature differential within the center pulls cooler outside air in and down from many radial channels leading in from the outside. The VortexFan works the same way, but with the assistance of some very powerful fans that supplement the upward draft.

The IS VortexFan is an enclosed IS engine that utilizes the Venturi effect to circulate air into and out of large structures or areas. It sucks the dead air out, cleanses it, and moves it up up and away. VortexFans are ideal for reducing the spread of diseases and eliminating airborne pathogens.

### HH. HVAC-TerraFormer

The HVAC-TerraFormer may be considered to be in a class of sphere-driven torus pattern generator with a subsystem of VortexScrew, TwistGrates, thermoelectric cooling/heating, UV purification

The centrifugal HVAC System is driven by two back-to-back VortexScrews designed to quietly move large quantities of conditioned air—hot, cold, dry, humid, or whatever. These engines can change climates indoors AND outdoors—providing comfortable healthy indoor climates or bringing much needed rain and snow to drought areas. Or they can purify smoggy air and remove harmful chemicals and pathogens. They are the terraformers that condition and clean up the atmosphere. The kind of volumes of gas they move is inconceivable in classical terms, but altogether realistic in practical toroidal time-stretch terms. It comes down to having inexhaustible power. Anything is possible if you can turn fans fast enough.

The electromagnetic induction motor assemblies are bi-conical, like the TeleScrew. Above and below it are rings of thermo-electric heating/cooling resistors designed to create the greatest energy exchange with the passing air. Humidity can be added or removed from the air as well.

Just above the thermo-electric belt is an electromagnetic field “sterilization” belt or an ultra-violet radiation (probably laser) belt, the latter for both killing pathogens and generating oxygen by means of a vacuum ultra-violet laser. It will separate carbon dioxide into carbon and oxygen. This process takes place in nature already, in the thermosphere or ionosphere. This feature makes it capable of also being a terraformer—generating a breathable atmosphere on alien planets. It could also have an ozone generator feature, not that dissimilar to Tesla's lightning balls. This feature would be atop the TerraFormer and would fuse O2 into O3. The ozonosphere is incredibly important to cancer-free life on earth because it diffuses ionizing electromagnetism that will burn (by radiation) people and lead to undesirable genetic mutations. We should be making ozone out of CO2 all the time. In a generation, Terraformers could vastly enrich the ozone layer by simply converting our overabundant greenhouse gasses (CO2) to carbon and oxygen and then from O2 to O3 with electrostatic discharge or lightning. We would not only be fortifying our ozone but we would also be regulating the planet's temperature by means of carbon capture and oxygen supplementation.

The HVAC Terraformer draws air in from both the top and bottom. It uses centrifugal fans and TwistGrates to direct air through the engines in order to achieve the desired air conditioning qualities. Then it's directed through outlets around the equators of the engines. Those outlets could direct air throughout a structure, as an HVAC system would, creating a variable and precision climate for greatest comfort and health.

For terraforming, the engine can also be used to infuse moisture into the air, which would later become rain or snow, supplementing lakes, rivers, snowpacks, and watersheds when it falls back to earth. That feature includes spiraling trumpet horn gas-expanders—billowing out clouds, for cooling, evaporation, and precipitation.

### II. TubeScrew

The TubeScrew may be considered to be in a class of sphere-driven torus pattern generator with a subsystem of VortexScrew (impeller), and TailCone (rotatable pipeline tube segments).

TubeScrews are capable of moving fluid or gas over long distances and up/down steep hills with ease. They are self-contained and enclosed within the tube or pipe for safety and security. Gas TubeScrews are essentially the same as liquid TubeScrews, except for the different spoke-blade pattern—one for gas and the other for liquids.

A TubeScrew consists of a VortexScrew in a tube or pipeline, and a CircleScrew for power and for force field generation around the length of the pipeline. The electromagnetic induction motor assembly encircles the inside of the tube, like a belt, around the rotating engine. It initiates rotation and then becomes a generator—of electricity and force fields.

TubeScrews are how one would move trillions of gallons of freshly reorganized water from the coastlines to the interior regions, where it could replenish lakes, reservoirs, rivers, etc. Bringing the water back is important. Pristine abundant waterways are essential for ecological and social health.

### JJ. TerraBorer

The TerraBorer may be considered to be in a class of sphere-driven torus pattern generator with a subsystem of CircleCutter (borer), SuperShaft (vortex auger), and TailScrew(dirt auger and its containment tube).

The TerraBorer is both a borer and an excavator, as it removes everything it cuts. With crushing power and speed, it chews up the medium and spits it out the end of a long, flexible, self-locomoting TailScrew that can keep up with the TerraBorer, eliminating the need for carts, tractors, conveyors, or other.

Both the TerraBorer and VortexDrill utilize a CircleCutter to bore and drill. The rotating outer sheering grate is convex and covered with spiraling teeth. It could be acorn-shaped. The crushed mixture of dirt and rocks it produces is easily removed and transported up the central vortex dirt auger (SuperShaft) and then out through the TailScrew dirt auger system.

A SuperShaft vortex auger in the center of the TerraBorer is embedded within the powerful rotating CircleCutter boring head. The SuperShaft dirt auger rotates independently from the CircleCutter head. The vortex auger in the middle rotates faster than the CircleCutter head. Dirt and cuttings are removed from the hole/mine by the embedded vortex auger and transferred to the TailScrew (dirt-rubble conveyer) at the top of the TerraBorer.

### KK. VortexDrill

The VortexDrill may be considered to be in a class of sphere-driven torus pattern generator with a subsystem of CircleCutter (borer), SuperShaft+TailScrew (dirt auger elevator), and TailCone (initiates rotation of the central SuperShaft dirt auger)

A VortexDrill is a dry hole (clean) drilling method that utilizes a CircleCutter to drill, a SuperShaft with TailScrew to remove rubble, and a TailCone to initiate rotation of the central SuperShaft dirt auger). The VortexDrill is held by its hips and tail, face down, at the end of a long drill pipe. A SuperShaft vortex auger (dirt vacuum) in the center of the VortexDrill is embedded within a powerful rotating CircleCutter boring head. Dirt and cuttings are removed from the hole/well, up the SuperShaft vortex auger to a TailScrew (dirt conveyer). As with the TerraBorer, the SuperShaft vortex auger in the middle rotates faster than its CircleCutter partner.

### LL. VortexElevator System and Green Giants

The VortexElevator system may be considered to be in a class of sphere-driven torus pattern generator with a subsystem of SnailScrews, TeleScrews, and CircleScrews.

A VortexElevator is a smooth and powerful spiraling elevator system for lifting everything from people to homes to vehicles to watercraft to bicycles and motorcycles, to freight, and just about anything else that needs elevating. VortexElevators are instrumental in GreenGiants, ExplorArks, CloudCities, SeaCities, and TelePorters, to name a few. VortexElevator systems can move much larger volumes of people than conventional elevator systems because VortexElevators travel in curvilinear fashion, spiraling up and down, around and round, like a vortex. The torus movement pattern makes room for lots of elevator cars to vortex up and down without waiting or colliding. Traditional elevator systems only utilize the linear path—up and down, or side to side. If buildings are ever to be over a mile tall, they will need to have elevator systems that can effectively service them. Linear elevator systems will not suffice. Curvilinear ones will. Every car on a VortexElevator is an express car.

VortexElevator spokes contain multiple SnailScrews (lifter-drivers), a TeleScrew (extensor), a CircleScrew (rotator), and sometimes a CircleScrew swivel or a TeleScrew clamp at the end of the spoke. Categorically, the securing cuff is an inverted TailCone—with the rotational inertias on its exterior and its CircleScrew rotational inertias driving downward, parallel to the z-axis of tubular shaft it rotates around.

Individuated (semi-autonomous) spokes coordinate with segmented (and also individuated) securing cuff bands in order to re-order or redirect the inertial information (angular momentums) in the VortexElevator system. Securing cuff bands look like circular bands and are comprised of several securing cuff segments that make up the circular band like links in a bracelet. A band, which is a collection of these securing cuff links, rotates around in concert with other adjacent bands in order to align pathways for the spokes to travel. Rotating securing cuff bands produce the toroidal effect, while the advancing spokes produce the poloidal effect. The VortexConveyor system works the same way, except horizontally.

VortexElevator systems utilize tall tubular structures as the shaft around which they vortex. There are many varieties of VortexElevator and they are all designed to work together, in concentric rings, like those in a tree. The central-most ring (around the central shaft), is the people and freight elevator system. The next rings outward are underground elevator systems for automobiles (garages). The next outward underground ring is the elevator system for the HomePods (underground storage and service). The above ground rings continue with the aerial HomePod ring, which spiral around the tubular exterior of the structure like a giant toroidal gyroscope.

Each of these VortexElevator systems is producing the torus pattern, as well as its own toroidal force field. Together, and embedded within one another like the rings of a tree, the force fields protect the entire superstructure from the inside out. Making it one huge multi-layered gyroscope that resists external torque and keeps the building light and upright. This is the product of layers and layers of time stretch, working together and supplementing each other. Adjusting the central axis-circuit charge simultaneously controls the degree of time stretch of all systems that share that axis circuit. In this way, the entire system can be controlled by just one variable—axis charge.

Inertia is force, and is dependent on mass (gravity) and velocity (space time). Something very small, like an electron, needs to be travelling relatively fast to produce substantial inertia for torus activation. Something very large, like an automobile or home, can be travelling very slowly and yet produce plenty of inertia with which to activate the torus. As the concentric systems move outward the inertias they handle become larger and larger—people to cars to homes.

GreenGiants are toroidal supersystems designed to provide a happy, healthy, all-in-one lifestyle experience to those who wish to live in an urban environment within a natural one. Everything, including residences, restaurants, offices, hospitals, schools, universities, organic agriculture, water management, recreation, entertainment, fitness, community, spirituality, and more, is integrated within the lifestyle experience. GreenGiants can be constructed as tall as desired. They self-stabilize like gyroscopes from within the core of the structure by creating multi-layered force fields radiating outward from the center (axis) of the structure like rings in a tree. The inertias created by the 7-toroids-in-1 (all gyroscopes sharing the same central axis circuit) is great enough to render the structure impervious to external forces or torque—from wind or missiles or nukes, or fire or hurricanes, or whatever is going down. In time stretch, these buildings cannot be damaged or destroyed from the outside because they are insulated by layers of force fields. Think of it as similar to dressing in layers. More layers equal more protection from the outside conditions.

The rotational inertias that open 5 of the 7 force fields are generated by the GreenGiant's toroidal VortexElevator systems. The force fields of the two remaining toroids are generated by the VortexFan and the Fountain of Youth.

GreenGiants can each support tens of thousands of HomePods. Each HomePod has InfinityDrives that enable HomePod inhabitants to float all over the world and dock with several GreenGiants along the way. As long as there is a GreenGiant, or other compatible SuperSystem, with a spare spoke-stem or anchor, there's a place to reconnect and rest. It will be like a floating tour of the world. They can fly, float, or dive, enabling inhabitants to spend time in a variety of unique and beautiful environments; like a Northern California kelp forest or a tropical toroidal reef matrix. Everything is now possible.

All 7 of the toroids in the GreenGiants share the same centrally charged shaft-axis and are, therefore, all kept on the same toroidal time-stretch “zone”. This is important because it prevents dimensional sheering and enables the entire system to respond in sync to changes in volume or flow by simply adjusting the axis circuit charge.

In case of any threat, the GreenGiant is protected to at least the farthest reach of the underground home/watercraft-storage spokes, which is out under the lake that surrounds the GreenGiant in all directions.

The toroidal HomePods that spiral up and down the exterior of the tubular structure on TeleScrew “limbs” offer 360-degree views of the land, sea, and sky, from all elevations, or just desired ones. Everything is possible. Each HomePod is powered by InfinityDrives that can stretch time to whatever degree the resident of that pod desires—1:2 or 1:24, the latter giving the resident 24 hours in the HomePod for the seeming equivalent of one external hour's time. What would you do with just an extra 6-8 hours every day? Time is precious and anything that can give people more time is more valuable than money.

The InfinityDrives in the HomePods also enable the pods to levitate and fly to other GreenGiants or float down to the water where they can submerge when in time stretch, as the inertial system overcomes gravity and buoyancy. They won't need NemoJets because the craft can move and steer underwater just like it can in the air. The InfinityDrives can generate imbalances in angular momentums within the InfinityDrive coils, pushing the engine and system in more of one direction than another. Cymatics may also be used.

Most people want to take travel adventures but seldom find sufficient time. HomePods are going to give people extraordinary freedom and enjoyment. Toroidal engineering is magical. Basically, these homes can live in the air, floating above the ground or hanging from a Spoke-stem, 6000 feet up. They can live underwater, anywhere in the world, cruising the oceans or secured to an AnchorAuger matrix in a giant kelp forest or a tropical coral reef.

HomePods screw together as two hemispheres sharing a vertical shaft, axis-circuit, and securing cuff bracket (pole) that connects the two halves and reinforces the craft. It also provides the axis for the InfinityDrives. At the ends of the shaft-axis are the HomePod's suspension points. They enable the HomePods to be either held from below or above—like a balloon or an apple.

These toroidal homes are always circular or Phi-like, and usually shaped like some sort of fruit or nut—an orange, an apple, a pear, an acorn, a strawberry—always derivatives of Phi. Phi is nature's form for beauty and strength and divinity and it is toroidal, also. Just a little hand-drawn heart-shaped doodle represents the torus and Phi and love. The top of the heart is the torus in expansion, bursting forth and outward (lobes of heart) and then trailing as a tail, as expansion forward transitions to collapse inward, up the rear of the torus and back (through the vortex) to the mouth—just as the energy in chakras moves from the base up through the spine and out the top of the head.

Around the base of the GreenGiant are several stress rings that double as safety and defensive systems. The deep moat that sits above the first ring is the closest to the structure and protects the structure from invading hoards. It also contains hydra-head clown daisies (like a clown's squirt flower) that emerge way out of the water and blast enormously powerful and precise jets of water at whatever or whoever is trying to breach the moat. One of these clown daisies can generate enough thrust to overturn a vehicle or shoot a helicopter into the lake.

The Helping Hands/Fists of Fury are the second stress ring, which entertains and protects us with TeleScrew-telescoping fingers that can drop straight down, creating a circular dry pit that would be difficult to cross, or they can quickly and powerfully extend upward, overturning whatever might be trying to bridge them. These fingers encircle the base of the GreenGiant and rise to upwards of 150 feet in the sky, providing a moving, flowing, bullet- and missile-proof steel shield, protected by the electromagnetic force fields generated by the TeleScrews that comprise the fingers.

The third stress ring is where vehicles enter the structure through secret underwater spiral tubes lined with MagicCarpets. Once a vehicle enters an entrance tube to a GreenGiant, all driving is finished for the driver. He can just put the car in park and turn off the engine, relaxing as the MagicCarpets flow his car through the tubes, like water. It symbolizes taking one's hands off the wheel of life and letting spirit carry them gently down the stream. There are lots of fun and poignant symbolisms like that. I am also a bit of a trickster and have always loved secret passageways and hidden entrances/exits. My designs are rich with these symbolisms. That's very toroidal—full of awe and wonder and mystery. The torus strives for that in every embodiment.

### MM. VortexConveyer System

The VortexConveyer system may be considered to be in a class of sphere-driven torus pattern generator with a subsystem of SnailScrews, TeleScrews, CircleScrews.

A VortexConveyor is a smooth and powerful spiraling conveyer/transport system for cars, motorcycles, watercraft, commercial vehicles, freight, food preparation, and manufacturing. VortexConveyors are found in MagicChefs/Cornucopias, CreationTubes, and SkyWays.

VortexConveyer spokes contain multiple SnailScrews (advancers-drivers), a TeleScrew (extensor), a CircleScrew (rotator), and sometimes a CircleScrew swivel or a TeleScrew clamp at the end of the spoke. The securing cuffs and spokes of the VortexConveyor are individuated, just like those of the VortexElevator. The securing cuff assembly of the VortexElevator, however, is categorically a CircleDriver. The VortexConveyer system drives the securing cuffs around the securing cuff bracket with outward pressure, away from the z-axis. The z-axis on a VortexConveyor is horizontal.

VortexConveyer securing cuff segments contain multiple SnailScrews driving rotation of the securing cuffs around their securing cuff brackets, which are secured around a long rigid hollow shaft containing the axis circuit. Telescoping stands (TeleScrews) support the long shaft lengths and are always in time stretch when under load. These long shafts can share multiple securing cuff bands per shaft.

The VortexConveyor system will begin to erect itself once assembly is initiated on the shaft. It does this at ground level and then raises the entire system at once, in sync. There is still some human effort involved but it is greatly assisted by the torus machines that will be paving the way, so to speak. The simplicity of the design would save trillions on roads and highways—less money and materials, less space required, and less time to build. These are space, time, and gravity savers.

The spokes and securing cuffs work together to produce the ever-rotating and ever-advancing torus pattern. When axis charge is applied, the whole system speeds up. And the pattern doesn't need to be present everywhere for the torus to become active. As long as somewhere along the shaft, the torus pattern is being generated, the entire shaft and everything along it experiences the effects. This means that not all of the spokes have to be in a perfect pattern all the time. If only a fraction of the spokes where making the pattern it would still work perfectly.

### NN. SkyWay or Rotating MonoRail or Rotating SuperHighway—A VortexConveyor System

The SkyWay or Rotating MonoRail is a transportation super-system and one of my favorites. It will save people and industry lots and lots of time and money. Through rotation, the SkyWay can move people, things, cars, goods, etc, safely within a torus electromagnetic force field at supersonic speeds. The Skyways are set up on hexagonal geometric grids that enable passengers to get from wherever they are to where they want to be in usually less than two directional changes, left or right. This is amazing.

Vehicles of all sorts (cars, boats, motorcycles, public transit, etc), as long as they are toroidal, can ride the SkyWay at supersonic speeds, entering and exiting below the SkyWay shaft, where each is secured by the transportation spoke that will lift and carry it spiraling down the line. These spokes extend and retract, clamp and release, securing the vehicle/cars by the front and rear and enabling the car to rotate about its lengthwise axis as the Skyway rotates the car around the rail. In this fashion, the cars maintain an upright position and don't roll upside-down as the shaft does. Upon arrival at destination exit, the spoke with vehicle rotates under the rail, extends its arms to the ground or exit platform, and gently releases the vehicle, now rolling down the road or perhaps on a MagicCarpet entry/exit. In this way, MagicCarpets and SkyWays can work together in rhythm, which is much faster than working separately without rhythm. Like people, these machines like to move in rhythm, whereby they are the most productive. And the rhythm is always natural—like that of a beating heart.

The SkyWay is the future of inter- and intra-state movement of goods and people. Trains can use it too, whereby each car has its own spoke and can be sent directly to its destination without having to be re-directed in railyards. Or perhaps better, transportation containers similar in function but smaller than conventional train cars, can be loaded at source and delivered with express-speed to exactly where they are needed in the exact quantity desired. Smaller cars are also safer and more manageable than larger ones.

The often-lengthy SkyWay shaft segments are sequenced together at their ends by TeleScrew support beams that, in harmony, lift or lower the shaft segments as one. This is great for several reasons. First, it enables the system to be constructed and tested and repaired very close to the ground, where it is less dangerous to people who might be working on it. Second, it can't be tampered with once it is up high in the air. With no way to climb up or access the support beams or shaft, sabotage becomes impossible. There is no way to get to the rail, except from on the rail. Because the SkyWay system controls all vehicles on its spokes, it is impossible for vehicles to stop the spoke and fiddle with the system.

The tops of the TeleScrew support beams are the engine brackets that hold the ends of the shaft segments. The TeleScrew support beams are also encapsulated in several toroidal force fields that give them super-strength and protect them along their entire length from any kind of assault or structural fatigue. In this way the whole system is completely protected and safe from wear and meddling.

Imagine how easy it would be to build bridges if it only entailed sinking a few modest TeleScrew support beams and then setting the shaft segments into place, just above the water level. Mule spokes assemble the securing cuff brackets and the securing cuffs close to ground level. Next, the TeleScrews, working in unison, lift the rail to the desired height and then you're open for business. It's a much better system, by far, than any we are currently considering. It would be so affordable and quick that no one would even believe it possible. If we use levitating construction ships, the TeleScrews could be positioned like birthday candles on a cake, from the air. This would further reduce dangers to humans and speed up the building process. Naturally, developing this infrastructure is going to require considerable labor. These systems are like that. There could be wonderful exciting employment for many millions who want to contribute their sweat and passion to building the infrastructure of a fantastic new earth, where all are free to spend their time doing what they love and find meaning in. People should be free to pursue their own passions, and not necessarily those of others. This extra time in people's lives is critical to spiritual growth and self-knowledge. Time for relaxation and self-reflection is absolutely essential to becoming an enlightened world.

For inspection and maintenance of the SkyWay line, specialized spokes can be employed. They can precisely examine and assess wear, repair worn or damaged parts, clear the SkyWay proximity of limbs, debris, obstacles, blockades, or anything. They can be designed as mules and tow-spokes, which constantly patrol for and retrieve spokes that may be stuck or damaged. Safety to humans is never compromised and the machines do all the work, beginning at set-up.

Using the SkyWay system, people could get from Los Angeles to Boston in a little over an hour, if they so desired. Others might want to travel across the country less hurriedly and could average 50 miles per hour. All of it happening at the same time, thanks to rotation, which always enables people to drop back or jet ahead. Shaft slots align for a fraction of a second whereby dozens or hundreds of spokes can squeeze by in one harmonious pulse after another.

For defense and safety, the SkyWay is set up on a hexagonal geometric grid that enables the smooth and speedy detour of any impeded route, preventing congestion of every sort. There will be no more speed limits or stop signs necessary, if the entire system is toroidal. No more accidents, no more injuries and deaths, no more pollution, no more noise, no more road-rage or boredom. Just fun, beautiful rotating 360-degree views of the picturesque landscapes along the SkyWay.

Because it doesn't burn fuel of any kind, the majority of operating expenses is gone. It also necessitates little human help to oversee and maintain. This will help enable a more rapid expansion of the SkyWay system into surrounding areas. The designs are always simple and elegant and fun. And with a little education, the masses would understand it well enough to appreciate all of its many benefits.

### OO. CreationTube or Curvilinear Stereolithography or 8D Printer—A VortexConveyor

The CreationTube was my second torus pattern system. It is a manufacturing super-system. I had been asking for a solution to the shortcomings of linear production systems, like assembly lines and health clubs. Why couldn't an assembly line make several different types of vehicles (or athletes), all at once, each perfectly customized? As long as products have to wait in line behind one another, there is wasted time and unfulfilled productivity. But if cars could pass one another in the assembly process they could reach completion when they were ready, not after the product ahead of them was completed. And by taking a big production area and wrapping it into a tube, all points of the production area are then less than one rotation from all other points within the tube.

The inside of the tube is the production area. Products are moved atop spokes in a curvilinear pattern through the tube, making contact with the production surfaces along the way. Each production surface, whether by stereolithography or assembly, adds to the product in small quick and flowing increments that reduce time spent at any one production surface or area. At the end of the process, a complete product emerges, the result of a thousand small steps. The products are moved through the CreationTube, secured to the top of spokes that, like the SkyWay, ride the slots in the multi-segmented securing cuffs forward and backward in rotation. Forward and backward is poloidal, while rotation is toroidal. Both are occurring at once, in both phases at the same time, and ongoing, if the toroidal force field is to be maintained. It accompanies the continuous expansion and contraction of the system's rotational inertias.

In high-entropy phase the spokes are extended outward and are rotating clockwise (front view) along the lengths of the securing cuffs until they reach their turnaround point or final destination. When the spokes reverse direction, and move along the shaft-axis towards the front of the CreationTube again, they will still be rotating in the same direction (clockwise from the front), but they will be hunkered down, close to the shaft, in low-entropy phase. Both phases are required for the torus to emerge and sustain. The two phases are separated by an aspect ratio.

The spokes are very dexterous and can extend, retract, rotate, swivel, and more. They are also very rigid because they need to move heavy things with precision and speed. The spoke's dexterity makes it possible to create contact with any side of the unit being produced. Like painting a teacup by hand. An arm (spoke) holds the teacup up for the hand (assemblers) to paint. The Creation tube could be thought of in a similar way.

When several “feeder” CreationTubes are added, we see a fractal geometry emerging. This geometry, like that of the Cornucopia/Magic Chef, serves many purposes, one of which has to do with the management of the information within the system. This means that from one location several systems can be directly serviced, fed, or adjusted. DNA are like this too. They are all compact and coiled up in order to keep their genetic code, or information, localized and more easily transmutable or adjustable, when necessary.

Once the CreationTube system is working in harmony, even slowly, time stretch (resulting from electrical charge being moved through the axis-circuit) will accelerate the whole rotational inertia system—which is already moving by means of time stretch—faster to keep up with the associated revolution speed associated with the charge in the central shaft's axis-circuit. In this way, the spokes, securing cuffs, and assembly systems can work at their own harmonious pace, within the toroidal bubble, while the whole bubble is simultaneously stretched or contracted; sped up or slowed down as one holistic unit, not as many.

Like the SkyWay and the GreenGiants, the CreationTube can assemble and disassemble itself. Once the TeleScrew support beams are positioned and anchored, the lengthy fixed shafts (w/axis-circuits) is set in place and secured to the TeleScrew support beams. Next, the securing cuff bracket segments are added like segmented rings around the fixed shaft. The securing cuff segments are then secured around the completed securing cuff bracket segment. Then it's time to either add another securing cuff bracket or perhaps another shaft section. Once a shaft segment has its first complete securing cuff segment, the first spoke (a mule spoke) can be inserted in one of the spoke slots in the first operational securing cuff This mule spoke will then proceed to position and secure the remaining securing cuff brackets and securing cuffs, including lifting more shafts into place between the TeleScrew support stands that elevate the rotating securing cuffs. When under construction (or repair) the system can be lowered near to the ground, as the TeleScrew support stands are retracted and not extended upward.

The CreationTube “tube” is next to be assembled. Its ring-like frame is set in place and secured by the spokes working in conjunction with the shaft and support beams. Once the ring-frame and hollow manufacturing tube is secured, the spokes begin to position the stereolithography heads and other assembly devices to the interior of the tube. Once the production surfaces and systems are in place, the rest of the spokes are added to the shaft.

Then it's testing and production time. Spokes learn the obstacle course and develop almost personalized movement patterns of their own, based largely on what type of spoke they are. This, I believe, is the result of letting the system play with itself and giving it the freedom to solve the rotational riddle—how to get to the finish line most safely, helpfully, and quickly.

There are several different types of production spokes—one for each type and size of unit. For example, a CreationTube for vehicles would have spokes for several different types of vehicles—some for motorcycles, some for cars, some for bicycles, some for watercraft, some for utility vehicles, some for commercial vehicles, etc. . . Because a bicycle is smaller and lighter than other types of vehicles, its spokes, too, will be smaller and lighter. And a bicycle's production-cycle would look very different from that of a tractor's or boat's. If spokes can pass each other in rotation, and they can, then perfect customization can also occur, making each vehicle unique and to the desired specifications of the user.

The CreationTube can be designed to make products of nearly any size—from tiny computer processors to consumer goods, pharmaceuticals, electronics, vehicles, and spacecraft, to name a few. Basically, almost anything that can be made or produced can be made or produced with a CreationTube. And it can be made or produced at incredible speeds. The only limiting factor is how fast the building block components can be fed into the assembly systems. The funny thing about time stretch, is that it only gets more productive and more efficient, the more time is stretched; as axis-circuit charge increases. This is the opposite of classical engineering, whereby everything has a limit or maximum.

The CreationTube, like all InfinityScrew engines and systems, doesn't burn fuel or anything and generates all of its own power. It operates within a toroidal force field and is mostly impervious to the wear and tear associated with linear or rotary 4D systems.

### PP. MagicChef or Cornucopia—A VortexConveyer System

The MagicChef or Cornucopia is a manufacturing super-system for time stretch food or mixture preparation. Imagine any meal, ready in seconds. This is cooking in time stretch. The Cornucopia could feed the masses and it's the way to cook in deep space—like the Jetsons!

The Cornucopia has an interesting fractal design that minimizes the space-requirement for the system while maximizing the accessibility, variability, and productivity of the system. It's like rolling a hundred or a thousand kitchens into one.

Food basics are quickly measured, combined, mixed, cooked, etc, or whatever the process may be, in time-stretch. A meal that might take several hours to cook is presented in minutes. The several hours of cooking may have still happened. It just happened in another dimension of space-time-gravity. What you experience is the compression effect of all that time stretch, experienced as productivity or lots and lots of quick healthy delicious meals for a large crowd.

### QQ. HexDrive

The HexDrive may be considered to be in a class of sphere-driven torus pattern generator with a subsystem InfinityGenerator, Holographic Projector, VortexComputing, stereophonics, and optics.

A HexDrive is an InfinityGenerator with plenty of aspect ratio space (Phi space) left open along its extensive shaft for the radial processor to slide onto. This enables time stretch computing because the processor has what seems to it like days to get the work done and solve the puzzle Both the HexDrive and the QuantumClam are the all-in-one computers—power supply, processor, memory, holographic display and keyboard, stereophonic sound, etc, all in one. The HexDrive is a small mobile personal computer, perfect for a single person.

### RR. QuantumClam

The QuantumClam may be considered to be in a class of sphere-driven torus pattern generator with a subsystem of TwistGrate, Holographic Projector, VortexComputing, stereophonics, and optics.

A TwistGrate for rotation of the upper hemisphere, around a central shaft for extension of the TwistGrate's force field along the length of the charged axis in the shaft. The bi-hemispherical TwistGrate design could hold a lot of processor/computer. The TwistGrate encircles the axis and creates a vacuous aspect ratio (Phi space) left open along its entire axis for the spherical processor/electronics to slide into. The TwistGrate powers the QuantumClam and provides the toroidal force field in which it processes. Both the HexDrive and the QuantumClam produce an interactive holographic experience that immerses the user's senses. The keyboard, like the display, is projected as well.

### SS. SuperGills

The SuperGills may be considered to be in a class of sphere-driven torus pattern generator with a subsystem of VortexScrew (pump), electrolysis, and vacuum UV laser.

SuperGills are personal rebreathers that enable people to breathe comfortably underwater without external air or power. This system fits over the face and the back of the head like a scary Halloween mask. It has a facemask that allows for unhindered multi-directional visibility and enables the user to speak via microphone and speaker system to other users or people monitoring the user(s). Because the user doesn't need a mouthpiece to draw air, the user can breathe regularly with ease.

A small VortexScrew circulates the water and provides the electricity to capture sufficient oxygen by means of electrolysis or other, as well as to provide ventilation and power to all functions of the SuperGills, including lights, optics, vacuum UV laser, gas filtering, gas mixtures, self-monitoring, etc. . .

It may be that there is a way to make dive tables irrelevant with this invention. Consider this . . . What if we're breathing the same breath of gas over and over again, while continuously supplementing it with electrolysis-generated 02, in order to keep the gas mixture of O2 to CO2 at a 1:4 mixture ratio . . . There would be no nitrogen (N) in the gas mixture—from where would it come, if not from compressed surface air, which contains roughly 80% nitrogen and 20% oxygen? Ordinarily, it's either too much oxygen or nitrogen that hurts people. CO2 is non-toxic and does not accumulate in joints like nitrogen does. If recycled CO2 were to make up the 80%, while O2 were to make up the other 20%, a diver would be free of the nitrogen “build up” in the body and could dive more often, longer, and deeper. That's it!!! SuperGills will do away with decompression-related illnesses, like the benz. Dive tables are a thing of the past! Now everyone can dive safely.

SuperGills could also include a high-altitude O2 generator that uses a vacuum ultra-violet laser to separate CO2 into C and O2.

### IV. InfinityMatrix Systems

InfinityMatrix systems are described below.

### A. InfinityCoil

The InfinityCoil may be considered to be in a class of Electromagnetic.

InfinityCoils and electromagnetic torus technologies yield an interesting host of capabilities—including control of space, time, and gravity. Since the dawn of man there has been a curiosity to explore the heavens or manipulate time. Today, these dreams are stronger than ever. Traveling to distant galaxies and star systems at faster-than-light speeds is one of the most pervasive. Another is traveling backward or forward in time, or simply having more hours in the day—more time to enjoy life. Having more time is seen as the most valuable thing in this world. Time is worth more than money.

Consider the ability to manipulate time in one's favor. It could mean a restful 8 hours of sleep in just an hour or two. Consider the ability to travel at speeds faster than light, or the ability to say “goodbye” to long flights.

Most people want space travel that's fun, safe, entertaining, and posh. And, they want faster than fast. Why can't they realize these fantasies yet? Now they can! Today, thanks to a super-phenomenon known as the torus, we have the technology to realize all of our wildest sci-fi fantasies. Soon gone are the days of terrestrial-bound life, boredom, and not having enough time in the day.

We have arrived at the dawn of inexhaustible free energy, faster-than-light travel, super-transportation systems, levitating cities and superstructures, super-health, bionics, alchemy, endless recreation, intergalactic travel, and more. All made possible by Torus engineering. Torus engineering is kind engineering because it is predictable and consistent and safe. It is also amazing because there is almost no limit to how much work torus machines can do.

There are several variations of the InfinityCoil, each relying on the core InfinityMatrix design. Some InfinityCoil engines, like the InfinityDrive spacecraft engines, utilize several InfinityDrives (InfinityCoils) stacked atop one another to produce multi-directional thrust. Others, like the TelePorter, have InfinityRings (InfinityCoils) with large and utilizable zero-spaces, where access to the singularity is possible by moving through the field generated within the hole of the InfinityRing; the zero-space. The formal name of the InfinityCoil is a flux thruster atom pulsar electrical venturi space-time implosion field generator coil, given by Marko Rodin.

The InfinityCoil utilizes Straight or SpiralSpine, InfinityDrive or InfinityRing, 3-phase sine wave signal generator, Signal amplifier, HALO—controller, Battery, Battery charger, and Resistors.

The following is a description of numbers in the user of systems described herein. The numbers 1 through 9 signify quantities AND qualities. The following applies:

### Number: Shape: Masculinity/Femininity: Function: Symbology

1: point: Masculine: the beginning: Unity

2: circle: feminine: chaos: duality

3: triangle: divine masculine expressed through the feminine: redirection: change

4: square: masculine: community: organization

5: pentagon: feminine: magical solo journey of Self-discovery: desiring and seeking wholeness or completion

6: hexagon: divine masculine expressed through the feminine: completion in form: wholeness and the ultimate in strength, beauty, function, and utility—best in form

7: septagon: masculine: ethereal journey to the Infinite: lucky quest to God—beyond form

8: octagon: feminine: infinite awareness: moving towards God's “last step”

9: diamond: God energy—masculine: return to the no-thing and God: eternal bliss

In Vortex Math by Randy Powell and Marko Rodin, number groupings include the following:

Family Number Groups: (group 1) 9-3-6 (group 2) 1-4-7 (group 3) 2-5-8

Base 9-point wind—9, 18, . . . , 72, . . . , 432, . . .

Total points will be divisible by 9 in order to accommodate all numbers (1-9)

Circuits to include at least 3 because there are 3 phases to a heartbeat; however, there may be more.

Family number group 1 (9-3-6) is the first circuit and will always be left blank or open for etheron flux emanations.

The InfinityCoil is a field generator and an electromagnetic engine designed to power spacecraft, teleporters, and levitating craft—including homes, buildings, cities, vehicles, or anything that would be good to relocate to somewhere else, if desirable.

InfinityCoils create abundant electricity and enable electromagnetic levitation, which is slightly different than mass-borne inertial levitation, which uses tangible masses to generate the required angular momentums to overcome gravity. Torus electromagnetic levitation is more flexible and easy to control because it uses magnetism instead. An InfinityCoil can create a more expansive and energetic electromagnetic bubble than other types of engines because magnetism is so fast, powerful, variable, and energetically organized. It's instant, which is certainly faster than electrons or light.

The InfinityCoils use a base 9-point 3-circuit coil-wind that reproduces the essential torus rotational inertia pattern, using electrons. The Torus movement pattern can easily be seen in the InfinityCoil wire-winding pattern. This winding pattern is essentially that of the InfinityMatrix and produces a similar electromagnetic force field along the axis-circuit to the radial width of the farthest reaching electrical inertias, which will be amplified and projected outward in time stretch, extending far beyond the radial reach of the physical high-entropy coil wires. This enables a relatively small Infinity coil to produce a very wide electromagnetic vector field and a robust and protective electromagnetic force field, in which space time and gravity are being thinned or stretched. This electromagnetic field must encapsulate the craft in order to protect it from outside forces, like torque, gravity, and all forms of electromagnetic radiation.

The InfinityCoil generates a singularity, or a vortex-bubble in space-time-gravity, or an Einstein-Rosen Bridge “wormhole”, that, in some embodiments, enables it to move interdimensionally. And it seems the only way to go through a singularity is within a craft that is itself a singularity (see works of Nassim Haramein.)

Charge (as duty-cycle) to the InfinityCoil controls the flux density, or the amount of electrical inertia in the electromagnetic field. More electrical energy equals a bigger and denser inertia field and more electrical angular momentum with which to overcome gravity or locomote.

The frequency and pulse rhythm, generated by the signal generator, controls electrical dynamism and displacement, or rotation speed and axial advance of the electrons via high-speed switches. A 1-2-3 firing sequence equals one full rotation about the InfinityCoil's axis circuit—the z-axis. First, family group 1 is activated. This means leaving an empty firing space in the pulse sequence every time it's 9, 3, and 6's turn. Family group 2, consisting of circuits 1, 4, and 7, is fired next. Then family group 3, consisting of circuits 2, 5, and 8, is fired. Together, the firing sequence sounds like a heartbeat. Blank, beat, beat . . .

Nested vortices (see VBM or Vortex Based Math), at crossovers of high- and low-entropy circuits/wires, determine the amount of etheron flux that can be emanated through the InfinityCoil per cycle. The greater the number of nested vortices, the greater potential for big power outputs at low orders of time-stretch; at lower axis-circuit charges. This means it can produce more angular momentum without needing to stretch time as much to do so. The more time is stretched, the more the torus goes interdimensional. Eventually, with enough stretch the cosmic fabric will tear. More nested vortices accompany more points in the winding. Therefore, a 72-point winding (is divisible by 9) would produce more nested vortices than a 54-point wind. This assumes that the topography/winding patterns were the same.

The aspect ratio determines the electromagnetic backdraft “implosion” potential of the InfinityCoil. Implosion precedes explosion and the greater the implosion, the greater the explosion. Greater aspect ratios could provide larger and more powerful electromagnetic fields with which to encapsulate the craft and the InfinityCoil, as well as to overcome gravity.

The aspect ratio defines the space-time-gravity within every true torus that is intentionally kept open for the information to flow over, under, and around itself—through both low- and high-entropy phases, simultaneously. In the InfinityCoil, the radii difference between the low- and high-entropy zones of the circuits is the aspect ratio. It creates an open space within the coil that enables the high- and low-entropy information channels to pass over and under one another without ever colliding or stalling.

The curvilinear appearance of the spiral spokes is easily seen in the winding pattern of the InfinityCoil. The pattern is the combination of toroidal and poloidal movements and it creates an 8D vortex-shortcut through stretched space-time-gravity.

The electrical request made upon the InfinityCoil's axis circuit is always filled, but not in our relative space-time-gravity dimension. It occurs in 8D (in multiple space-time-gravity dimensions, simultaneously) and from one toroidal perspective, seems to take no time, but from another, may seem to have taken several minutes, or hours, or days, or even years. . . . This means that it mysteriously “stretches” space-time-gravity to whatever degree necessary to summon the energy/productivity, as demanded, on time. This is how faster than light speeds are attained—in time stretch. It's not that anything is necessarily traveling faster than light. It's just that it has more time and less gravity to overcome in order to traverse the perceived time-distance field.

Toroids can expand and contract as fast as magnetism, which is instant. There are no limits to how fast they can move because they all do it in time stretch, which ensures they can do what they need to—safely, productively, and efficiently. I believe it is literally the invisible hand and bosom of Spirit, carefully cradling the torus and everything in it. A kind and benevolent force that will stretch space-time-gravity to no end in order to help its beloved contents realize their divine paths. In natural toroids, spirit or inspiration may be responsible for axis circuit charge.

The electrical charge (amps) moving through the axis circuit determines the rotation speed of the torus. Changing the axis circuit charge changes the rotation speed. With an InfinityCoil, rotation speed is initially set with the signal generator in terms of cycles per second. However, as more electrical drive or electricity is demanded from the axis circuit, everything within the toroidal electromagnetic field is sped up as one, including the rotation speed and poloidal advance of the InfinityCoil's electrical inertia.

The InfinityCoils produce an electromagnetic field (and a singularity portal). The axis circuit running right through the middle of the singularity acts as a tap by which we can extract electricity. When electrical charge or electrical drive, like that required to power electromagnetic wave generators, is requested of the axis circuit, the entire system's electromagnetic rotation speed increases without increasing the signal generator frequency. The electrical rotational inertia in the coil will increase to whatever rotation speed necessary to provide for the electrical drive requested by the axis circuit. The more electricity is requested, the more time, space, and gravity are being stretched within the InfinityCoil's electromagnetic vector field to meet that request. This gives the engine more time to fill the order; more time for etheron flux to impart electrical inertia.

The InfinityCoil is not producing the etheron flux that is being converted into electrical drive or electricity. Rather, the unwired empty gaps for family group 1 (9-3-6) allow for the etheron flux emanations to supplement the wired channels that are family group 2 (1-4-7) and family group 3 (2-5-8). Leaving family group 1 blank is like leaving space and time for Spirit to work through.

The degree of time stretch creates the appearance of incredible craft speeds. Directional propulsion mechanisms of the craft are, themselves, not responsible for the incredible “leaps” in acceleration. For colorful example, a craft moving at 20 miles per hour, in very light time stretch (×2) drawing perhaps a megawatt wouldn't seem to be moving all that fast, relative to the outside observer. But that same craft moving at 20 miles per hour in a more extreme time stretch (maybe ×1000), drawing, perhaps, a gigawatt, would have the appearance of being super-sped-up and would, perhaps, seem to be traveling at closer to 20,000 mph. It would all be relative to the observer's relative perspective of time and space—whether on the inside of the craft or on the outside.

It seems the InfinityCoil is an ideal power generation and propulsion system for craft in open space, where it can move about, free of trans-dimensional tethers (wires). Terrestrial power demands would probably be better served by InfinityGenerators, which will stay put and won't create dimensional sheer.

Virtual photon flux theory posits that positive photons/electrons and anti-photons/anti-electrons/positrons, or antimatter, are alternately popping in and out of existence, never in the same dimension at the same time. However, when near a singularity, both photons/electrons and their positron anti-matter counterparts can co-exist without mutual annihilation. Instead of destroying each other, photons/electrons move towards the singularity, or axis circuit, and are delivered to us through the axis circuit as electrical drive, or electricity. Anti-photons/anti-electrons/positrons move outward, and away from the singularity, until they encounter matter and are annihilated, perhaps balancing the flow of energy between the ethereal and form worlds.

Symbolically, the axis-circuit is the spinal cord. The securing cuff is the body and shoulders of the engine. The collections of wires are the hands. The radial end-brackets on either end of the vertical shaft are the collar and pelvis. The redirectors, or hearts, are the high-speed switches located near the top or bottom of the coil, near the radial end-bracket. And then there's the mind (and soul) of the engine, HALO, which operates in multiple dimensions and determines the order, frequency, and rhythm of the engine system, as well as the axis circuit charge, which determines the degree of time stretch and the rotation speed of the overall system. The sound of the beating heart is the essential torus rhythm.

In time stretch, the InfinityCoil reduces the gravitational effects on masses within its field. This simultaneously reduces buoyancy. This enables underwater craft to become “weightless” to the outer dimension and therefore exert zero-bouyancy in water. This can also be seen in underwater vortex bubble rings, which can both dive or ascend, depending on the orientation of their invisible z-axis. This makes it easy for the InfinityCoil to move through water without struggling with buoyancy issues. This also makes it very difficult to get injured in an accident; if the people and their vehicles only experience the inertia-effect of cotton balls. There would be no “bangs” or “splats” or “crunches”. There would be fewer or no injuries.

### B. InfinityDrive

The InfinityDrive may be considered to be in a class of Electromagnetic

The InfinityDrive utilizes an InfinityCoil design (type 2) that generates a robust electromagnetic field as well as serving as a flux thruster nozzle. InfinityDrives project an expansive torus electromagnetic field outward from the axis. Its force field appears like a swollen doughnut with a tiny hole (or zero-space). The doughnut shaped Phi-space field is supposed to encompass the craft, user, or wearer, in which the InfinityDrive is centered. InfinityDrives don't utilize the zero-space between the axis and the low-entropy wires of the coil. The zero-space of an InfinityDrive is minimized in order to outwardly project a larger electromagnetic field. InfinityDrives can generate a large Phi-space and project it outward from the axis circuit or zero-point. InfinityDrives are used for levitation and force field generation. InfinityDrives are utilized in HomePods, ExplorArks, EyeBalls, and Bionics, to name a few.

InfinityDrives can be stacked atop each other for generating multiple force field “layers”, as well as for directional thrust. The polar orientation of each coil can be variable or reversible.

An electromagnetic torus force field is generated by each InfinityDrive (and InfinityRing). When InfinityDrives are stacked along the same vertical z-axis, their force fields combine to create layers of force fields, like layers of an onion, or layers of a vortex. The more the better, generally. An InfinityDrive force field radiates and projects outward from the axis-circuit, along the entire length of the charged axis circuit.

InfinityDrives can be wound to create electrical inertia imbalances within the coil. These imbalances (of nested vortices) can be aligned/misaligned to provide multi-directional thrust. Cymatics may also be utilized to assist in thrust production.

The multiple InfinityDrives that share the same z-axis operate collectively and share the same axis circuit charge. InfinityDrives utilize a base 9-point wind (with total points divisible by 9).

All of the core electronics of the InfinityDrive, including the 3-phase sine wave signal generator, the signal amplifier, the HALO controller, batteries, charger, etc, must be physically contained along the axis-circuit (shaft) and within the radial reach of the farthest reaching high-entropy wires in the InfinityDrive coil so that it resides within the aspect ratio or Phi-space of the coil.

An InfinityDrive contains InfinityCoil, 3-phase sine wave signal generator, Signal amplifier, HALO—controller, Batteries, Battery charger, and Resistors.

### C. InfinityRing

The InfinityRing may be considered to be in a class of Electromagnetic.

An InfinityRing utilizes an InfinityCoil design (type 1) that generates a robust electromagnetic Phi-space field within its aspect ratio, as well as a zero-point portal (zero-space) between the central shaft/axis-circuit and the low-entropy wires of the InfinityRing. InfinityRings are used for accessing the singularity for teleportation, as well as for garbage disposal, as with the Gone4Good black hole waste disposal system. InfinityRings provide access to immense electromagnetic reorganizing forces within the zero-space. When combined with an InfinityMatrix, InfinityRings can reorganize and clean polluted water and air or possibly transmute mercury into gold. These processes may be positron-assisted and produce harmless but colorful Cherenkov radiation.

Phi-space is the protected life-supporting space within a torus. InfinityRings can provide both a safe Phi-space for living and working within, as well as a zero-space for access to the singularity. For this reason, InfinityRings are ideal for teleportation, disease eradication, agriculture, waste disposal, and water purification.

An InfinityRing contains InfinityCoil (base 9-point wind), 3-phase sine wave signal generator, Signal amplifier, HALO—controller, Batteries, Battery charger, and Resistors.

### D. WaterWasher

The WaterWasher may be considered to be in a class of Health Super-Systems.

The WaterWasher is a water reorganization and purification tube matrix with the classic torus “Infinity” pattern design.

The WaterWasher is comprised of an InfinityRing encompassing a watertube matrix. The watertube matrix is mostly embedded within the aspect ratio area of the InfinityRing. The rotational inertia of the vortexing water through the watertube InfinityMatrix produces the torus pattern. The faster the water vortexes through the InfinityMatrix, the easier it is to electromagnetically re-organize. The tubes on the InfinityMatrix water matrix are wrapped in an InfinityMatrix pattern. On a toroidal water matrix, the redirectors are ScrewBall valves that direct disorganized water into the matrix while directing re-organized water out of the matrix. All ScrewBall valves should work in sync so that there is no imbalance in water tube pressure as water is moved in and out of the matrix.

The WaterWasher has a dual securing cuff—2 in 1. One aspect holds the wires of the InfinityRing coil, while the other holds the water tubes firmly in place. Spokes hold spoke tubes/wires. They should hold the wire and tube pathways firmly because of the inertias moving through those wires and tubes. Spokes should be strong and firm for both rotational inertia phases (both high- and low-entropy).

Spoke tubes of the InfinityMatrix can reach between or through the 9-3-6 gap spaces of the InfinityRing coil wires to access the zero-space beyond the low-entropy wires. This zero-space is generated by the InfinityRing coil. It provides access to the immense electromagnetic reorganizing forces within a singularity. These reorganizing electromagnetic forces can renew water.

The WaterWasher vortexes water through the system at extremely high speeds, electromagnetically reorganizing the water and erasing its memory while precipitating out toxins, such as chlorinated hydrocarbons, as salts. Hexagonal water offers no loose hydrogen bonding opportunities for electrolytes. This makes the water unable to dissolve electrolytic compounds, enabling the separation of these unwanted salt-like precipitates. These precipitates simply cannot dissolve in pure hexagonal water. There is no dipole-dipole attraction opportunity for electrolytes, so the electrolytes crystallize together and can be removed with relative ease.

Electro-magnetism, in time-stretch, can do, at safe temperatures and pressures, amazing feats with water. Things that would otherwise be impossible or very dangerous can now be achieved with far less risk or difficulty. Electromagnetism can re-organize those asymmetrical hydrogen bonds and enable water to find its ideal crystalline state—as 6H20. This is the best water in the world—water in its purest and most productive and healthy form—water reborn.

Water is “clumpy” as a result of asymmetrical hydrogen bonding between H20 molecules. Hydrogen bonds can be weakened by vortexing water. As the clumpy water is vortexing, it sheens—flattening out and stretching apart, loosening and exposing those hydrogen bonds to a potential state whereby electromagnetic reordering can occur. To some extent, electromagnetic water reorganization is being utilized in agricultural systems today. These systems use partially re-organized water to grow crops and livestock, resulting in better production and efficiency, as well as better flavor. More, better tasting food that required about 30% less water to grow, thanks to the super-hydrative effects of electromagnetically reorganized water. The WaterWasher makes happy, healthy, beautiful water and precipitates out toxins and ionic compounds that shouldn't be there. Those compounds, if extremely undesirable, can be completely disposed of in the zero-space of the InfinityRing.

The WaterWasher can also desalinate water, and without the need for reverse osmosis or steam distillation. Salt, and everything not water, precipitates out and can be collected and used for other helpful and productive purposes, as desired. The majority of the salt could be re-gifted to the ocean, delivered a mile or so offshore near the bottom via an underwater TubeScrew with a long powerful TailScrew. The currents and tides would prevent saline build-ups, redistributing the salts and minerals in the vast sea.

For toroidal entertainment, the water matrix will likely glow a brilliant beautiful blue, due to the Cherenkov effect, which results when a charged particle (electron or tachyon), travels through a dielectric medium (water) with a speed greater than the phase velocity of light in that medium. Light travels through water at 75% of its usual speed in a vacuum—or 0.75 c. Perhaps Cherenkov radiation is a continuous blue electromagnetic shockwave between the inner and outer 4D dimensions.

At X-ray frequencies, the refractive index becomes less than unity and hence no X-ray (or shorter wavelength) emission will be observed. (See Cherenkov effect in Wikipedia).

A WaterWasher contains an InfinityRing (a zero-space portal generator—access to singularity—and Phi-space generator), InfinityDrives (time-stretch amplifiers and levitators for transport), InfinityMatrix (fluid torus vortex-generator), InfinityGenerator (electricity supply), ScrewBall (valves for gating fluid), AnchoredAugers (for extraction and removal of precipitates and solids from FeatherFilter), FeatherFilter (filtration system occurs in high-entropy phase), TubeScrew (pumps), TeleScrew (stands or an inflatable LifeSaver ring-stand), and TwistGrates (on top and bottom for access, security, and safety).

### E. Fountain of Youth

The Fountain of Youth may be considered to be in a class of Health Super-Systems.

The Fountain of Youth is a biological purification system for longevity and good health, as well as a toroidal zero-space portal generator and air purifier/reorganizer.

The Fountain of Youth (FoY) is a biological cleansing system placed around a VortexElevator or VortexConveyor system. It electromagnetically zaps and washes diseases and pathogens from the area and from anything passing through the area in a vortexing fashion—like the VortexElevator cars and the people in those elevator cars—preventing disease from spreading through the structure, possibly a GreenGiant or ExplorArk.

The Fountain of Youth consists of an InfinityRing and works similar to the WaterWasher, electromagnetically washing the passengers in the toroidal elevators in a rejuvenating electromagnetic shower as they spiral up and down the VortexElevator in the torus pattern. This electromagnetic field “recharges” our cells and steers diseases out of the body, enabling us to live stronger and age slower. Electromagnetic field therapy studies support this position.

A Fountain of Youth is an InfinityRing that produces a Phi-space electromagnetic field that resonates any number of healing frequencies along the entire length of the elevator tube. The electromagnetic field of the InfinityRing is not limited to a narrow segment along the axis. The charged axis-circuit spreads the electromagnetic field to its tips. If the axis circuit is not moving electrical charge (amps) then the electromagnetic field will not be extended beyond the height of the specific Fountain of Youth (InfinityRing). Axis circuit charge is what extends and amplifies the field of the Fountain of Youth coil.

The Fountain of Youth coil also thins space-time-gravity around the central shaft of the structure it serves, adding rigidity and torque-resistance from deep within the structure.

When used with a VortexFan, the area within the central shaft, around the fans, may be exposed to electromagnetism in the Fountain of Youth's zero-space, cleaning the air of pathogens, as it is vortexed up and out of the building.

The Fountain of Youth can also be used in conjunction with VortexConveyor systems, like the SkyWays, to prevent the movement of disease at the “roadway” level. As with the VortexElevator, the cleansing field extends along the entire length of the charge-carrying axis-circuit; along the length of active SkyWay axis circuit.

Fountain of Youth contains InfinityRings (generate the healing frequencies).

### F. TelePorter

The TelePorter may be considered to be in a class of Transportation Super-Systems.

TelePorters enable access to anywhere and everywhere through the zero-space field/portal. The TelePorter is a means to travel without time and distance. Its InfinityRing coil generates a torus electromagnetic zero-space field that is also a singularity portal.

The TelePorter consists of a large InfinityRing. The InfinityRing opens a large enough singularity for the teleporter pods to “dive” (up) into, through to the singularity within the zero-space electromagnetic field within the hole. The Teleporter pods can then emerge wherever in the universe there is another teleporter system equipped to send/receive passenger pods or spacecraft.

The electromagnetic shielding provided by the passenger pods is produced by an InfinityDrive coil and is essential for emerging from the singularity safely. Passengers must be encapsulated within a torus in order to move through the zero-space of another. Torus teleportation can move people and things to anywhere in the blink of an eye. It doesn't take time because time does not exist in the singularity. And there's only one singularity, seeming as many. Each zero-space portal is unique by its frequency. This may be how we are to map the singularity superhighway system.

TelePorters can teleport smaller pods from within a structure like a GreenGiant lifestyle center, or an ExplorArk spacecraft, to another teleporter in another structure. Or, a TelePorter can be a large spacecraft itself, like a large doughnut-shaped space station. People can live and work and play within the doughnut part, and people can teleport in spacecraft, HomePods, or other, through the hole in the doughnut; its zero-space; direct access to the singularity. Others can live in HomePods or craft docked around the exterior of the doughnut; like a HomePod VortexElevator system on a GreenGiant. This produces living space and another toroidal force field around the large teleporter station. Levitating TelePorters use sets of multiple InfinityDrive coils for propulsion and directional guidance. Both the InfinityDrive coils and the InfinityRing coil share the same axis-circuit and shaft, which is positioned vertically in the center of the doughnut hole. TelePorters would have multiple retractable TeleScrew legs that extend down for landings on terra firma.

TelePorters are active portals and need to be defended/protected from stray craft coming through. This is why they have TwistGrates on top and bottom of the doughnut-shaped InfinityRing—for access and shielding. TelePorter space stations could be spread out through the galaxy, wherever we go, and always enabling the quick movement of people and resources about the galaxy.

TelePorters contain InfinityRing(s) (generate a zero-space portal and a protected Phi-S space ring around the zero-space), InfinityDrives (transportation and levitation and electricity), TelePods/HomePods (the vehicles that travel through the InfinityRing's zero-space), TwistGrates (defense, containment, and shielding from unwanteds coming through the zero-space), and TeleScrews (stands that extend down to support the resting TelePorter, like legs under a horizontal doughnut).

### F. Gone4Good

The Gone4Good may be considered to be in a class of Health Super-Systems. Gone4Good is a permanent waste disposal in the blackhole via the zero-space portal. A Gone4Good is simply a way to dispose of highly undesirable refuse by discarding it into the zero-space generated by an InfinityRing coil. Refuse is loosely dropped in the top and disappears through the zero-space into the singularity, never to be seen again. This is how to completely and permanently remove the most dangerous toxins from our environment.

A Gone4Good InfinityRing coil is oriented with its top pointed down towards the ground. This enables refuse to be dropped in from above, versus shot into from below.

The TwistGrates on the Gone4Good have multiple purposes. They contain and guard the singularity portal, preventing unauthorized access to or from. They also work to chop the refuse into small enough pieces to fall freely through the zero-space portal.

The Gone4Good contains InfinityRing (generates a zero-space portal), InfinityDrive (transportation and levitation), TwistGrate (for access, safety, and as engine bracket for InfinityDoughnut), and TeleScrew stands (legs).

### G. SpringSpring

The SpringSpring may be considered to be in a class of Agricultural Super-Systems.

SpringSprings purifywater and grow plants at super speeds in time stretch. This embodiment is personal to many because of the need for food security. If you don't grow your own food or shop from local growers, then you're gonna starve when transportation lines are down. Nobody thinks of this and it's extremely important to our health and social security. With unlimited energy and wise water management, everyone in the world could enjoy proper nutrition without poisons or petro-chemical fertilizers or GMOs. Getting back to worms and bees and bats and saying goodbye to harmful ways is the way of the future.

In most states, agriculture water usage comprises 80% of the state's total water consumption. Of the water used for agriculture, most is lost to evaporation and watering earth that isn't in production. As a result, ground wells are being rapidly depleted while lakes and reservoirs are drying up. Water is one of our most precious resources and shouldn't be squandered by wasteful irrigation practices.

In this system, all supplemental irrigation in outdoor fields is done underground via a spring-in-wick system that carefully monitors and manages moisture and soil nutrients. No water is wasted on growing weeds because all watering happens underground, where the roots are. The SpringSpring pushes out water but it also pulls in water when there's too much in the soil. It knows when nutrients and minerals need to be added to the soil, as well. This technology will make farming easy to learn for city slickers.

The SpringSpring, which looks like a stretched slinky on its side, does way more than just water plants and test soil. It also uses electromagnetism to grow plants at super speeds. Plants growing in time stretch could easily receive 24+ hours of sunlight a day and will reach productivity in a fraction of the time of today's crops, enabling multiple harvests per season. The SpringSpring also sings to the plants and aligns them with the earth's frequency and circadian rhythms. Happy, strong, healthy, productive plants and crops that can be entrained in various ways by the SpringSpring.

The SpringSpring InfinityRings will produce a very deep and robust electromagnetic field that will encapsulate the roots of plants and trees within its reach, giving everything more time to grow.

A SpringSpring system could grow plants almost as fast as we could eat them. It can grow things faster in time stretch because the plants in the toroidal electromagnetic field have more time to grow, relative to our experience of time, outside the SpringSpring's electromagnetic field. This means that we'll get to see fruits, nuts, vegetables, and flowers actually growing and changing before our eyes. This will make it even more exciting to garden and farm. For example, asparagus usually requires several years to develop a substantial root system before it will start feeding anyone. In just months, any gardener/farmer using a SpringSpring could be experiencing an asparagus (and vegetable) cornucopia from the SpringSpring. And the grower determines how fast it can grow, not the calendar. The possibilities for helping people with this technology are unlimited.

A SpringSpring contains InfinityRing, Infinity tube matrix, SpiralSpine, ScrewBall (valves), and TubeScrew (pumps).

### H. Bionic Suits

Bionics Suits may be considered to be in a class of Transportation Super-Systems.

Bionic suits enable super strength in time stretch. Bionic suits enable super-speed, super-strength, levitation, interdimensional cloaking, and resistance to all external forms of torque and electromagnetism. A Bionic suit consists of a small InfinityDrive that powers the suit and generates the electromagnetic field around the wearer. This extensive field is made possible with flexible spiral axis-circuit/shaft extensions embedded within the suit. The torus's electromagnetic field follows the entire length of the charge-carrying axis-circuit and its extensions, provided there are no kinks in the axis. The SpiralSpine axis circuit and shaft can branch and run from toe to crown, enabling the wearer to be fully encapsulated within its protective field so they may safely experience fractional space-time-gravity densities without dimensional sheer. Sheering occurs where two or more space-time-gravity densities meet, usually between an inner and an outer.

In time stretch, the suit wearer could feel as strong as a dozen or a thousand men. The wearer could move at what are seemingly impossible speeds to observers outside of their relative space-time-gravity field. For example, a person walking at one mile per hour in a time-stretch factor of ×10 would seem to be walking 10 miles per hour. Getaway speeds in time stretch could equate to thousands of miles per hour, on foot.

Activators on the front of the shoulders of the suit enable the wearer to easily select degrees of time-stretch with synchronized touch patterns. These suits would make it very easy for older people or anyone who has difficulty moving about. The suit makes the wearer's experience of gravity more manageable. Imagine seeing a 70-year-old man skipping over cars. For the suit wearer, everything gets easier.

In order to stretch time, energy draws from resistors need to be placed on the axis circuit in order to make the engine work harder, expanding and contracting faster to fill the additional energy request. It's the filling of that energy request that stretches time. We'll need to come up with creative new ways to literally waste a lot of electricity, if we want more productivity, or time stretch, out of these InfinityCoil engines. For resistors, I would use electromagnetic wave generators on the back of the suit, over the shoulder blades, or lower, right next to the InfinityDrive, where it can move lots of amps over a very short (and safe) distance to the resistors.

The spiral-axis design of the Bionics system is helpful in generating a very robust electromagnetic cocoon for the wearer. What seem like many separate axis circuits are actually all just one, branched into many. The axis circuit length is what defines the axial length of the toroidal field generated by the InfinityDrive coil. Branching the axis-circuit enables us to wrap those branches around the wearer.

Bionic suits contain InfinityDrives (field generators and space-time-gravity stretchers) and SpiralSpine axis (produces a dense and robust electromagnetic field along the entire axis circuit).

### I. EyeBalls

EyeBalls may be considered to be in a class of Imaging Super-Systems

EyeBalls are levitating spheres that image, compute, and protect.

An EyeBall is a small round levitating toroidal imaging system capable of repositioning anywhere around the Earth. Because EyeBalls use InfinityDrives, they can constantly reposition, regardless of gravitational fields. They are capable of sitting and watching from anywhere, for however long. The speed and processing power of EyeBalls (in time-stretch) enables them to see “deeply” into whatever they watch, giving the optics and sensors what seem like days to collect the data that a conventional system would have only a few minutes to collect. EyeBalls are dispatched in collections of two or more for stereoscopic imaging. They fly at warp speeds, are nearly indestructible, and can hide interdimensionally when cloaking.

EyeBalls are our best bet at detecting and dispatching earthbound asteroids. EyeBalls have it covered.

EyeBalls can be scaled to any size and they use multiple InfinityDrives for power and propulsion, along with cymatics for guidance. As with any InfinityCoil, EyeBalls can unleash nearly unlimited power, and their HALOs process in 8D, giving them time stretch computing capabilities. EyeBalls have many diverse and helpful applications, in addition to those few mentioned here.

Another very helpful purpose for EyeBalls is for powerful broadcasting. EyeBalls are very easy and inexpensive to build and could be quickly positioned to levitate everywhere in the mesosphere (just above the stratosphere) where they could broadcast to the people of the whole world. Every person with an antennae or radio or satellite dish or cell phone would be able to receive the nearby and extremely robust transmissions, powered by the EyeBall's InfinityDrives. Internet, wireless, and GPS would also be well served by EyeBalls.

Before now, nobody has been able to put a big receiver/transmitter in the mesosphere. This is because there is nothing to keep it there. EyeBalls will be higher than planes, balloons, or missiles, but much lower than low-earth orbit, giving them residence where there is nothing to crash into. These positions in the mesosphere also afford considerably better imaging vantage points than those in low-earth orbit.

For safety, EyeBalls can be utilized for all sorts of traffic management, especially sea and air traffic. They will be the unfailing traffic guidance system that gets everything safely to where it wants to go. Hundreds, if not thousands, could oversee all the skies, levitating in perfect lattice position, together forming a GPS system and traffic-services management grid for everyone to use. This grid is also geometric in design. Hexagons, triangles, and diamonds.

Planes, especially, will literally always be in sight of the system. In the event of a mayday situation, the system would spot the plane and have escort EyeBalls deliver it gently to the ground or an awaiting ship. We can literally catch planes before they reach the ground, ensuring much greater survival rates of passengers.

EyeBalls contain InfinityDrives, TwistGrates, TeleScrews, Processors, and Imaging Hardware and systems.

### J. HomePods

HomePods may be considered to be in a class of Lifestyle Super-Systems.

HomePods are the ultimate mobile homes. HomePods are designed to fly, float, swim, and hang. They are levitators.

Consider the ability to go anywhere and always bring your home with you. HomePods are sure to be a hit because they are levitating mobile homes that don't burn fuel and can travel anywhere around the earth at time-stretch speeds. They are designed to dock at various torus superstructures, like on the spoke-stems of GreenGiants, or on AnchoredAuger systems. HomePods are toroid-shaped; like a fruit or vegetable or nut. Some are round like an orange.

HomePods are powered by multiple InfinityDrives, which thin or stretch space time and gravity around and within the HomePod, suspending gravity's hold and enabling it to be levitated elsewhere.

The InfinityDrives can also stretch time for the personal enjoyment of the inhabitants of HomePods, giving them more hours in their days to recreate, as well as more time to sleep.

TwistGrates provide privacy and electromagnetic shielding for HomePods.

HomePods contain InfinityDrives, WaterWasher, TwistGrates, TeleScrews, TubeScrews, and InfinityGenerators.

### K. ExplorArk

The ExplorArk may be considered to be in a class of Exploration Super-Systems.

ExplorArks are vertically postured intergalactic spacecraft that offer people a plentitude of posh cosmic perspectives. SpaceFleets will use these instead of saucer craft to move about the star systems. These are large, posh, and fast. They come with a cool upright docking station that makes it fun and easy to embark and disembark. It also makes a great entrance and fits in tight urban areas where there's no room to set down a huge saucer or sphere craft. These other shapes also don't have the higher ratio of windows to passengers that makes space travel fun like an ExplorArk. Consider it, if you were going to be traveling in space, wouldn't you want to see what was outside of the craft in order to gain a relativistic perspective? Today's astronauts are given the equivalent of being locked in the trunk of a space Yugo.

The ExplorArk is powered by multiple large InfinityDrives that work together to electromagnetically insulate the craft within multiple toroidal force fields. The ExplorArk also has a VortexElevator system with a Fountain of Youth.

ExplorArks and other spacecraft will have teleporters on them so crews and visitors can easily move about between earth and between other ships at superluminal speeds.

ExplorArks contain InfinityDrives, TwistGrates, TeleScrews, VortexElevators, AnchoredAugers, VortexFan, Fountain of Youth, HVAC and Terraformer, SpringSpring, TelePorters & TelePods, GoneforGood, WaterWashers, MagicChef, CreationTube, EyeBalls, TerraCraft, and BionicSuits.

### L. TerraCraft

The TerraCraft may be considered to be in a class of Transportation Super-Systems.

The TerraCraft is a toroidal spaceship designed for planetary and interplanetary travel. It can be relatively small and easy to maneuver and has TeleScrew landing gear. It is driven by InfinityDrives and cymatics. TerraCraft operate within a multi-layered electromagnetic field, which protects the craft from external forces like torque and electromagnetism and enables it to move at superluminal speeds within a self-generated space-time vortex.

TerraCrafts contain InfinityDrives for levitation and propulsion, TeleScrew stands, and TwistGrates for electromagnetic shielding.

### M. HoverStructures and FloatingCities

HoverStructures and FloatingCities may be considered to be in a class of Lifestyle Super-Systems.

Consider the capability for one's office, classroom, home, building, or city, to float, thereby making everyday a productive fieldtrip. People would be delighted to work and learn and live.

HoverStructures are levitated and driven by multiple InfinityDrives. In case of emergency or threat, the entire structure can levitate away to another haven. These structures can be open or closed or convertibles, depending on the purpose of the structure. Floating gardens and parks would be better open, while classrooms would probably be better as convertibles. Very cold climates or underwater/floating structures/cities might be better if closed. There are almost endless possibilities and opportunities that come with toroidal levitation.

HoverStructures use InfinityDrives for levitation. Larger HoverStructures can also incorporate InfinityRings, VortexElevators, VortexConveyers, AnchoredAugers, VortexFan, Fountain of Youth, HVAC and Terraformer, SpringSpring, TelePorters & TelePods, GoneforGood, WaterWashers, MagicChef, CreationTube, EyeBalls, TerraCraft, BionicSuits, and HomePods.

### N. AgOasis

The AgOasis may be considered to be in a class of Agriculture Super-Systems.

The AgOasis is a sustainable and satisfying agriculture and ecosystem designed around water. Agriculture is essential to every nation and all people. Without it, civilization will collapse. The economic and social security of everyone depends on it. And, yet it is unknown by most and controlled by a smaller and smaller few who often have little knowledge of life sciences and the inner workings of the larger ecologies.

The agriculture system of tomorrow will look very different than it does today and it will have better, more benevolent players than it currently does. The AgOasis is the toroidal answer to sustainable healthy agriculture. With it, the entire world could experience nutritional abundance and food security. There would be no more drought, minimal pestilence, and no more GMOs. Holistic, self-organizing ecologies that include bees and bats and organic production methods.

The AgOasis oversees virtually all aspects of the agricultural system—irrigation, fertilization, pest control, water management, and more. The WaterWasher purifies the water, making it healthy and extremely productive. The SpringSpring uses the washed water (6H20) to irrigate the plants at their roots, where no water is lost to evaporation or wasted growing weeds. The SpringSpring is also the growth-accelerator. The SpringSpring stretches time around the plants, giving them more sunlight each day and more rest each night. Healthier plants are the result of this kind of agriculture. Plants grown in time stretch are incredibly hearty and can fight off most diseases by themselves without the need for chemicals and poisons that further throw the ecological system out of balance.

The AgOasis is laid out on a hexagonal geometric grid that facilitates productivity, recreation, community, and the environment and ecology. It enables man and nature to co-exist in harmony, without compromising anything for either. The encircling waterways separate the wildlife from the farming areas, minimizing crop damage and providing clear well-established areas and paths for wildlife to roam, and to come and go as it pleases. These waterways also provide clean water, recreational fishing, aquaculture, deep moats for impasse, recreational sports, and water for bees and bats and wildlife. Water is essential to life. We all like to play around it. Why not integrate it into our agrarian societies? It needs to be more holistically integrated everywhere, and now it can.

The AgOasis is a bigger-picture system than ties everything together to create a sustainable agrarian lifestyle for all who would like to become farmers or live an agrarian life. The SpringSpring and the WaterWasher are integral parts of the AgOasis.

Unlike farming communities of today, where neighbors hardly know each other, the AgOasis communities are designed for much greater and more meaningful social interaction within and between communities. Being a farmer historically comes with a lot of boring moments spaced between a few very busy ones. This isn't right. Being a farmer should be one of the most enjoyable, satisfying, purposeful, and sought after professions on earth. More people would get into agriculture if it was simple and fun and that's the AgOasis—agriculture that's simple and fun. If it's fun and meaningful, people will clammor to do it. If it's boring and lonesome, they won't. The world desperately needs good farmers—a multitude of kind ones.

The AgOasis can be set up in what are currently considered non-arable regions if supplemented by the other toroidal systems like the pipelines and water pumps that bring fresh water from seaside desalination areas (by large WaterWashers) to the interior lands where it is required for agriculture and lifestyle. Agriculture will be in places that it isn't now, as water delivery systems (infrastructure) are developed. Countries with oil and deserts, like those in the Middle East or Africa, will be able to switch from oil to agriculture, almost overnight, using the AgOasis and SpringSpring systems. People who had no work or food will now be able to work growing food so plentiful that they can sell, trade, or give it to others. This planet, if farmed properly and gently, could provide the entire population with gourmet organic foods—naturally and indefinitely.

AgOasis contains WaterWasher, SpringSpring, and AgOasis geometric grid.

FIG. 6 shows a bottom view of the InfinityScrew, radial end bracket removed;

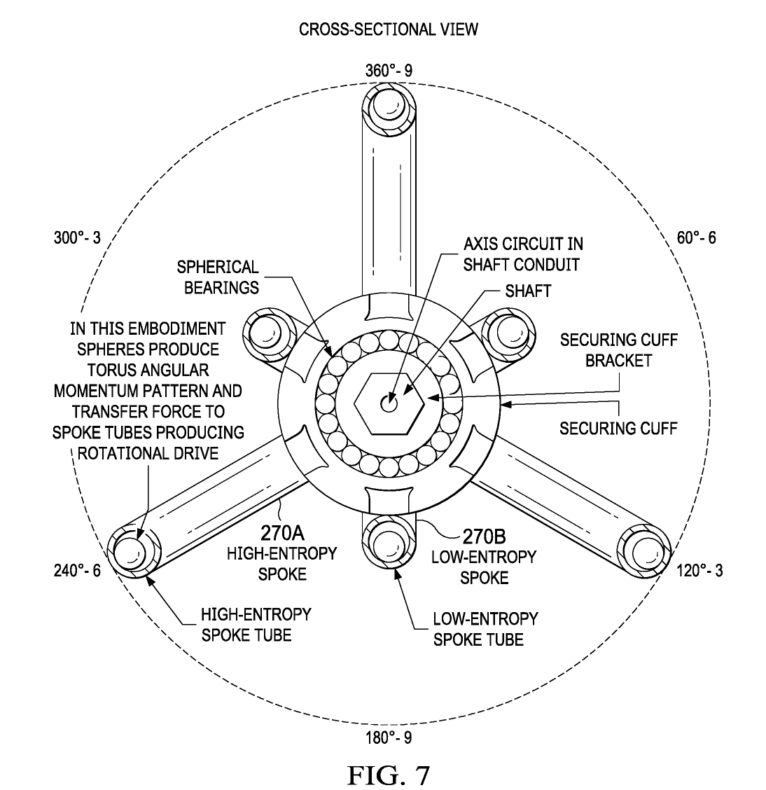

FIG. 7 shows a cross-sectional view of the InfinityScrew;

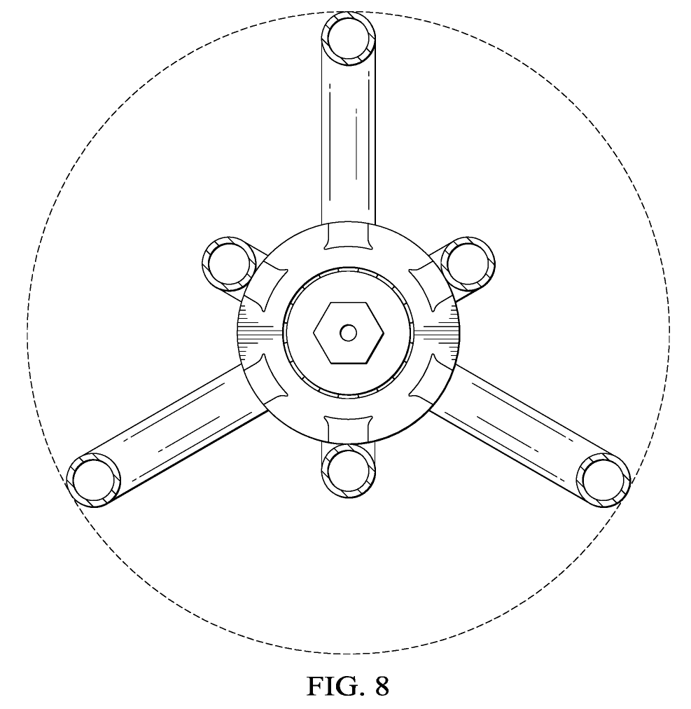

FIG. 8 shows a cross-sectional view of the InfinityScrew;

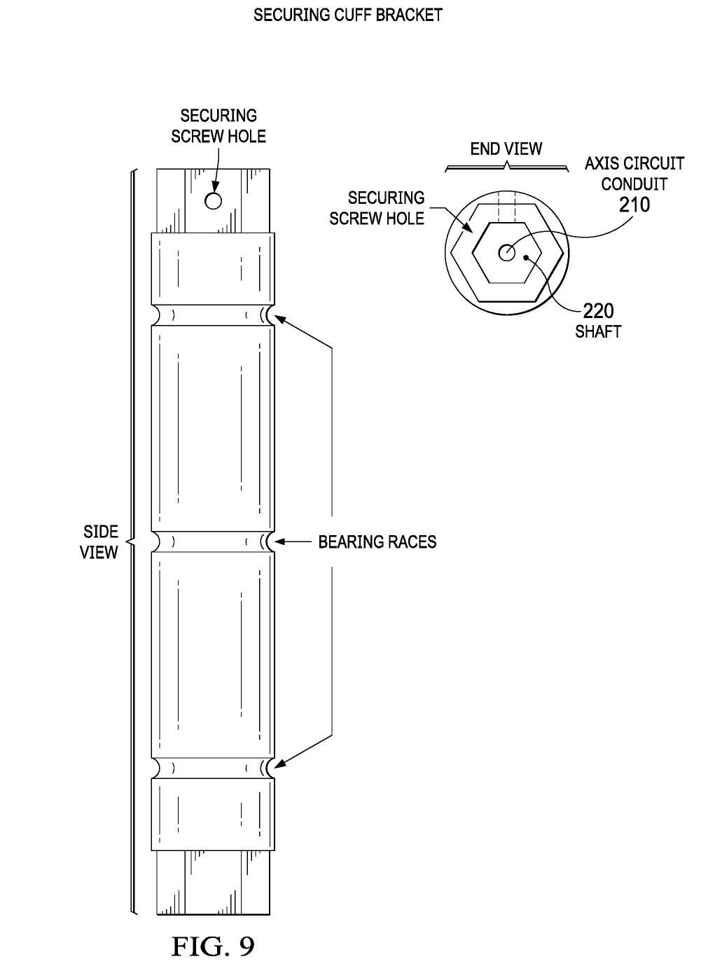

FIG. 9 shows a side view of the InfinityScrew securing cuff bracket;

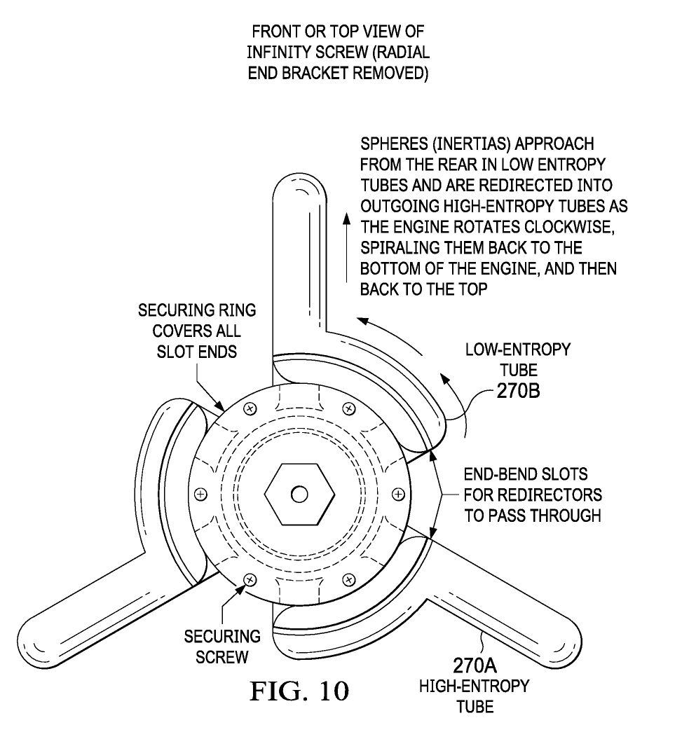

FIG. 10 shows a front or top view of the InfinityScrew, radial end bracket removed;

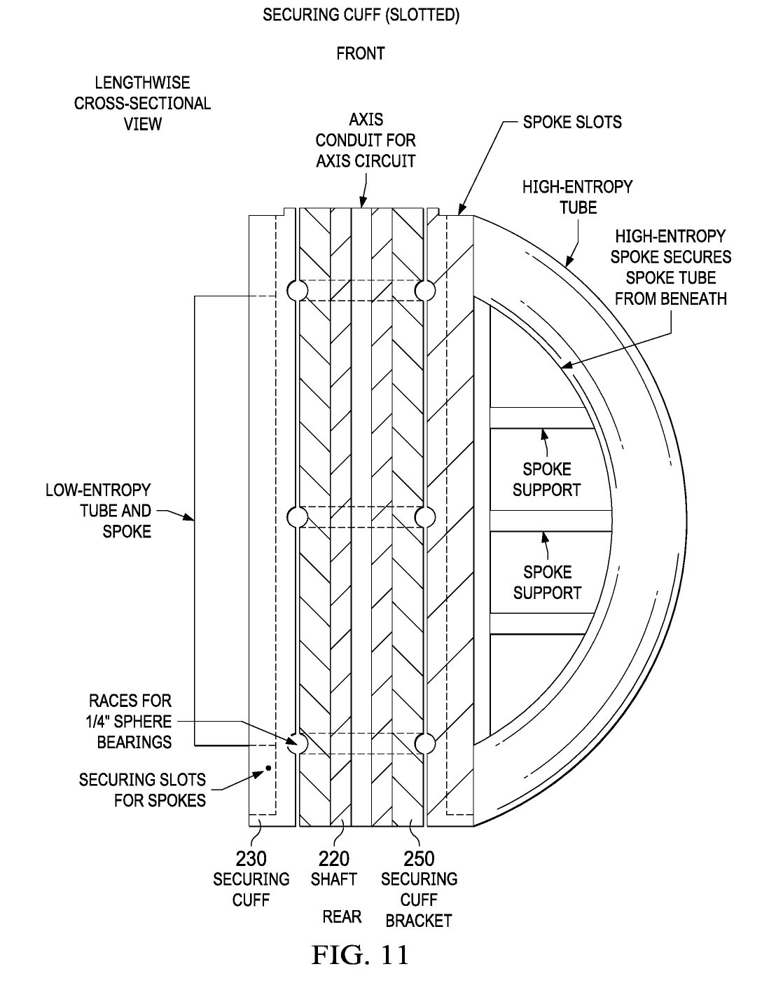

FIG. 11 shows a lengthwise cross-sectional view of the InfinityScrew engine securing cuff and securing cuff bracket;

FIG. 12 shows the radial end bracket with redirectors;

FIG. 13 shows a multi-tooth redirector.

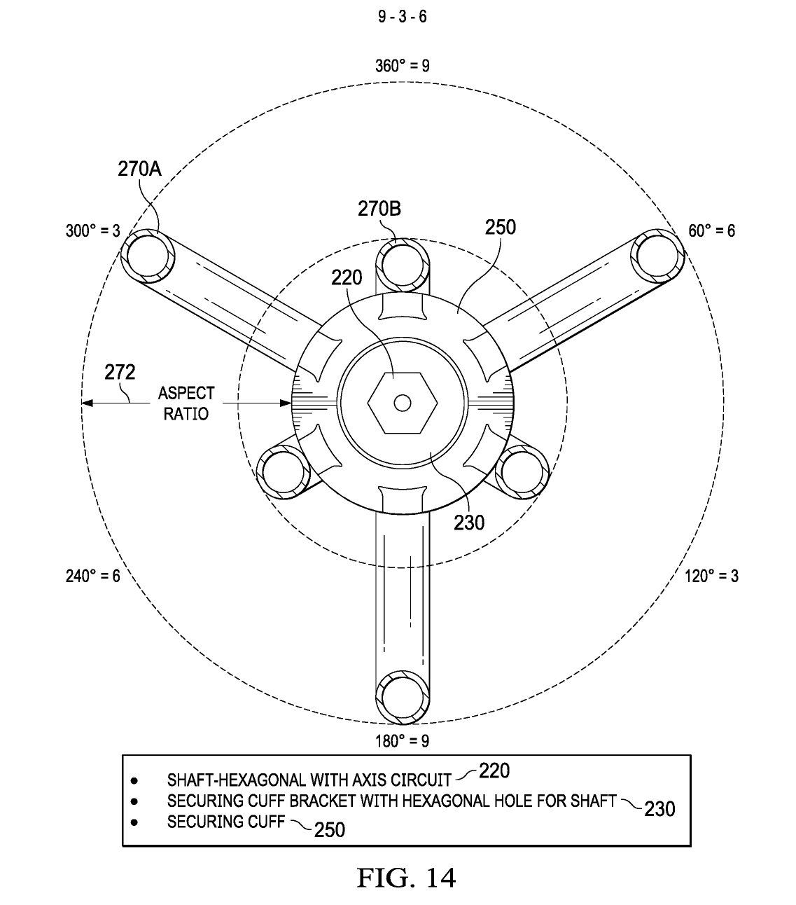

FIG. 14 shows a cross-sectional view of the InfinityScrew; and

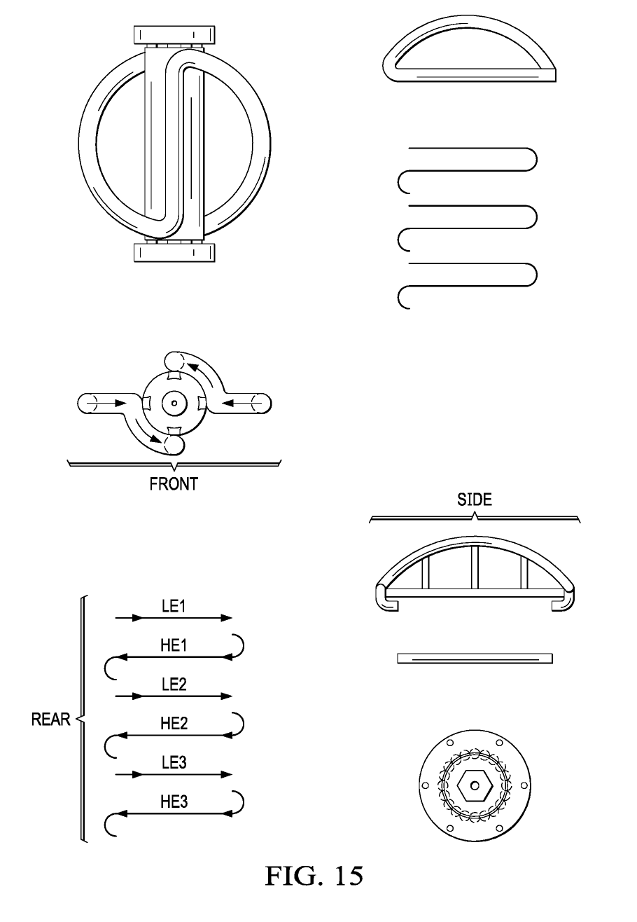

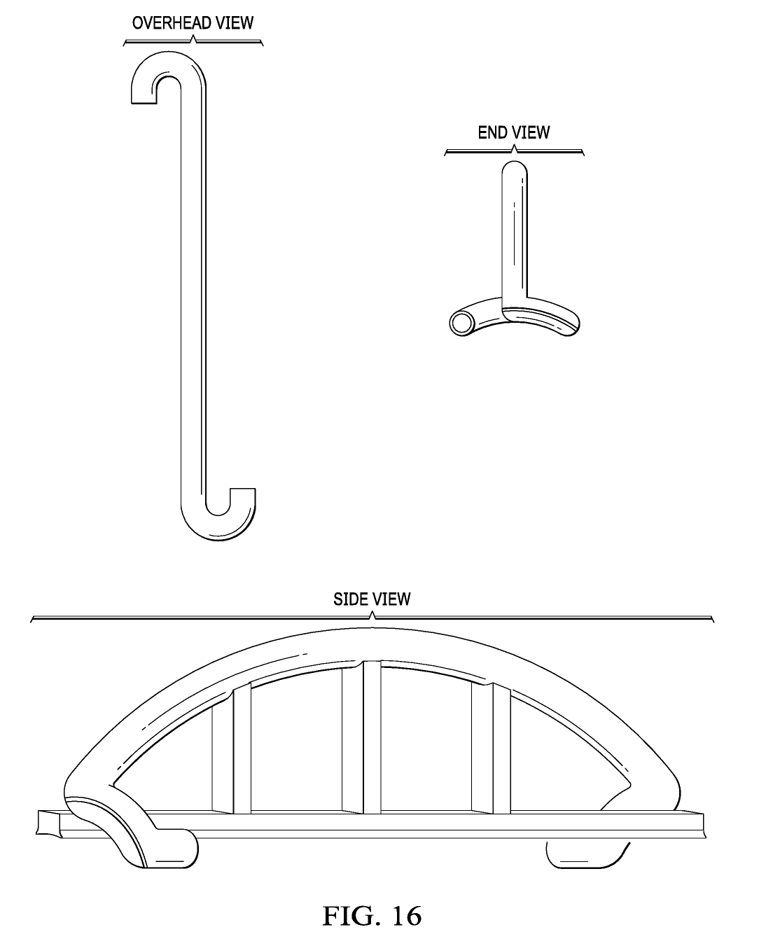

FIGS. 15 and 16 show spoke-tube segments.

Various embodiments may have one or more (or none) of the following features:
A system, method, and device for generating the torus pattern.
A system and method that generates the pattern with rotational inertias or angular momentums.
A device and system that generates a toroidal portal by producing a “vortexing” movement pattern with its rotational inertias.
A system and device that is a gyroscope with a linear axis.
A system, and method for producing a gyroscope with a linear axis.
A device, method, and system for converting rotational inertia into linear movement through a rotational drive.
A device and system that converts linear inertia into rotational inertia through a vortex drive.
A device, method, and system for a reactionless drive.
A system, method, and device for expanding and contracting space time and gravity.
A device that operates within at least two temporal dimensions simultaneously (4D+4D).
A device and system that is modeled after a natural phenomenon—the torus.
A method and system for modeling systems after the torus.
A device and system that reproduces the phenomenon known as the torus.
A system, method, and device that thins or stretches the cosmic fabric known as space-time-gravity in order to achieve increased productivity.
A system, method, and device that generates an electromagnetic toroidal field portal.
A system, method, and device that generates an electromagnetic toroidal force field.
A device that is driven from within by etheron/tachyon energy expressed as rotational inertia.
A device and system that operates in a fractional or thinned space-time-gravity field.
A device and system that is self-organizing, self-stabilizing, self-driven, and self-maintained.
A device and system that is conscious in nature.
A device and system that is multi-perspective in nature.
A device and system that is spiritual in nature.
A device and system that is benevolent (or kind) in nature.
A device and system that utilizes fractal anatomies or fractal systems.
A system and method for generating fractal anatomies or fractal systems.
A device and system that is designed to enlighten, entertain, and educate.
A device and system that levitates.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of moving an item in a torus-like pattern, the method comprising:
moving an item poloidally along a path with reference to a torus grid; and
at least partially moving the item toroidally along the path with reference to the torus grid such that when the item substantially moves around a revolution around the torus grid when viewed from a cross section cut across the poloidal direction of movement, the item also moves poloidally.

2. The method of claim 1, wherein a portion of the poloidal movement with reference to the torus grid is non-linear and another portion is linear.

3. The method of claim 1, wherein the path of movement of the item does not cross another path of movement when viewed from a cross-section cut across the toroidal direction of movement.

4. The method of claim 1, wherein the item is at least one sphere flowing through tubes that follow the path.

5. The method of claim 1, wherein the item is a plurality of spheres flowing through tubes that follow the path.

6. The method of claim 1, wherein the item is at least one electron.

7. The method of claim 1, wherein the item is fluid.

8. The method of claim 1, wherein multiple items are simultaneously moved along the path both toroidally and poloidally such that when the items substantially move around a revolution around the torus grid when viewed from a cross section cut across the poloidal direction of movement, the items also move poloidally.

9. The method of claim 1, wherein the item follows a continuous path repeating a revolution around the torus grid when viewed from a cross section cut across the poloidal direction of movement approximately that is 120 degrees apart from a prior revolution.

10. A system for moving an item in a torus-like infinity pattern, the system comprising:
a channel for moving an item poloidally along a path with reference to a torus grid, wherein the channel in at least partially moves the item toroidally along the path with reference to the torus grid such that when the item substantially moves around a revolution around the torus grid when viewed from a cross section cut across the poloidal direction of movement, the channel also moves the item poloidally.

11. The system of claim 10, wherein a portion of the channel with reference to the torus grid is non-linear and another portion is linear.

12. The system of claim 10, wherein channel does not cross another channel of movement when viewed from a cross-section cut across the toroidal direction of movement.

13. The system of claim 10, wherein the item is at least one sphere flowing through the channel that follows the path.

14. The system of claim 10, wherein the item is a plurality of spheres flowing through the channel that follows the path.

15. The system of claim 10, wherein the item is at least one electron.

16. The system of claim 10, wherein the item is fluid.

17. The system of claim 10, wherein multiple items are simultaneously moved along the path both toroidally and poloidally such that when the items substantially move around a revolution around the torus grid when viewed from a cross section cut across the poloidal direction of movement, the items also moves poloidally.

18. The system of claim 10, wherein the channel follows a continuous path repeating a revolution around the torus grid when viewed from a cross section cut across the poloidal direction of movement approximately 120 degrees apart from a prior revolution.
